(19) United States
(12) Patent Application Publication
(10) Pub. No.: US 2021/0391161 A1
(43) Pub. Date: Dec. 16, 2021

(54) DIRECT IONIZATION IN IMAGING MASS SPECTROMETRY OPERATION

(71) Applicant: Fluidigm Canada Inc., Markham (CA)

(72) Inventors: Alexander Loboda, Thornhill (CA); Daaf Sandkuijl, Markham (CA); Adam Carew, Toronto (CA)

(73) Assignee: Fluidigm Canada Inc., Markham, ON (CA)

(21) Appl. No.: 17/422,578

(22) PCT Filed: Jan. 14, 2020
(86) PCT No.: PCT/US2020/013509

§ 371 Date: Jul. 13, 2021

Related U.S. Application Data
(60) Provisional application No. 62/792,799, filed on Jan. 15, 2019.
(60) Provisional application No. 62/930,225, filed on Nov. 4, 2019.

(51) Int. Cl. H01J 49/00; H01J 49/16

(52) U.S. Cl. CPC H01J 49/0004; H01J 49/40; H01J 49/162; H01J 49/164

(57) ABSTRACT

As described herein, one or more parameters of a direct ionization imaging mass spectrometer (IMS) may be set to obtain a desired plasma and deliver it to a mass detector. Depending on the application, certain parameters may be predetermined (e.g., a spot size given a desired resolution) and, as described herein, other parameters can be adjusted to obtain the desired plasma properties. Also included is sample preparation suitable for direct ionization IMS and/or other imaging modalities.

### CROSS REFERENCES TO RELATED APPLICATIONS

This application claims the benefit of priority to U.S. Provisional Patent Application No. 62/792,799 filed Jan. 15, 2019, and claims the benefit of priority to U.S. Provisional Patent Application No. 62/930,225 filed Nov. 4, 2019, the contents of which are hereby incorporated by reference in their entirety for all purposes.

### FIELD OF THE INVENTION

The present invention relates to radiation of samples, such as biological samples, to produce atomic ions for analysis by imaging mass spectrometry (IMS).

### BACKGROUND

Many applications in imaging elemental mass spectrometry, such as imaging mass cytometry in which biological samples are labelled with metal-tagged antibodies, benefit from higher sensitivity, higher speed, higher resolution and/or cheaper instrument cost. However, sampling at higher resolution tends to reduce speed of sample acquisition over a given area, and ion signal is reduced as a smaller portion of the sample is analysed at a given sampled spot. Ionization and delivery to a mass detector may be inefficient due to a number of reasons. For example, in LA-ICP-MS, sample loss may occur in the gas conduit, upon injection into an ionization source such as an inductively coupled plasma, upon differential pumping, and/or due to space charge effects in the ion beam. Methods and systems that ionize upon radiation of the sample obviate the need of a separate ionization step, but often do not provide elemental (atomic) ions at high and consistent efficiency suitable for delivery to a mass detector in high resolution, high sensitivity and/or high-speed applications.

### SUMMARY OF THE INVENTION

Aspects of the invention include methods and systems for direct ionization for analysing a sample by imaging mass spectrometry.

A method of analyzing a sample may comprise:
a) directing radiation at a spot on a sample to form a plasma comprising elemental ions,
b) delivering the elemental ions to a mass detector; and/or
c) detecting the elemental ions at the mass detector.

A system for analyzing a sample may comprise:
a) a solid support;
b) a radiation source and optics for directing radiation at a spot on a sample to form a plasma that atomizes and ionizes the sample at that spot to produce elemental ions; and/or
c) a mass detector for detecting the elemental composition of elemental ions delivered from the plasma.

The method may further include additional aspects (alone or in combination) described below, and the system may further comprise, be configured to, or provide means for, aspects (alone or in combination) described below.

In certain aspects, a sample is provided on a solid support. The solid support may comprise an X-Y stage, X-Y-Z stage, and/or a slide as described herein, and may be transparent.

The sample may be a geological or semiconductor sample.

Alternatively, the sample may be a biological sample, such as a tissue section (e.g., an thin tissue section such as an EM section). The tissue section may be 200 nm, 100 nm, 50 nm, or 30 nm or less in thickness. The biological sample may be stained with specific binding partners (SBPs) comprising elemental tags, such as distinct metal (e.g., lanthanide) tags. In certain aspects, the SBPs may be antibodies (or fragments thereof) or aptamers. The biological sample may comprise metal containing histochemical stains and/or metal tagged oligonucleotides (e.g., metal tagged DNA directly or indirectly hybridized to a target RNA directly or antibody linked oligonucleotide), as described herein.

In certain aspects, radiation may be scanned across the sample, for example by one or more positioners (e.g., one or more of a galvanometer mirror, piezoelectric mirror, MEMS mirror, polygon scanner, acousto-optic device or an electro-optic device). In certain aspects, at least one positioner may be a non-inertial (e.g., solid state) positioner.

The radiation may directed from a different angle than the direction of the mass detector in the relation to the sample, such as from the opposite side of the sample from the side of delivery to the mass detector or at an angle from the same side of the sample as the mass detector. The radiation may have pulse duration above, below or between 1 ps, 5 ps, 10 ps, 50 ps, 100 ps, 1 fs, 5 fs, 10 fs, 50 fs, 100 fs, 500 fs, such as below 10 ps or between 10 fs and 10 ps. The duration of a pulse of radiation at a sample spot may be shorter than the time to form the plasma (or optionally form a plasma past neutralization). The radiation may provide a spot size below or between 1 um, 500 nm, 300 nm, 200 nm, 100 nm, 50 nm, 30 nm, and 10 nm. In certain aspects, spots may be analysed at a frequency above or between 100 Hz, 1 kHz, 10 kHz, 100 kHz, 1 MHz, 10 MHz, 100 MHz, such as between 1 kHz and 10 MHz.

In certain aspects, the radiation is a laser (e.g., comprises laser pulses). The laser may be a femtosecond laser or picosecond laser. For example, the laser may have a pulse duration above, below or between 1 ps, 5 ps, 10 ps, 50 ps, 100 ps, 1 fs, 5 fs, 10 fs, 50 fs, 100 fs, 500 fs, such as below 10 ps or between 10 fs and 10 ps. The laser may be a high harmonic generation laser, a UV laser, or a EUV laser. The laser may have a wavelength at or below 550 nm, 500 nm, 450 nm, 400 nm, 350 nm, 300 nm, 250 nm, or 200 nm. The laser may have a pulse energy above, below or between 10 pj, 100 pj, 500 pj, 1 nJ, 10 nJ, 50 nj, 100 nJ, 500 nJ, 1 uJ, 5 uJ, 10 uJ, 20 uJ, 50 uJ, 100 uJ, and 500 uJ, such as between 10 pJ and 10 uJ. For example, the laser has a pulse energy of less than 1 nj, or less than 100 pJ. The laser may be focused by an immersion lens, such as a solid or liquid (e.g., TIRF) immersion lens.

Alternatively, the radiation may be a beam of charged particles, such as an ion beam or an electron beam. For example, electron beam radiation may comprise electrons with an energy of above, below or between 100 eV, 200 eV, 500 eV, 1 keV, 10 keV, 100 keV, and 1 MeV, such as between 100 eV, and 10 keV. In certain aspects, the energy of electrons in the beam may be low enough to allow efficient thermal transfer and/or reduce dispersion of energy or electrons beyond the spot of radiation. In certain aspects, the number of electrons used to create the plasma (e.g., provided in a pulse to a single spot) may be above, below or between 200, 500, 1000, 5000, 10000 and 50000 electrons, such as between 1000 and 50000 electrons.

In certain aspects, plasma is not formed in the presence of an injected noble gas, such as Argon or Xenon. The plasma may be a thermal plasma, for example having an internal temperature above or between 3000K, 5000K, 7000K, 10000K, 30000K, such as between 3000 K and 30000 K, or between 5000 K and 10000 K. The plasma may have the internal temperature described above when past neutralization (e.g., after 80% or 90% of collision based neutralization events have occurred) or when the plasma is collisionless. The plasma may have a diameter at or less than 10 um, 5 um, 2 um, 1 um, 500 nm, 200 nm, 100 nm, or 50 nm when past neutralization, such as a diameter less than 1 um.

The elemental ions from the plasma may be delivered in a vacuum from the point of plasma formation to the mass detector (e.g., by ion transport optics). In certain aspects the delivering (e.g., ion transport optics) may not comprise a mass filter, or may comprise a high pass filter with a cutoff at or below 80 amu, below 60 amu, or below 40 amu. The delivery time of elemental ions from the plasma to the detector may less than 2 ms, 1 ms, 500 us, 200 us, 100 us, 10 us, 5 us, 1 us, or 100 ns, such as below 200 us.

In certain aspects the plasma produced may have a desired ionization efficiency. For example, at least 1%, 5%, 10%, 20%, 50%, 80%, or 90% of sample material, or metals (e.g., lanthanides from metal-tags) released from the sample spot by the radiation are atomized and ionized (e.g., remain ionized past neutralization and/or until delivery to the mass detector). In certain aspects, the ionization of metals (e.g., lanthanides from metal tags) in the plasm is above that of carbon or elements lighter than 40 amu. For example, the metal or lanthanide ionization efficiency may be above 10%, 20%, 50%, 80% or 90% while the ionization efficiency of carbon in the plasma may be below 10%, below 5%, or below 1%. As such, preferential ionization of lanthanides or other metals may decrease undesired ions reaching the mass detector or complicating ion transport through space-charge effects.

In certain aspects, the mass detector is a magnetic sector detector or a time of flight (TOF) detector. For example, the mass detector may be a TOF detector without means to separately push elemental ions delivered from a single spot (or plasma).

In certain aspects, the methods and systems may be for imaging mass cytometry. For example, the detection of the elemental ions may comprise analysis of metal tags or targets associated with the metal tags (e.g., lanthanides associated with SBPs such as antibodies). For example, more than 5, 10, 20, 40, or 50 metal tagged antibodies may be distinguished by the systems and methods described herein. The method and systems herein may form an image of the sample based on the elemental/isotopic composition of multiple spots, such as the composition of metal tags indicating presence of proteins or other targets in the sample. Certain aspects include detecting single copies of metal-tagged antibodies (e.g., at high resolution an sensitivity). When detecting single copies of metal-tagged SBPs (e.g., antibodies), the metal tags may of each SBP specific for a different target may comprise a unique barcode of elements or isotopes. This allows more than 100, more than 200, more than 500, or more than 1000 tagged SBPs to be analysed in a single sample.

In certain aspects, the portion of the sample removed at the spot by radiation is less than 1 femto gram, less than 1 atto gram, or less than 1 zepto gram.

In certain aspects a 3D image is constructed, such as by radiating the sample at the same spot (X-Y coordinate) multiple times.

Also included are methods of sample preparation for analysis by direct ionization and/or other imaging modalities.

One of skill in the art will recognize that the elements described above can be combined or adjusted based on the desired application.

### BRIEF DESCRIPTION OF THE FIGURE

FIG. 1 is a diagram of a direct ionization system and method. A radiation source (such as a laser or an electron beam gun described herein) directs radiation to the sample. The radiation may be applied from a direction other than the direction of the mass detector, such as from the opposite side of the sample. Radiation optics (such as positioners and/or ion or light focusing lenses described herein) apply the radiation to a spot on the sample (such as a biological sample as described herein), which is mounted on a sample support (such as a carrier, or transparent slide as described herein). Plasma is formed at the sample spot and expands into vacuum. For sampling the elemental ions into the mass analyser, it is important to generate a plasma with the density and the temperature parameters that lead to reduction of collision-based neutralization. As described herein, the radiation energy, pulse time, and spot size and/or other parameters described herein may provide a plasma with high ionization efficiency, providing elemental ions that are then directly transported (e.g., by ion transport optics as described herein) to a mass detector (such as a time-of-flight or magnetic sector mass detector as described herein).

FIG. 2 is a proportional line drawing of an exemplary ion transport (extraction) optics used herein with the same orientation to the sample as shown in FIG. 1.

FIG. 3 is a mass spectrum of heavy metal counts detected over a PMMA matrix by the subject using the system of FIG. 2 combined with upstream laser optics and downstream TOF detection.

### DETAILED DESCRIPTION OF THE INVENTION

As described herein, one or more parameters of a direct ionization imaging mass spectrometer may be set to obtain a desired plasma and deliver it to a mass detector. Depending on the application, certain parameters may be predetermined (e.g., a spot size given a desired resolution) and, as described herein, other parameters can be adjusted to obtain the desired plasma properties. As a general direction, an optimal radiation energy, shorter radiation pulse time, smaller spot size, and wavelength absorbed well by the sample will provide a plasma with higher ionization efficiency (e.g., which can be measured by optical emission, or as oxidation or quantity of ions passed to the mass detector). This smaller, faster scale of ablation facilitates formation of a nano-plasma that can lead to ion sampling without neutralization. The radiation pulse time, such as a laser pulse time, may be shorter than the duration of plasma formation, or of the formation of a plasma past neutralization. These parameters, and the material of the sample itself, affect the amount of the sample in the plasma and its temperature (kinetic energy), with less material at a higher temperature expanding more rapidly in vacuum thereby reducing the formation of neutrals.

One can assume that in the earlier stages of plasma evolution it reaches a state of local thermal equilibrium. That means that one temperature value can describe the temperature of electrons and the temperature of ions. To achieve a local thermal equilibrium sufficient density of plasma is required which is the case while the plasma is right at the specimen where the local density is high and collisions are prevalent. As described herein, as the plasma expands into a vacuum, positive ions separate from negative ions and electrons to the point that neutralization through collisions is reduced or eliminated. As such, properties of the plasma described in embodiments herein may describe the plasma past neutralization (e.g., after the majority, such as 80% or 90%, of neutralizing collisions have taken place). For example, when the plasma is past neutralization (e.g., and may be collisionless, or approaching a collisionless state) it may still have a temperature more than 3000K, such as between 3000K and 30000K, such as between 5000K and 10000K. As such, ions in plasma past neutralization may be stably ionized and passed to the detector. The direct ionization methods and systems described herein have unique benefit to imaging mass cytometry, specifically to imaging of metal tags in biological samples.

In a gas at a high temperature and pressure, thermal collisions will ionize some atoms. The Saha ionization equation relates the ionization state of a gas to its temperature, pressure, and ionization energies of its composite atoms, assuming thermal equilibrium. For example, the ionization efficiency of a lanthanide atom in a thermal plasma at 6000K would be high (approaching 100%). Assuming a radiation pulse was applied rapidly enough and at high enough energy (e.g., by a femtosecond or picosecond laser) in a small enough spot size and was absorbed by the sample (e.g., 10% or 20% of the laser light or electron beam was absorbed as thermal energy), the conditions for a highly ionizing (e.g., high lanthanide ionization efficiency) local plasma would be met. In certain aspects, ionization efficiency of lanthanides in the plasma may be higher than that of carbon or other lower mass elements, such that ions delivered to the mass detector are enriched for lanthanide ions. In certain aspects, the parameters (such as spot size, pulse time and/or pulse energy) may be tunable for different applications or to maintain consistency of plasmas (e.g., with real-time feedback on ionization efficiency).

As described below, the radiation providing a plasma at the sample spot may be laser radiation or an charged particle beam, such as an ion beam or electron beam.

Overview of Direct Ionization by Laser Ablation

Many imaging mass spectrometry applications, including some forms of imaging mass cytometry, uses a laser ablation ICP-MS system. These types of systems have natural challenges to deal with:
The plasma-vacuum interface (as well as the time-of-flight mass spectrometer we use) prevents most of the analyte ions not to reach the detector, lowering the end-to-end sensitivity of the instrument.
The ICP introduces a large background signal from Ar and ArAr ions, which effectively limits our mass range to analyte ions with mass over 80 amu.
The sample transport from the ablation site to the plasma, as well as the dwell time in the plasma itself, is the main factor limiting our ablation rate to hundreds of Hz (e.g. <˜1 kpixel/s).
The laser ablation resolution is about 1 pm due to the choice of wavelength, objective numerical aperture, sampling geometry and the types of samples (e.g. FFPE tissue sections) our existing systems can work with.
The instrument as a whole is quite complex, with the analytes going through many processes and interfaces before being detected. This increases the build cost, operating cost and service cost of our instruments, and complicates end-to-end analysis.

Systems and methods described below provide an alternative setup, where one or more laser sources are used to ablate and ionize the sample, which is already in a vacuum, and the resulting ions are then accelerated into a mass spectrometer directly, without the need for an ICP and vacuum interface.

In our current LA-ICP-MS system the sample is ablated using a laser in a helium/argon environment at near-atmospheric pressure. The ablation event can be thermal or athermal in nature, depending on the choice of laser source (long pulse duration UV laser or femtosecond laser). Either way, the plasma that might form during the ablation process rapidly neutralizes due to the density of the ablated cloud as well as the extended contact with the carrier gases at atmospheric pressure. An ICP with a vacuum interface is then used to ionize the ablated material and sample the ions.

An alternative way to sample the analyte ions would be to create a local plasma and inject the analyte ions directly from this plasma into a mass analyzer. The inventors realized that in order to prevent neutralization, the ablation plasma would need to be sparse enough and expand quickly enough that neutralization is halted and the plasma is ‘frozen’. Past this neutralization ions in the plasma remain ionized (e.g., greater than 80% or 90% of the ions may remain ionized). This means the ablation volume (e.g., spot size) needs to be kept small. Typical laser ablation volumes are about 1×1×1 μm (our HTI platform) or larger (Laser Induced Breakdown Spectroscopy, LA-ICP-MS of geological samples, etc.). We estimate an appropriate ablation volume for ensuring low degree of neutralization to be 100×100×100 nm or smaller (e.g., a spot size of 100 nm or less).

Of note, fs-LIBS literature often describes the LIBS process as a plasma evolution. LIBS plasma eventually cools down, the ions neutralize, and complex molecules form at the final stages of LIBS evolution. This sequence happens because there are just too many neutral particles generated by ablation and they continue to collide as the plasma cools down. In addition, there are too many charged particles in a small volume and the forces of attraction between positive and negative charged particles can overcome all other forces acting on ions in the ablation plume. For a fixed degree of ionization, the number of ions in the plasma plume goes down as roughly the cubic power of pixel size. The same cubic power law applies to the number of neutral species in the ablated plume. Thus, LIBS type of plasma created at a nanoscale could be a source of analytical ions that can be sampled directly into a mass analyzer without neutralization. In other words, the plume originating from a nanoscale ablation can be sampled as a “frozen” plasma. And then, the plasma can be separated into positive and negative particles and the positive ions can then be detected by a mass spectrometer with high efficiency. In the classical LIBS, the topic of ablated pixels at a spatial resolution of 100 nm (or below) remains unexplored because there is no motivation to go there due to poor optical signals that are the main source of information in LIBS. By employing a LIBS type of plasma created from nanoscale ablation in combination with direct sampling of ions into a mass spectrometer. Once the ions from the plasma separate from electrons they can be analyzed. The sample would need to be in a vacuum environment or at a relatively low pressure during the ablation event to facilitate ion extraction and ion manipulation with a minimal time broadening of the ion packets from corresponding pixels.

It might be advantageous to create plasma in a state of a local thermal equilibrium (LTE). This condition has a parallel to the plasma in the traditional ICP-MS. The reason the LTE plasma is useful is because the ionization efficiency becomes dependent on the temperature of the plasma and the ionization potential for a given element. At a temperature of around 7000K the degree of ionization exceeds 90% for the majority of elements (e.g., lanthanide isotopes) used in MaxPar reagents for mass cytometry. At the same time, the degree of ionization for the most abundant biological elements such as carbon, hydrogen and oxygen stays at around a few percent. Therefore, the amount of charged particles in the expanding plasma remains fairly low which in turn helps with the plasma separation into positive and negative particles.

The temperature of the plasma increases with the amount of the laser energy deposited into the ablation volume. Thus, one can adjust the temperature to achieve the desired degree of ionization and an optimal plasma breakup. Note, a non-thermal plasma may also work for this application, though it may be more difficult to model the ion production behaviour for a non-thermal plasma. Experiments can be used as a guidance to develop optimal conditions for ionization with non-thermal plasma. It might happen that a longer pulse duration leads to a plasma that is closer to thermal. But, it might also happen that a shorter pulse duration leads to the thermal plasma. The state of plasma depends on several parameters such as pulse energy, its wavelength, pulse duration and pulse shape. Even the light polarization properties could be contributing to the type of the plasma being created by the laser pulse.

Mean velocity of atoms in the thermal plasma can be calculated from the temperature of the plasma and the mass of the atoms. It comes at around 3000 m/s for carbon atoms at 7000 K. This is the velocity at which plasma will start expanding from the solid being ablated and into the vacuum. At this velocity, the plasma will cover 30 nm of distance in 10 ps. Thus, 10 ps becomes an estimate for a maximum duration of light that can still be used to heat up the plasma. A pulse duration longer than ˜10 ps may not be efficient at converting the light energy into the plasma energy. It is fortunate that cost efficient fs fiber lasers produce laser pulses with duration on the scale of 500 fs. Such pulses should be well suited for creating the desired plasma as long as they can be focused to the 100 nm scale using suitable optics.

Such small ablated volumes require special optical arrangements, since most microscopes are limited to a spatial resolution of around 200 nm or larger by the diffraction limit of visible light and limitations on the numerical aperture available. This is shown by the FWHM focal spot diameter formula: D=0.541λ/(√m [symbol] NA [symbol] \hat{ }0.91), where λ is the wavelength of light used, m is the order of the optical process, and NA is the numerical aperture (between 0.7 and 1.4 for this formula to be valid). Using λ=450 nm and NA=1.4 leads to a FWHM spot diameter of about 180 nm.

The spot size formula above indicates there are three ways in which ablation scales of 100 nm or less could be achieved: reducing the wavelength from visible to UV or shorter, using a higher-order (nonlinear) optical process, or increasing the numerical aperture beyond what is available from common off-the-shelf microscope components.

EUV Laser Ablation

The wavelength can be reduced by using EUV lasers with wavelength below 50 nm. Even though a numerical aperture below 1 will need to be used (as no materials can be used for immersion), the shorter wavelength more than makes up for this and focal spot sizes of 100 nm or less may easily be achieved, potentially down to 10×10×10 nm for high harmonic generation laser sources or tin vapour lasers with a wavelength of 13 nm, which are used commercially in EUV lithography. Even at a numerical aperture of 0.4 (close to what is used in EUV lithography) the 13 nm wavelength will still lead to ablation spot on the 30 nm scale.

This approach will require the use of custom all-reflective optics with very tight surface figure tolerances, and likely a custom laser source. The fact that no materials should be in the path of the laser also implies that the ablation laser may need to reach the sample from the same side as where collection of ions will take place. This will require very specialized optics that can reflect and focus the ablation laser and still have a clear aperture for transmission of the generated ions.

Downsides of this approach include the high cost and complexity of the custom EUV laser source and optics.

The need for the pulse duration below 10 ps may be a significant limitation for the tin-droplet EUV laser mentioned above, though high harmonic generation sources are known to generate attosecond pulse durations and would be viable from this perspective.

Femtosecond Laser Ablation

A femtosecond laser can also be used, which would make the ablation event nonlinear in nature. This shrinks the effective spot size by the square root of m, where m is the order of the nonlinear process. For example, laser pulses from a frequency-doubled Ti:Sp laser would have a central wavelength of around 400 nm. Using a TIRF objective with numerical aperture of 1.49, and assuming a second-order nonlinear process or higher, the spot size would be 106 nm in diameter or smaller (FWHM). Furthermore, nonlinear ablation processes have well-defined thresholds, so that effective ablation spot sizes well below the FWHM diameter can be achieved by precisely controlling the pulse energy. In literature, factors of 5-10 are routinely achieved, with a 5× reduction commonly considered the upper limit for reproducibility. This would mean ablation sizes on the order of 20-30 nm.

One major benefit of this approach is that standard lasers and microscope optics can be used, which would greatly shorten time-to-market and lower parts cost. Furthermore, the laser pulses can be focused through the sample carrier (i.e., a microscope coverslip in the case of off-the-shelf microscope objectives), which greatly simplifies the instrument design because the ion sampling side can be completely devoted to ion acceleration and collection.

Pulse durations on the order or tens of femtoseconds to hundreds of femtoseconds are routinely achieved in commercial laser systems (e.g., titanium-doped sapphire lasers or ytterbium-doped lasers, respectively). The transition from a nonlinear ablation process to a linear ablation process (i.e., linear absorption) may take place around pulse durations of 1-10 picoseconds. In any case, the pulse duration may not be much longer than tens of ps due to the small spot size and the plasma's speed of expansion. For example, if the ablation plasma expands at 3000 m/s, a 30 nm volume would expand to twice its size/diameter in about 10 ps.

Solid Immersion Lenses

Another approach could be to use solid immersion lenses to greatly increase the numerical aperture, thereby shrinking the spot size. For example, diamond solid immersion lenses are commercially available and can be used with laser wavelengths of 266 nm. The numerical aperture at this wavelength can be up to about 2.5, limited by the refractive index of the material. At such a high numerical aperture the spot size formula above is not valid anymore, but it can still be used to estimate D=63 nm. A diamond lens of this type was used in a prototype of an optical storage disk by Sony with a storage capacity on the scale of 2 TB enabled by the tight focusing of the beam.

The chief advantages of this approach are that a low-cost, standard laser source can be used (4th harmonic Nd laser), and that the laser can be focused through the sample carrier, leaving the other side free for ion acceleration and collection. There are several major disadvantages, however:
High parts cost and tight tolerances on the immersion lens
Very tight dynamic alignment tolerances on the immersion lens
Very small field of view.
Sample would need to be mounted on the lens itself, or would need to be mounted on a tight-tolerance substrate of the same material, and the interface between the lens and substrate will require optical contact, which is difficult to maintain dynamically.

Laser beam rastering can be employed to facilitate sample interrogation. For example, the laser can be scanned at 5000 lines per second and each laser line can generate 2000 pixels leading to 10 Mpixel/s and 10 MHz laser repetition rate. With 100 nm pixels the laser line will cover 200 micrometers and the velocity of travel will be 500 mm/s. Such parameters could be an extreme case—a more practical setup will involve 1000 pixels per line collected at 1000 lines per second at 100 mm/s. The data can be collected by rastering the beam in two dimensions within the field of view of 100×100 micrometers.

Mass Spectrometer Considerations

Regardless of which approach is used to shrink the ablation volume to an appropriate size, the ions will need to be accelerated immediately from the sample and injected into the mass spectrometer. This will likely require the sample carrier to be conductive (e.g., using an ITO-coated microscope slide or using a conductive coating made of lower-mass atoms that will not show up in our analyte ion channels, such as a graphene coating). In certain aspects, the sample support may be conductive and charged to repel ions generated by direct ionization as described herein.

Various configurations of ion optics could be used, such as magnetic sector mass analyzers with multiplexed multichannel detection, TOF mass analyzer without pulse extraction or a TOF mass analyzer with pulse extraction. In the case of a TOF with pulse extraction the pulse can be synchronized with the firing of the laser beam. The purpose of the pulsed extraction could be to improve instrument mass resolution as practiced in the art of MALDI mass spectrometers. There the technique goes under the name of delayed extraction.

A benefit of the proposed ionization method over our current ICP-based instrumentation is that there would be no background ions from carrier/plasma gases, etc., and so the mass range of the analyzer can be extended to lower masses. High brightness ion species such as carbon+ ions would be present in the ion beam of this method but can be filtered out on the basis of TOF or magnetic separation. On the other hand, molecular ions and clusters would likely show up in the data and complicate the analysis as compared to our current instrument. The majority of the molecular ions and clusters will appear in the mass range that is outside of the mass range of interest for the elemental tags. Thus, they too can be filtered out by a suitable mass spectrometry filtering. As an alternative, molecular ions and clusters could be suppressed by inducing ion fragmentation by means known in the art of mass spectrometry.

Furthermore, by immediately accelerating the ions away from the ablation site the time duration of the ion pulse in the mass analyzer would be very short, which means a vast improvement in the scanning rate would be possible as compared to our current instrument—up to tens or hundreds of kHz for TOF and up to 100 MHz for magnetic sector instrument. In the case of magnetic sector instrument the limiting factor could be the pulse duration at the detection channel. The ion optics of a magnetic sector instrument can be designed to maintain ion pulse duration at the detector surface on the scale of 10 ns. This may require the ion optics to contain compensation due to the energy spread introduced by the plasma expansion. A cross over ion optics technology fusing a TOF technology that maintains a narrow beam pulse at the detector and a multi-channel magnetic sector technology can be applied to operate at such high acquisition rates.

Sample Considerations

Because the ablation volume is so much smaller compared to our standard platform, the number of analyte ions per laser ablation event is greatly reduced. This may be a problem if the end-to-end detection efficiency is not proportionally improved. Due to the lack of vacuum interface, and the possibility of using a TOF or a magnetic mass analyzer, the end-to-end detection efficiency may be significantly higher. On the other hand, the ionization efficiency of the analyte ions will likely be reduced as compared to our ICP-based instruments due to some recombination of the plasma during its expansion phase. Either way, the technique would obviously benefit from new staining techniques increasing the number of analyte ions per volume.

Another consideration is that the short ablation depth means that thin samples will need to be used, on the order of 100 nm or thinner. These are routinely used in electron microscopy. These samples are resin-embedded, which would likely be beneficial due to dimensional stability and reproducibility of ablation threshold regardless of the inhomogeneity of the biological sample.

A large number of serial sections can be prepared for a single specimen and then quickly read out by the proposed method. This makes this method well suited for 3D analysis of biological sections. Indeed, at 1 Mpixel/s and 100 nm pixel size an area of 100×100 micrometers can be read out in 1 second and the third dimension can be read out at 1000 layers in 1000 seconds leading to a full 3D image of a 100×100×100 micrometers volume read out in under 20 minutes with a large number of channels detected simultaneously.

Finally, the sensitivity of the instrument at the level of single copy detection and the instrument's ability to image individual antibodies will facilitate tagging of individual antibodies with mass tag barcodes. This, in-turn, allows access to a vast number of tagging options, such that experiments with even 1000 different antibodies could become possible (e.g. using 10 mass channels with binary On/Off barcodes leads to 210=1024 available staining channels).

Overview of Direct Ionization by Electron Beam

This section describes an alternative setup, where pulsed electron source is used to ablate and ionize the sample, which is already in a vacuum, and the resulting ions are then accelerated into a mass spectrometer directly. With fast enough electronics to generate the electron pulse the need for the laser in this concept is removed which could lead to an additional cost saving for the product.

In, for example, the LA-ICP-MS system used for IMC, the sample is ablated using a laser in a helium/argon environment at near-atmospheric pressure. The ablation event can be thermal or athermal in nature, depending on the choice of laser source (long pulse duration UV laser or femtosecond laser). Either way, the plasma that is formed during the ablation process rapidly neutralizes due to the density of the ablated cloud as well as the extended contact with the carrier gases at atmospheric pressure. An ICP with a vacuum interface is then used to re-ionize the ablated material and sample the ions.

An alternative way to sample the analyte ions would be to prevent neutralization of the ablation by creating a local plasma and injecting the analyte ions from this plasma directly into a mass analyzer. The inventor has realized that in order to prevent neutralization, the sample would need to be in a vacuum environment during the ablation event, and the ablation plasma would need to be sparse enough and expand quickly enough that neutralization is halted and the plasma is ‘frozen’. This means the ablation volume needs to be kept small. Typical laser ablation volumes are about 1×1×1 pm (our HTI platform) or larger (LA-ICP-MS of geological samples, etc.). We can estimate the appropriate ablation volume for ensuring low degree of neutralization in the plasma to be 100×100×100 nm or smaller. Note that the literature for the femtosecond laser induced breakdown spectroscopy (fs-LIBS) often describes the LIBS process as a plasma evolution. LIBS plasma eventually cools down, the ions neutralize, and complex molecules form at the final stages of LIBS evolution. This sequence happens because there are just too many neutral particles generated by ablation and they continue to collide as the plasma cools down. In addition, there are too many charged particles in a small volume and the forces of attraction between positive and negative charged particles can overcome all other forces acting on ions in the ablation plume. For a fixed degree of ionization, the number of ions in the plasma plume goes down as roughly the cubic power of pixel size. The same cubic power law applies to the number of neutral species in the ablated plume. Thus, LIBS type of plasma created at a nanoscale could be a source of analytical ions that can be sampled directly into a mass analyzer without neutralization. In other words, the plume originating from a nanoscale ablation can be sampled as a “frozen” plasma. And then, the plasma can be separated into positive and negative particles and the positive ions can then be detected by a mass spectrometer with high efficiency. In the classical LIBS, the topic of ablated pixels at a spatial resolution of 100 nm (or below) remains unexplored because there is no motivation to go there due to poor optical signals that are the main source of information in LIBS. The inventive step here is to employ LIBS type of plasma created from nanoscale ablation triggered by an electron pulse in combination with direct sampling of ions into a mass spectrometer. Once the ions from the plasma separate from electrons in the plasma they can be analyzed. The sample would need to be in a vacuum environment or at a relatively low pressure during the ablation event to facilitate ion extraction and ion manipulation with a minimal time broadening of the ion packets from corresponding pixels. The vacuum is also needed for the electron beam pulse to be delivered to the specimen.

It might be advantageous to create plasma in a state of a local thermal equilibrium (LTE). This condition has a parallel to the plasma in the traditional ICP-MS. The reason the LTE plasma is useful is because the ionization efficiency becomes dependent on the temperature of the plasma and the ionization potential for a given element. At a temperature of around 7000K the degree of ionization exceeds 90% for the majority of elements used in MaxPar reagents for mass cytometry. At the same time, the degree of ionization for the most abundant biological elements such as carbon, hydrogen and oxygen stays at around of a few percent. Therefore, the amount of charged particles in the expanding plasma remains fairly low which in turn helps with the plasma separation into positive and negative particles.

The temperature of the plasma increases with the amount of the energy deposited into the ablation volume by the pulsed electron beam. Thus, one can adjust the temperature of the plasma by increasing the total charge of the electron pulse (or other parameters of the beam) to achieve the desired degree of ionization and an optimal plasma breakup. Note, the non-thermal plasma can also work for this application. It just makes it harder to anticipate the ion production behavior for the non-thermal plasma. Experiments and modelling can be used as a guidance to develop optimal conditions for ionization with non-thermal plasma. It might happen that a longer pulse duration leads to a plasma that is closer to thermal. But, it might also happen that a shorter pulse duration leads to the thermal plasma. From the technical standpoint it might be easier to operate with a longer electron pulse to avoid repulsion of electrons due to space charge in the beam. However, there is a soft upper limit to the pulse duration imposed by the residence time of the plasma. The electron pulse needs to be shorter than the time needed to expand the plasma away from the specimen.

Mean velocity of atoms in the thermal plasma can be calculated from the temperature of the plasma and the mass of the atoms. It comes at around 3000 m/s for carbon atoms at 7000 K. This is the velocity at which plasma will start expanding from the solid being ablated and into the vacuum. At this velocity, the plasma will cover 30 nm of distance in 10 ps. Thus, 10 ps becomes an estimate for a maximum duration of an electron pulse that can still be used to heat up the plasma. A pulse duration longer than ˜10 ps will not be efficient at converting the electron energy into the plasma energy.

Some electron beams can be routinely focused to a 10 nm diameter spot (or below). This kind of focusing gives its high spatial resolution to electron microscopes.

The beam parameters needed to create a plasma at the desired temperature of 7000 K could be calculated as following.

The electron energy used may correlate with the thickness of the specimen (around 30 nm, proposed). The energy of individual electrons may be chosen low enough so that a large portion of the electron energy is lost in the specimen. Thus, electrons with 30 keV or 100 keV energies (common in electron microscopes) would not be the best choice as their range of penetration into a soft material is on the scale of 1 micrometer or more. At this range, only 3% of the energy may be lost in the first 30 nm and that will be the extent of the energy available for ablation of the specimen. Electrons with significantly lower energy such as 1-2 keV will have a shorter range (comparable to the thickness of the specimen) and are likely to be more suited for this application. Operating electron beams at lower energies also reduces the cost of the electronics for the instrument.

The total energy of the pulse required for an ablation and plasma formation at the specimen can be estimated from the energy balance. Assuming an ablation volume of 10×10×10 nm we can estimate the number of atoms in such volume with an assumption that the atoms are spaced 0.1 nm apart. Thus, the volume subjected to ablation will have 100×100×100 atoms in all three dimensions. This leads to a total of 1 million atoms. In order to break the bonds and heat up atoms to 7000 K one needs to supply ˜2 eV per each atom. Thus, the total amount of energy needed to create the desired plasma is 2 MeV. Considering that the energy of the incoming electrons might be utilized with only 50% efficiency we arrive to the total energy of the electron beam being 4 MeV. Since each electron carries 2 keV, the pulse may need to contain 2000 electrons in order to trigger an ablation. If a pulse of this magnitude arrives within 10 ps it leads to an electron current of 32 □A concentrated into a 10 nm diameter spot.

At this level of electron current and at this electron velocity the space charge effects should be fairly minor. When a larger area needs to be ablated the current will increase with the area and the space charge effects will grow and might become significant. Therefore, the optimal size of the electron beam could be at 10 nm diameter. A much narrower beam is harder to produce and once it enters the specimen at a 1-2 keV energy it would spread to 10 nm volume anyway.

From the peak current and space charge effects point of view it is beneficial to spread the pulse longer. But, the duration of the beam cannot be longer than the time it takes for the plasma to expand. Thus, the optimal pulse duration will need to be around 10 ps.

The 10 nm size of the electron beam matches well with the 10 nm size of an antibody. Therefore, only a few antibodies can be interrogated in a given ablation event. The signal from that event will not exceed a signal generated from a few metal tags. This means that the upper limit of dynamic range for such system is reduced to just a few copies per pixel. This could simplify the ion detection system.

If the plasma ionization is sampled efficiently and a tagging reagent is ionized at nearly 100% this would produce 100 ions at the detector assuming close to 100% efficient transmission of ions through the ion path. The ion optics design for the ˜100% efficient transmission will be facilitated by the compact phase space volume of the ion beam emerging from the plasma. Thus, each individual tag may generate a detection event that is easily recognizable from the noise. Therefore, a single copy detection of antibodies becomes a standard mode of operation. This is of high value to mass cytometry customers for several reasons: the antibodies can be counted with high fidelity and their respective locations will be fully characterized; mass tags can then be barcoded to increase the number of readout channels.

Mass Spectrometer Considerations

Regardless of which approach is used to shrink the ablation volume to an appropriate size, the ions will need to be accelerated immediately from the sample and injected into the mass spectrometer. This will likely require the sample carrier to be conductive (e.g., using an ITO-coated microscope slide or using a conductive coating made of lower-mass atoms that will not show up in our analyte ion channels, such as a graphene coating).

Various configurations of ion optics could be used, such as magnetic sector mass analyzers with multiplexed multichannel detection, TOF mass analyzer without pulse extraction or a TOF mass analyzer without pulse extraction. In the case of a TOF with pulse extraction the pulse can be synchronized with the firing of the electron beam. The purpose of the pulsed extraction could be to improve instrument mass resolution as practiced in the art of MALDI mass spectrometers. There, the technique goes under the name of delayed extraction.

A benefit of the proposed ionization method over our current ICP-based instrumentation is that there would be no background ions from carrier/plasma gases, etc., and so the mass range of the analyzer can be extended to lower masses. High brightness ion species such as carbon+ ions would be present in the ion beam of this method but can be filtered out on the basis of TOF or magnetic separation. On the other hand, molecular ions and clusters would likely show up in the data and complicate the analysis as compared to our current instrument. The majority of the molecular ions and clusters will appear in the mass range that is outside of the mass range of interest for the elemental tags. Thus, they too can be filtered out by a suitable mass spectrometry filtering. As an alternative, molecular ions and clusters could be suppressed by inducing ion fragmentation by means know in the art of mass spectrometry.

Furthermore, by immediately accelerating the ions away from the ablation site the time duration of the ion pulse in the mass analyzer would be very short, which means a vast improvement in the scanning rate would be possible as compared to our current IMC (Hyperion) instrument—up to tens or hundreds of kHz for TOF and up to 100 MHz for magnetic sector instrument. In the case of a magnetic sector instrument the limiting factor could be the pulse duration at the detection channel. The ion optics of a magnetic sector instrument can be designed to maintain ion pulse duration at the detector surface on the scale of 10 ns. This may require the ion optics to contain compensation due to the energy spread introduced by the plasma expansion. A cross over ion optics technology fusing a TOF technology that maintains a narrow beam pulse at the detector and a multi-channel magnetic sector technology can be applied to operate at such high acquisition rates.

Electron Pulse Generation

The electron pulse needs to produce electrons with the energy on the scale of 1-2 keV. The optimal pulse duration is at around 10 ps. The number of electrons in the pulse required for creating a plasma is around 2000 to 20000. The size of the electron emitter or the beam restricting aperture can be on the order of 1 micrometer providing that the energy distribution of emitted ions facilitates refocusing of the beam to the 10 nm spot size. Schottky electron emitters can be well suited for this task. Ultrafast pulse electronics will be required to create 10 ps wide pulses. A longer electron pulse can be extracted from the emitter and then compressed by an application of an extraction pulse—a similar technique facilitates time of flight focusing in TOF mass analyzers. Alternatively, 10 ps pulse of electrons can be generated from a photocathode. A picosecond or a femtosecond laser can be focused to a 1 micrometer spot to emit the electrons. GaAs or other materials with Negative Electron Affinity (NEA) can be used to serve as an emitter.

The pulse of electrons can be focused to the specimen using a charged particle optics element—an electron beam objective. This element can employ magnetic focusing or electrostatic focusing. Electrostatic focusing could be a cheaper and simpler option for operating with electron energy of 1-2 keV. The design of the electrostatic electron beam objective also needs to support an immersion field that extracts ions from the plasma. Magnetic focusing, on the other hand, can still include the extraction field, but because the big difference in mass between electrons and ions the magnetic objective will act predominantly on electrons while ion trajectories to the first approximation will be unaffected by the magnetic field. This could simplify the design of the objective.

The path of electrons can be separated from the path of ions using methods known in the ion optics art. For example, the electron beam can be deflected by magnetic field while the ions will continue to follow a straight trajectory.

Sample Considerations

Because the ablation volume is so much smaller compared to our standard platform, the number of analyte ions per laser ablation event is greatly reduced. This would likely be a problem if the end-to-end detection efficiency is not proportionally improved. Due to the lack of vacuum interface, and the possibility of using a TOF or a magnetic mass analyzer, the end-to-end detection efficiency may be significantly higher. On the other hand, the ionization efficiency of the analyte ions could be reduced as compared to our ICP-based instruments due to some recombination of the plasma during its expansion phase. Either way, the technique would obviously benefit from new staining techniques increasing the number of analyte ions per volume.

Another consideration is that the short ablation depth means that thin samples will need to be used, on the order of 100 nm or thinner. These are routinely used in electron microscopy. These samples are resin-embedded, which would likely be beneficial due to dimensional stability and reproducibility of ablation threshold regardless of the inhomogeneity of the biological sample.

A large number of serial sections can be prepared for a single specimen and then quickly read out by the proposed method. This makes this methods well suited for 3D analysis of biological sections. Indeed, at 1 Mpixel/s and 100 nm pixel size an area of 100×100 micrometers can be read out in 1 second and the third dimension can be read out at 1000 layers in 1000 seconds leading to a full 3D image of a 100×100×100 micrometers volume read out in under 20 minutes with a large number of channels detected simultaneously.

Finally, the sensitivity of the instrument at the level of single copy detection and the instrument's ability to image individual antibodies will facilitate tagging of individual antibodies with mass tag barcodes. This, in-turn, allows access to a vast number of tagging options, such that experiments with even 1000 different antibodies could become possible (e.g. using 10 mass channels with binary On/Off barcodes leads to 210=1024 available staining channels).

Additional Aspects of the Direct Ionization System and Methods

The system and methods of direct ionization imaging mass spectrometry may have alternative or additional aspects as described below.

For example, the system may contain a sample chamber, which is the component in which the sample is placed when it is subjected to analysis. The sample chamber may comprise a stage, which holds the sample (typically the sample is on a sample carrier, such as a microscope slide, e.g. a tissue section, thin EM section, a monolayer of cells or individual cells, such as where a cell suspension has been dropped onto the microscope slide, and the slide is placed on the stage). The sampling and ionisation system acts to remove material from the sample in the sample chamber (the removed material being called sample material herein) which is converted into elemental ions, e.g., as part of the process that causes the removal of the material from the sample.

The ionised material is then analysed by the second system which is the detector system. The detector system can take different forms depending upon the particular characteristics of the ionised sample material being determined, for example a mass detector in mass spectrometry-based analyser apparatus.

In certain aspects, the sampling and ionization system comprises a radiation source that directs radiation (such as a laser or an electron beam) onto a spot of the sample, so as to form a plasma that atomizes and ionizes material at that spot, forming elemental ions (i.e., atomic ions).

In certain aspects, a laser scanning system directs laser radiation onto the sample to be ablated and forms a plasma at that spot. As the laser scanner is faster moving (i.e. has a quicker response time) than a sample stage, due to much lower or no inertia, it enables ablation of discrete spots on the sample to be performed more quickly, so enabling a significantly greater area to be ablated per unit time without loss of resolution. In addition, the rapid change in the spots onto which laser radiation is directed permits the ablation of random patterns, for instance so that a whole cell of non-uniform shape is ablated, by a burst of pulses/shots of laser radiation in rapid succession directed onto locations on the sample using the laser scanner system, and then ionised and detected as a single cloud of material, thus enabling single cell analysis. The locations are typically neighbouring positions, or close to one another.

The ions of the sample material are then passed into the detector system. Although the detector system can detect many ions, some of these may be ions of the atoms that naturally make up the sample. In some applications, for example analysis of minerals, such as in geological or archaeological applications, this may be sufficient.

In some cases, for example when analysing biological samples, the native element composition of the sample may not be suitably informative. This is because, typically, all proteins and nucleic acids are comprised of the same main constituent atoms, and so while it is possible to tell regions which contain protein/nucleic acid from those that do not contain such proteinaceous or nucleic acid material, it is not possible to differentiate a particular protein from all other proteins. However, by labelling the sample with atoms not present in the material being analysed under normal conditions, or at least not present in significant amounts (for example certain transition metal atoms, such as rare earth metals; see section on labelling below for further detail), specific characteristics of the sample can be determined. In common with IHC and FISH, the detectable labels can be attached to specific targets on or in the sample (such as fixed cells or a tissue sample on a slide), inter alia through the use of SBPs such as antibodies, nucleic acids or lectins etc. targeting molecules on or in the sample. In order to detect the ionised label, the detector system is used, as it would be to detect ions from atoms naturally present in the sample. By linking the detected signals to the known positions of the sampling of the sample which gave rise to those signals it is possible to generate an image of the atoms present at each position, both the native elemental composition and any labelling atoms (see e.g. references 2, 3, 4, 5). In aspects where native elemental composition of the sample is depleted prior to detection, the image may only be of labelling atoms. The technique allows the analysis of many labels in parallel (also termed multiplexing), which is a great advantage in the analysis of biological samples, now with increased speed due to the application of a laser scanning system in the apparatus and methods disclosed herein.

Thus, the invention provides an apparatus for analysing a sample, such as a biological sample, comprising:
(i) a sampling and ionisation system to remove material from the sample and to ionise said material to form elemental ions, comprising a radiation source (such as a laser source) for forming a plasma at a sample spot, and optionally a laser scanning system and/or solid support (e.g., such as a sample carrier, transparent slide, electron microscopy mesh, and/or translatable sample stage); and
(ii) a detector to receive elemental ions from said sampling and ionisation system and to detect said elemental ions.

Scanning System

In certain aspects, ablation of the sample may be performed by a scanning IMC system. A source of radiation, such as a laser beam or a charged particle beam (such as ion beam or electron beam) source may be scanned across a portion of the sample to produce a single transient (e.g., single instance of ablated material). The transient may be an ablation plume delivered to ICP for atomization and ioinzation prior to detection by MS. Alternatively, the transient may be ionized by radiation at or close to the surface of the sample, as described herein. Scanning with an ion beam or electron beam (e.g., using ion optics) may allow for ablation of a small region of interest of the sample at high resolution (such as a single organelle). For example, the region of interest may have an area of less than 100,000 nm ², less than 50,000 nm ², or less than 20,000 nm ², or less than 10,000 nm ². Alternatively, the region of interest could be larger, such as a single cell or even a group of cells. In certain aspects, the scanning system may employ direct ionizing radiation as described herein, such that a plasma if formed from the radiated sample.

One or more imaging modalities other than IMC, as described herein, may be used to identify one or more regions of interest for scanning. In certain aspects, scanning may be performed on an array of ultrathin tissue sections, e.g., such that volumetric analysis may be performed for regions of interest across serial sections.

Radiation Scanning System

Certain aspects comprise a scanning system for scanning radiation, such as a laser scanning system, a scanning electron beam or a scanning ion beam. The radiation may be focused (e.g., by light optics or ion optics) before or after the scanning system, as described herein.

A laser scanning system directs laser radiation onto the sample to be ablated. As the laser scanner is capable of redirecting the position of laser focus on the sample much more quickly than moving the sample stage relative to a stationary laser beam (due to much lower or no inertia in the operative components of the scanning system), it enables ablation of discrete spots on the sample to be performed more quickly. This quicker speed can enable a significantly greater area to be ablated and recorded as a single pixel, or the speed of the laser spot movement can simply translate to, e.g., an increase in pixel acquisition rate, or a combination of both. In addition, the rapid change in the location of the spot onto which a pulse of laser radiation can be directed permits the ablation of arbitrary patterns, for instance so that a whole cell of non-uniform shape is ablated, by a burst of pulses/shots of laser radiation in rapid succession directed onto locations on the sample by the laser scanner system, and then ionised and detected as a single cloud of material, thus enabling single cell analysis,

The use of a scanning system to increase the acquisition rate provides numerous advantages over other strategies for increasing the rate at which a sample is imaged. For instance, an area of at least 100 pm x 100 pm can be ablated with a single laser pulse using appropriately adapted apparatus.

Accordingly, to enable rapid scanning, the laser scanning system may need to be able to rapidly switch the position at which the laser radiation is being directed on the sample. The time taken to switch the ablating position of the laser radiation is termed the response time of the laser scanning system. Accordingly, in some embodiments of the invention, the response time of the laser sampling system is quicker than 1 ms, quicker than 500 ps, quicker than 250 ps, quicker than 100 ps, quicker than 50 ps, quicker than 10 ps, quicker than 5 ps, quicker than 1 ps, quicker than 500 ns, quicker than 250 ns, quicker than 100 ns, quicker than 50 ns, quicker than 10 ns, quicker than 1 ns, quicker than 100 ps, or quicker than 10 ps.

The laser scanning system can direct the laser beam in at least one direction relative to the sample stage on which the sample is positioned during ablation. In some instances, the laser scanning system can direct the laser radiation in two directions relative to the sample stage. In certain aspects, the laser scanning system may be configured to only scan in one direction. For example, the laser scanning system may only have one positioner, which is capable of only scanning in only one direction. In such cases, the sample stage may be moved to provide motion in a different direction, non-parallel to the direction of the laser beam. In certain aspects, the area scanned (e.g., region of interest) may be increased by movement of the sample stage while the laser beam is being directed by the laser scanning system. In the absence of movement of the sample stage, the area scanned by the laser beam may be limited by the size of a window the beam passes through, such as a window in the top of the laser ablation cell and/or a window in a portion of an injector tube within the laser ablation cell positioned for uptake of irradiated sample. As such, movement of the stage during laser scanning may increase the area continuously scanned. In certain aspects, multiple regions of interest are scanned.

In some instances, the laser scanning system directs the laser beam in both the X and Y axes. Accordingly, in this instance more advanced ablation patterns can be generated. For instance, when the laser scanning system can direct the laser radiation in both the X and Y axes, the sample stage may be moved at constant speed in the X axis (thereby eliminating inefficiencies associated with the inertia of the sample stage during the movement across each row other than acceleration/deceleration at the start/end of the row), while the laser scanning system directs laser radiation pulses up and down columns on the sample whilst compensating for the movement of the sample stage. To achieve this movement, the triangle-wave control signals can be applied to the scanner in the X direction, and a sawtooth signal in the Y direction. Alternatively, it may be desirable to apply a sawtooth drive signal to the scanner in the Y direction, depending on the processing algorithm used, as would be appreciated by the skilled person. As a further alternative, one of the scanner components may be pre-rotated slightly, to pre-compensate for the slanted scanning pattern. In some embodiments, the controller of the laser scanning system will cause the laser scanner system to move the beam in a figure-of-eight pattern as the sample stage moves.

Another application is arbitrary ablation area shaping. If a high repetition rate laser is used, it is possible to deliver a burst of closely-spaced laser pulses in the same time that a nanosecond laser would deliver one pulse. By quickly adjusting the X and Y positions of the ablation spot during a burst of laser pulses, ablation craters of arbitrary shape and size (down to the diffraction limit of the light) can be created. For instance, the n and n+1 positions in a burst may be no more than a distance equal to 10× the laser spot diameter apart (based on the centre of the ablation spot of the nth spot and the (n+1)th spot), such as less than 8×, less than 5×, less than 2.5 times, less than 2× times, less than 1.5×, around 1×, or less than 1× the diameter of the spot size.

Accordingly, in some embodiments, the laser scanning system comprises a positioner to impart a first relative movement of a laser beam emitted by the laser with respect to the sample stage (e.g. the Y axis relative to the surface of the sample). In some embodiments, the positioner of the laser scanning system is capable of imparting a second relative movement of the laser beam with respect to the sample stage, wherein the first and second relative movements are not parallel, such as wherein the relative movements are orthogonal (e.g. the first movement direction is in the Y axis relative to the surface of the sample and the second movement direction is in the X axis relative to the surface of the sample).

In some embodiments, the laser scanning system further comprises a second positioner capable of imparting a second relative movement of the laser beam with respect to the sample stage, wherein the first and second relative movements are not parallel, such as wherein the relative movements are orthogonal (e.g. the first movement direction is in the Y axis relative to the surface of the sample and the second movement direction is in the X axis relative to the surface of the sample).

Laser Scanning Positioners

Any component which can rapidly direct laser radiation to different locations on the sample can be used as a positioner in the laser scanning system. The various types of positioner discussed below are commercially available, and can be selected by the skilled person as appropriate for the particular application for which an apparatus is to be used, as each has inherent strengths and limitations. In some embodiments of the invention, as set out below, multiple of the positioners discussed below can be combined in a single laser scanning system. Positioners can be grouped generally into those that rely on moving components to introduce relative movements into the laser beam (examples of which include galvanometer mirror, piezoelectric mirror, MEMS mirror, polygon scanner etc.) and those that do not (examples of which include such acousto-optic devices and electro-optic devices). The types of positioners listed in the previous sentence act to controllably deflect the beam of laser radiation to various angles, which results in a translation of the ablation spot. The laser scanning system may comprise a single positioner, or may comprise a positioner and a second positioner. The description of “positioner” and “second positioner” where two positioners are present in the laser scanning system does not define an order in which a pulse of laser radiation hits the positioners on its path from the laser source to the sample.

At the rates of radiation pulses discussed herein, it may be desired for at least one of the positioners to be a non-inertial positioner. In certain aspects, one positioner may be inertial (e.g., mirror based) for a first direction while the other may be non-inertial (e.g., solid state) for a second direction.

As discussed below, the positioners can take the form of mirror-based positioner (such as a galvanometer mirror, a polygon scanner, a MEMS mirror, piezoelectric device mirror), and/or a solid state positioner (such as an AOD or an EOD). The sample stage can also be moved, so as to produce relative movement of a sample on the stage relative to the beam of laser radiation. The sample stage typically can move the sample in the x and y, and optionally z, axes, and its movement can be co-ordinated by a controller module with the movement of the positioners in the laser scanning system. For example, the stage may move the sample in a first direction, and the position can introduce a relative movement into the laser beam in a second (i.e. not parallel, such as principally orthogonal).

Galvanometer Mirror Positioner

Galvanometer motors on the shaft of which a mirror is mounted can be used to deflect the laser radiation onto different locations on the sample. Movement can be achieved by using a stationary magnet and a moving coil, or a stationary coil and a moving magnet. The arrangement of a stationary coil and moving magnet produces quicker response times. Typically sensors are present in the motor to sense the position of the shaft and the mirror, thereby providing feedback to the controller of the motor. One galvanometer mirror can direct the laser beam within one axis, and accordingly pairs of galvanometer mirrors are used to enable direction of the beam in both X and Y axes using this technology.

One strength of the galvanometer mirror is that it enables large angles of deflection (much greater than, for example, solid state deflectors), which as a consequence can allow more infrequent movement of the sample stage. However, as the moving components of the motor and the mirror have a mass, they will suffer from inertia and so time for acceleration of the components may be accommodated within the sampling method. Typically, non-resonant galvanometer mirrors are used. As will be appreciated by the skilled person, resonant galvanometer mirrors can be used, but an apparatus using only such resonant components as positioners of the laser scanning system will not be capable of arbitrary (also known as random access) scanning patterns. As it is based on a mirror, a galvanometer mirror deflector can degrade laser radiation beam quality and increase the ablation spot size, and so will again be understood by the skilled person to be most applicable in situations which tolerate such effects on the beam.

Galvanometer-mirror based apparatus can be prone to errors in their positioning, through sensor noise or tracking error. Accordingly, in some embodiments, each mirror is associated with a positional sensor, which sensor feeds back on the mirror's position to the galvanometer to refine the position of the mirror. In some instances, the positional information is relayed to another component, such as an AOD or EOD in series to the galvanometer-mirror, which corrects for mirror positioning error.

Galvanometer mirror systems and components are commercially available from various manufacturers such as Thorlabs (NJ, USA), Laser2000 (UK), ScanLab (Germany), and Cambridge Technology (MA, USA).

In embodiments comprising only galvanometer mirror based positioners, the rate at which ablative laser pulses are capable of being directed at the sample may be between 200 Hz-1 MHz, 200 Hz-100 kHz, 200 Hz-50 kHz, 200 Hz-10 kHz, 1 kHz-1 MHz, 5 kHz-1 MHz, 10 kHz-1 MHz, 50 kHz-1 MHz, 100 kHz-1 MHz, 1 kHz to 100 kHz or 10 kHz-100 kHz.

Piezoelectric Mirror Positioners

Similarly, piezoelectic actuators on the shaft of which a mirror is mounted can be used as positioners to deflect the laser radiation onto different locations on the sample. Again, as mirror positioners, which are based on the movement of components with mass, there will inherently be inertia and so a time overhead inherent in movement of the mirror by this component. Accordingly, this positioner will be understood by the skilled person to have application in certain embodiments where nanosecond response times for the laser scanning system are not mandatory. Similarly, as it is based on a mirror, the piezoelectric mirror positioner will degrade laser radiation beam quality and increase the ablation spot size, and so will again be understood by the skilled person to be most applicable in situations which tolerate such effects on the beam.

In piezoelectric mirrors based on a tilt-tip mirror arrangement, direction of the laser radiation onto the sample in the X and Y axes is provided in a single component.

Piezoelectric mirrors are commercially available from suppliers such as Physik Instrumente (Germany).

Accordingly, in some embodiments of the invention, the laser scanner system comprises a piezoelectric mirror, such as a piezoelectric mirror array or a tilt-tip mirror.

In embodiments comprising only piezoelectric mirror based positioners, such as a piezoelectric mirror array or a tilt-tip mirror, the rate at which ablative laser pulses are capable of being directed at the sample may be between 200 Hz-1 MHz, 200 Hz-100 kHz, 200 Hz-50 kHz, 200 Hz-10 kHz, 1 kHz-1 MHz, 5 kHz-1 MHz, 10 kHz-1 MHz, 50 kHz-1 MHz, 100 kHz-1 MHz, 1 kHz to 100 kHz or 10 kHz-100 kHz.

MEMS Mirror Positioner

A third kind of positioner which is dependent on physical movement of the surface directing the laser radiation onto a sample is a MEMS (Micro-Electro Mechanical System) mirror. The micro mirror in this component can be actuated by electrostatic, electromechanic and piezoelectric effects. A number of strengths of this type of component derive from their small size, such as low weight, ease of positioning in the apparatus and low power consumption. However, as deflection of the laser radiation is still ultimately based on the movement of parts in the component, and as such the parts will experience inertia. Once again, as it is based on a mirror, the MEMS mirror positioner will degrade laser radiation beam quality and increase the ablation spot size, and so the skilled person will again understand that such scanner components are therefore applicable in situations which tolerate such effects on the laser radiation.

MEMS mirrors are commercially available from suppliers such as Mirrorcle Technologies (CA, USA), Hamamatsu (Japan) and Preciseley Microtechnology Corporation (Canada).

Accordingly, in some embodiments of the invention, the laser scanner system comprises a MEMS mirror.

In embodiments comprising only a MEMS mirror based positioner, the rate at which ablative laser pulses are capable of being directed at the sample may be between 200 Hz-1 MHz, 200 Hz-100 kHz, 200 Hz-50 kHz, 200 Hz-10 kHz, 1 kHz-1 MHz, 5 kHz-1 MHz, 10 kHz-1 MHz, 50 kHz-1 MHz, 100 kHz-1 MHz, 1 kHz to 100 kHz or 10 kHz-100 kHz.

Polygon Scanner

A further kind of positioner which is dependent on physical movement of the surface directing the laser radiation onto a sample is a polygon scanner. Here, a reflective polygon or multifaceted mirror spins on a mechanical axis, and every time a flat facet of the polygon is traversing the incoming beam an angular deflected scanning beam is produced. Polygon scanners are one dimensional scanners, can direct the laser beam along a scanned line (and so a secondary positioner is needed in order to introduce a second relative movement in the laser beam with respect to the sample, or the sample needs to be moved on the sample stage). In contrast to the back-and-forward motion of e.g. a galvanometer based scanner, once the end of one line of the raster scan has been reached, the beam is directed back to the position at the start of the scan row. The polygons can be regular or irregular, depending on the application. Spot size is dependent on facet size and flatness, and the scan line length/scan angle on the number of facets. Very high rotational speeds can be achieved, resulting in high scanning speeds. However, this kind of positioner does have drawbacks, in terms of lower positioning/feedback accuracy due to facet manufacturing tolerances and axial wobble, as well as potential wavefront distortion from the mirror surface. The skilled person will again understand that such scanner components are therefore applicable in situations which tolerate such effects on the laser radiation.

Polygon scanners are commercially available for example from Precision Laser Scanning (AZ, USA), II-VI (PA, USA), Nidec Copal Electronics Corp (Japan) inter alia.

In embodiments comprising only a polygon scanner based positioner, the rate at which ablative laser pulses are capable of being directed at the sample may be between 200 Hz-10 MHz, 200 Hz-1 MHz, 200 Hz-100 kHz, 200 Hz-50 kHz, 200 Hz-10 kHz, 1 kHz-10 MHz, 5 kHz-10 MHz, 10 kHz-10 MHz, 50 kHz-10 MHz, 100 kHz-10 MHz, 1 kHz-1 MHz, 10 kHz-1 MHz or 100 kHz-1 MHz.

Electro-Optical Deflector (EOD) Positioner

Unlike the preceding types for laser scanner system component, EODs are solid state components—i.e. they comprise no moving parts. Accordingly, they do not experience mechanical inertia in deflecting laser radiation and so have very fast response times, on the order of 1 ns. They also do not suffer from wear as mechanical components do. An EOD is formed of an optically transparent material (e.g. a crystal) that has a refractive index which varies dependent on the electric field applied across it, which in turn is controlled by the application of an electric voltage over the medium. The refraction of the laser radiation is caused by the introduction of a phase delay across the cross section of the beam. If the refractive index varies linearly with the electric field, this effect is referred to as the Pockels effect. If it varies quadratically with the field strength, it is referred to as the Kerr effect. The Kerr effect is usually much weaker than the Pockels effect. Two typical configurations are an EOD based on refraction at the interface(s) of an optical prism, and based on refraction by an index gradient that exists perpendicular to the direction of the propagation of the laser radiation. To place an electric field across the EOD, electrodes are bonded to opposing sides of the optically transparent material that acts as the medium. Bonding one set of opposed electrodes generates a 1-dimensional scanning EOD. Bonding a second set of electrodes orthogonally to the first set electrodes generates a 2-dimensional (X, Y) scanner.

The deflection angle of EODs is lower than galvanometer mirrors, for instance, but by placing several EODs in sequence, the angle can be increased, if required for a given apparatus set up. Exemplary materials for the refractive medium in the EOD include Potassium Tantalate Niobate KTN (KTaₓNb₁₋ₓO₃), LiTaO₃, LiNbO₃, BaTiO₃, SrTiO₃, SBN (Sr₁₋ₓBaₓNb₂O₆) and KTiOPO₄ with KTN displaying greater deflection angles at the same field strength.

The angular accuracy of EODs is high, and is principally dependent on the accuracy of the driver connected to the electrodes. Further, as noted above, the response time of EODs is very quick, and quicker even than the AODs discussed below (due to the fact that a (changing) electric field in a crystal is established at the speed of light in the material, rather than at the acoustic velocity in the material; see discussion in Romer and Bechtold, 2014, Physics Procedia 56:29-39).

Accordingly, in some embodiments of the invention, the laser scanner system comprises an EOD. In some embodiments, the EOD is one in which two sets of electrodes have been orthogonally connected to the refractive medium.

In embodiments comprising an EOD based positioner, the rate at which ablative laser pulses are capable of being directed at the sample may be between 200 Hz-100 MHz, 200 Hz-10 MHz, 200 Hz-1 MHz, 200 Hz-100 kHz, 200 Hz-50 kHz, 200 Hz-10 kHz, 1 kHz-100 MHz, 5 kHz-100 MHz, 10 kHz-100 MHz, 50 kHz-100 MHz, 100 kHz-100 MHz, 1 MHz-100 MHz, 10-100 MHz, 1 kHz-10 MHz, 10 kHz-10 MHz, or 100 kHz-10 MHz.

Acousto-Optical Deflector (AOD) Positioner

This class of positioner is also a solid state component. The deflection of the component is based on propagating sound waves in an optically transparent material to induce a periodically changing refractive index. The changing refractive index occurs because of compression and rarefaction of the material (i.e. changing density) due to the sound waves propagating through the material. The periodically changing refractive index diffracts a laser beam traveling through the material by acting like an optical grating.

The AOD is generated by bonding a transducer (typically a piezoelectric element) to an acousto-optic crystal (e.g. TeO₂). The transducer, driven by an electrical amplifier, introduces acoustic waves into the refractive medium. At the opposite end, the crystal is typically skew cut and fitted with an acoustic absorbing material to avoid reflection of the acoustic wave back into the crystal. As the waves propagate in one direction through the crystal, this forms a 1-dimensional scanner. By placing two AODs orthogonally in series, or by bonding two transducers on orthogonal crystal faces, a 2-dimensional scanner can be generated.

As for EODs, deflection angle of AODs is lower than galvanometer mirrors, but again compared to such mirror-based scanners the angular accuracy is high, with the frequency driving the crystal being digitally controlled, and commonly resolvable to 1 Hz. Romer and Bechtold, 2014, note that drift, common for galvo-based scanners, as well as temperature dependency in comparison to analog controllers, are not usually problems encountered by AODs.

Exemplary materials for use as the refractive medium of the AOD include tellurium dioxide, fused silica, crystalline quartz, sapphire, AMTIR, GaP, GaAs, InP, SF6, lithium niobate, PbMoO₄, arsenic trisulfide, tellurite glass, lead silicate, Ge₅₅As₁₂S₃₃, mercury (I) chloride, and lead (II) bromide.

In order to change the angle of deflection, the frequency of sound introduced to the crystal must be changed, and it takes a finite amount of time for the acoustic wave to fill the crystal (dependent on the speed of propagation of the soundwave in the crystal and on the size of the crystal), thereby meaning there is a degree of delay. Nevertheless, response time is relatively fast, compared to laser system positioners based on moving parts.

A further characteristic of AODs which can be exploited in particular instances is that the acoustic power applied to the crystal determines how much of the laser radiation is diffracted versus the zero-order (i.e. non-diffracted) beam. The non-diffracted beam is typically directed to a beam dump. Accordingly, an AOD can be used to effectively control (or modulate) the intensity and power of the deflected beam at high speed.

Diffraction efficiency of the AOD is typically non-linear, and accordingly, curves of diffraction efficiency vs. power can be mapped for different input frequencies. The mapped efficiency curves for each frequency can then be recorded as an equation or in a look-up table for subsequent use in the apparatus and methods disclosed herein.

Accordingly, in some embodiments of the invention, the laser scanner system comprises an AOD.

Combinations of Positioners

In the preceding paragraphs, two types of laser scanning system positioners are discussed: mirror based, comprising moving parts, and solid state positioners. The former are characterised by high angles of deflection, but comparatively slow response times due to inertia. In contrast, solid state positioners have a lower deflection angle range, but much quicker response times. Accordingly, in some embodiments of the invention, the laser scanning system includes both mirror based and solid state components in series. This arrangement takes advantages of the strengths of both, e.g. the large range provided by the mirror-based components, but accommodating the inertia of the mirror-based components. See, for instance, Matsumoto et al., 2013 (Journal of Laser Micro/Nanoengineering 8:315:320).

Accordingly, a solid state positioner (i.e. AOD or EOD) can be used for instance to correct for errors in the mirror-based scanner components. In this case, positional sensors relating to mirror-position feedback to the solid state component, and the angle of deflection introduced into the beam of laser radiation by the solid state component can be altered appropriately to correct for positional error of the mirror-based scanner components.

One example of a combined system includes a galvanometer mirror and an AOD (where the AOD may enable deflection in one or two directions (by using two AODs in series, or bonding two drivers to orthogonal faces of the crystal of a single AOD)). The system may comprise two galvanometer mirrors so as to generate a two dimensional scanning system, in combination with an AOD (where the AOD may enable deflection in one or two directions (by using two AODs in series, or bonding two drivers to orthogonal faces of the crystal of a single AOD)). In such a system, the rate at which ablative laser pulses are capable of being directed at the sample may be between 200 Hz-100 MHz, 200 Hz-10 MHz, 200 Hz-1 MHz, 200 Hz-100 kHz, 200 Hz-50 kHz, 200 Hz-10 kHz, 1 kHz-100 MHz, 5 kHz-100 MHz, 10 kHz-100 MHz, 50 kHz-100 MHz, 100 kHz-100 MHz, 1 MHz-100 MHz, 10-100 MHz, 1 kHz-10 MHz, 10 kHz-10 MHz, or 100 kHz-10 MHz. An alternative example of a combined system includes a galvanometer mirror and an EOD (where the EOD may enable deflection in one or two directions (by bonding two orthogonally arranged electrodes to the crystal)). The system may comprise two galvanometer mirrors so as to generate a two dimensional scanning system, in combination with an EOD (where the EOD may enable deflection in one or two directions (by bonding two orthogonally arranged electrodes to the crystal)). In such as system, the rate at which ablative laser pulses are capable of being directed at the sample may be between 200 Hz-100 MHz, 200 Hz-10 MHz, 200 Hz-1 MHz, 200 Hz-100 kHz, 200 Hz-50 kHz, 200 Hz-10 kHz, 1 kHz-100 MHz, 5 kHz-100 MHz, 10 kHz-100 MHz, 50 kHz-100 MHz, 100 kHz-100 MHz, 1 MHz-100 MHz, 10-100 MHz, 1 kHz-10 MHz, 10 kHz-10 MHz, or 100 kHz-10 MHz.

Additional Optional Components of the Laser Scanning System

To control the positioners of the laser scanning system, the laser scanning system may comprise a scanner control module (such as a computer or a programmed chip), which coordinates the movement of the positioners in the Y and/or X axes, together with the movement of the sample stage. In some instances, such as back and forth rastering, the appropriate pattern will be pre-programmed into the chip. In other instances, however, inverse kinematics can be applied by the control module to determine the appropriate ablation pattern to be followed. Inverse kinematics may be particularly useful, for example, in generating arbitrary ablation patterns, so as to plot the best ablation course between multiple and/or irregularly shaped cells to be ablated. The scanner control module may also co-ordinate the emission of pulses of laser radiation, e.g. by also co-ordinating operation of the pulse picker.

Sometimes, a positioner can cause dispersion of the beam of laser radiation it directs. Accordingly, in some embodiments of the apparatus described herein, the laser scanning system comprises at least one dispersion compensator between the positioner and/or the second positioner and the sample, adapted so as to compensate for any dispersion caused by the positioner. When the positioner is an AOD and/or the second positioner is an AOD the dispersion compensator is (i) a diffraction grating having a line spacing suitable for compensating for the dispersion caused by the positioner and/or second positioner; (ii) a prism suitable for compensating for the dispersion caused by the positioner and/or second positioner (i.e. appropriate material, thickness, and prism angle); (iii) a combination comprising the diffraction grating (i) and prism (ii); and/or (iv) a further acousto-optic device. In instances where a first positioner causes a dispersion and a second positioner causes a dispersion, the laser scanning system may comprise a first dispersion compensator to compensate for any dispersion caused by the first positioner and a second dispersion compensator to compensate for any dispersion caused by the second positioner. WO03/028940 describes how another appropriately adapted AOD can be used to compensate for dispersion caused by an AOD positioner.

Sometimes, due to the movement of the positioners directing laser radiation to different locations, the focal length of a beam of radiation can vary with respect to the position of the sample. This can be compensated for in a number of ways. For instance, a movable focusing lens can be moved so as to maintain a spot size of constant, or near constant, diameter on the sample irrespective of the particular location on the sample to which the laser radiation is being directed. Alternatively, a tunable focus lens (commercially available from Optotune), may be used. It is also possible to compensate for spot size variation by altering the height of the sample stage in the z axis. Both of these techniques rely on moving parts, however, introducing a timing overhead into operation of the system. If an AOD is used with a Gaussian beam, ablation spot size can be controlled by power applied to the crystal in the AOD, so as to modulate rapidly first order versus zero order beam intensity.

Lasers

As described herein, the radiation may be a laser that ablates a sample spot and forms a plasma that atomizes and ionizes the sample at that spot. The laser may be a UV laser. The laser may have a wavelength of less than 550 nm, less than 500 nm, less than 450 nm, less than 400 nm, less than 350 nm, less than 300 nm, or less than 250 nm. The laser may be a picosecond or femtosecond laser.

Generally, the choice of wavelength and power of the laser used for ablation of the sample can follow normal usage in cellular analysis. The laser must have sufficient fluence to cause ablation to a desired depth, without substantially ablating the sample carrier. A laser pulse energy at or between 10 pj, 100 pj, 500 pj, 1 nJ, 10 nJ, 50 nj, 100 nJ, 500 nJ, 1 uJ, 5 uJ, 10 uJ, 20 uJ, 50 uJ, 100 uJ, and 500 uJ. In some instances, a single laser pulse from such a laser should be sufficient to ablate cellular material for analysis, such that the laser pulse frequency matches the frequency with which elemental ions are generated. In general, to be a laser useful for imaging biological samples, the laser should produce a pulse with duration below 1 ps, 5 ps, 10 ps, 50 ps, 100 ps, 1 fs, 5 fs, 10 fs, 50 fs, 100 fs, 500 fs, such as below 10 ps or between 10 fs and 10 ps and which can be focused to, for example, the specific spot sizes discussed below. In some embodiments of the present invention, to take advantage of the use of the laser scanning system discussed above, the ablation rate (i.e. the rate at which the laser ablates a spot on the surface of the sample) is 200 Hz or greater, such as 500 Hz or greater, 750 Hz or greater, 1 kHz or greater, 1.5 kHz or greater, 2 kHz or greater, 2.5 kHz or greater, 3 kHz or greater, 3.5 kHz or greater, 4 kHz or greater, 4.5 kHz or greater, 5 kHz or greater, 10 kHz or greater, 100 kHz or greater, 1 MHz or greater, 10 MHz or greater, or 100 MHz or greater. Many lasers have a repetition rate in excess of the laser ablation frequency, and so appropriate components, such as pulse pickers etc. can be employed to control the rate of ablation as appropriate. Accordingly, in some embodiments, the laser repetition rate is at least 1 kHz, such as at least 10 kHz, at least 100 kHz, at least 1 MHz, at least 10 MHz, around 80 MHz, or at least 100 MHz, optionally wherein the sampling system further comprises a pulse picker, such as wherein the pulse picker is controlled by the control module that also controls the movement of the sample stage and/or the positioner(s) of the laser scanning system. In other instances, multiple closely spaced pulse bursts (for example a train of 3 closely spaced pulses) can be used to ablate one single spot.

In some embodiments, the laser is adapted to have a pulse repetition rate of at least 100,000 Hz, such as at least 1 MHz, at least 2 MHz, at least 3 MHz, at least 4 MHz, at least 5 MHz, at least 10 MHz, at least 20 MHz, at least 50 MHz, at least 100 MHz, at least 200 MHz, at least 500 MHz or 1GHz or more.

In some embodiments, the laser is adapted to have a pulse energy of between 1 nanoJoule up to 1 milliJoule, such as between 10 nanoJoules and 100 microJoules, between 100 nanoJoules and 10 microJoules, between 500 nanoJoules and 5 microJoules, such as around 1 microJoule, around 2 microJoules, around 3 microJoules or around 4 microJoules.

The time required for analysis of a sample spot is related to the time of radiation, plasma formation, delivery of elemental ions to the mass detector, and detection by the mass detector. Each laser pulse can be correlated to a pixel on the image of the sample that is subsequently built up, as discussed in more detail below.

In some instances a femtosecond laser is used as the laser source. A femtosecond laser is a laser which emits optical pulses with a duration below 1 ps. The generation of such short pulses often employs the technique of passive mode locking. Femtosecond lasers can be generated using a number of types of laser. Typical durations between 30 fs and 30 ps can be achieved using passively mode-locked solid-state bulk lasers. Similarly, various diode-pumped lasers, e.g. based on neodymium-doped or ytterbium-doped gain media, operate in this regime. Titanium-sapphire lasers with advanced dispersion compensation are even suitable for pulse durations below 10 fs, in extreme cases down to approximately 5 fs. The pulse repetition rate is in most cases between 10 MHz and 500 MHz, though there are low repetition rate versions with repetition rates of a few megahertz for higher pulse energies (available from e.g. Lumentum (CA, USA), Radiantis (Spain), Coherent (CA, USA)). This type of laser can come with an amplifier system which increases the pulse energy

There are also various types of ultrafast fiber lasers, which are also in most cases passively mode-locked, typically offering pulse durations between 50 and 500 fs, and repetition rates between 10 and 100 MHz. Such lasers are commercially available from e.g. NKT Photonics (Denmark; formerly Fianium), Amplitude Systems (France), Laser-Femto (CA, USA). The pulse energy of this type of laser can also be increased by an amplifier, often in the form of an integrated fiber amplifier.

Some mode-locked diode lasers can generate pulses with femtosecond durations. Directly at the laser output, the pulse duration is usually around several hundred femtoseconds (available e.g. from Coherent (CA, USA)).

In some instances, a picosecond laser is used. Many of the types of lasers already discussed in the preceding paragraphs can also be adapted to produce pulses of picosecond range duration. The most common sources are actively or passively mode-locked solid-state bulk lasers, for example a passively mode-locked Nd-doped YAG, glass or vanadate laser. Likewise, picosecond mode-locked lasers and laser diodes are commercially available (e.g. NKT Photonics (Denmark), EKSPLA (Lithuania)).

Alternatively, a continuous wave laser may be used, externally modulated to produce pulses of duration less than a nanosecond.

Typically, the laser beam used for ablation in the laser systems discussed herein has a spot size, i.e., at the sampling location, of 100 μm or less, such as 50 μm or less, 25 μm or less, 20 μm or less, 15 μm or less, or 10 μm or less, such as about 3 μm or less, about 2 μm or less, about 1 μm or less, about 500 nm or less, about 250 nm or less, 100 nm or less, 50 nm or less, or 30 nm or less. The distance referred to as spot size corresponds to the longest internal dimension of the beam, e.g. for a circular beam it is the beam diameter, for a square beam it corresponds to the length of the diagonal between opposed corners, for a quadrilateral it is the length of the longest diagonal etc. (as noted above, the diameter of a circular beam with a Gaussian distribution is defined as the distance between the points at which the fluence has decreased to 1/e² times the peak fluence). As an alternative to the Gaussian beam, beam shaping and beam masking can be employed to provide the desired ablation spot. For example, in some applications, a square ablation spot with a top hat energy distribution can be useful (i.e. a beam with near uniform fluence as opposed to a Gaussian energy distribution).

Sometimes, the laser system for emitting multiple wavelengths of laser radiation comprises a single laser source adapted to emit multiple wavelengths of laser radiation (i.e. one laser emits multiple wavelengths of laser radiation; the laser system may include further laser sources). Some laser sources emit laser radiation at a desired wavelength using wavelength conversion methods such as harmonics or sum-frequency generation, by super-continuum generation, by an optical parametric amplifier or oscillator (OPA/OPO) technique, or by a combination of several techniques, as standard in the art. For instance, an Nd-YAG laser generates laser radiation at 1064 nm wavelength, which is called its fundamental frequency. This wavelength can be converted into shorter wavelengths (when needed) by the method of harmonics generation. The 4^{th} harmonic of that laser radiation would be at 266 nm (1064 nm ÷4) and the 5^{th} harmonic would be at 213 nm. Thus, the 4^{th} harmonic can target the optical band of high absorption for DNA material while the 5^{th} harmonic would target the band of high absorption for proteins. In many laser arrangements generation of the 5^{th} harmonic is based on the generation of the 4^{th} harmonic. Thus the 4^{th} harmonic will be already present in the laser generating the 5^{th} harmonics output, although often the lower harmonics (with longer wavelength) are filtered out in the laser. Removal of the appropriate filters thus enables the emission of multiple wavelengths of laser radiation. Examples of such lasers are commercially available from Coherent, Inc, RP Photonics, Lee Laser etc.

Another useful pair of harmonic frequencies is the 4^{th} and the 3^{rd} harmonics of a laser with a fundamental wavelength at around 800 nm. The 4^{th} and the 3^{rd} harmonics here would have wavelengths of 200 nm and 266 nm respectively. Examples of such lasers are commercially available (Coherent, Inc., Spectra Physics).

In some situations, where the first wavelength of laser radiation and the second wavelength of laser radiation are produced by the same laser source, the wavelengths are not produced via harmonics, but from a laser with a broad emission spectrum. The emission spectrum of the laser can be at least 10 nm, such as at least 30 nm, at least 50 nm or at least 100 nm. Multiple wavelengths of light are produced by a white light laser or a supercontinuum laser.

In order to achieve 3D-imaging of the sample, the sample, or a defined area thereof, can be ablated to a first depth, which is not completely through the sample. Following this, the same area can be ablated again to a second depth, and so on to third, fourth, etc. depths. This way a 3D image of the sample can be built up. In some instances, it may be preferred to ablate all of the area for ablation to a first depth before proceeding to ablate at the second depth. Alternatively, repeated ablation at the same spot may be performed to ablate through different depths before proceeding onto the next location in the area for ablation. In both instances, deconvolution of the resulting signals at the MS to locations and depths of the sample can be

Thus, the sample may be positioned on the side of the sample carrier (e.g., glass slide) facing the laser radiation as it is directed onto the sample, although the radiation may be applied at an angle. Alternatively, the sample may be positioned on the side of the sample carrier opposite to the radiation as it is directed onto the sample (e.g. laser radiation passes through the sample carrier before reaching the sample), and plasma is released on the opposite side to the radiation.

Focusing Optics and Objective Lenses

As matter of routine arrangement, optical components can be used to direct a beam of laser radiation to a focussed spot.

As discussed above, one of the main challenges in achieving a spatial resolution of less than 200 nm, for example less than 150 nm, such as less than 100 nm, in traditional IMC and IMS is confining the spot size of the laser to less than 200 nm (e.g., less than 150 nm or less than 100 nm ) in size. The full width at half maximum of the spot size of the laser is defined by

$$D = \frac{0.451 λ}{{NA}^{0.91}} ,$$

for systems where numerical aperture (NA) exceeds 0.7, where λ is the wavelength of the laser light and NA is the numerical aperture of the objective lens 105, 205 of the focusing optics. Therefore, in traditional IMC and IMS, lasers of a shorter wavelength, or focusing optics with a high NA (above 0.9) are used to reduce the size of the laser spot size and hence improve resolution.

However, the numerical aperture of a lens is expressed as NA=n×sinθ, where n is the refractive index of the medium between the lens and the sample stage 107, 207 and e is half the acceptance angle of the objective. Therefore, maximum theoretical numerical aperture of the objective lens in typical IMC and IMS (such as the objective lens) is limited to 1.0 because the refractive index of a vacuum is 1.0 and the refractive index of air is around 1.0.

Immersion Lenses

The present invention may overcome the limitations of traditional IMC and IMS by utilising an immersion medium. The immersion medium has a refractive index which is greater than 1.0 and is placed between the objective lens and the sample stage. In this way, the apparatus of the present invention achieves numerical apertures of greater than 1.0 and so the spot size of the laser is less than 200 nm, less than 150 nm, or less than 100 nm. Thus, the present invention provides an apparatus for imaging mass cytometry with spatial resolution of 200 nm or better, 150 nm or better, or 100 nm or better.

In certain aspects, an immersion lens may be positioned above an area of interest, such as a cell or group of cells identified by light microscopy as described herein. A positioner (scanner) system may scan laser radiation across the area of interest. In certain aspects, the area of interest may be scanned multiple times to increase amount of sample detected and/or form a 3D image.

An immersion lens may be used with an ultrathin sample, as described herein.

Accordingly, the invention provides an apparatus for analysing a biological sample comprising:
a sample stage;
a laser source; and
focusing optics comprising an objective lens, the focusing optics adapted to direct radiation from the laser source towards a location on the sample stage; and wherein
the apparatus further comprises an immersion medium positioned between the objective lens and the sample stage.

Accordingly in operation, the sample stage holds the sample, typically wherein the sample is on a sample carrier and the same stage holds the sample carrier. Laser radiation is then directed through the optics of the apparatus, through the objective lens and immersion medium to the sample, where the radiation ablates material from the sample.

In order to achieve the optimal focusing conditions for the laser, the immersion medium of the present invention has a refractive index of greater than 1.00, such as 1.33 or greater, 1.50 or greater, 2.00 or greater, 2.50 or greater.

Furthermore, in order to reconstruct the image of a single layer of the thickness (or less than the thickness) of a biological cell or to read a thicker specimen layer by layer and generate a 3D image, as discussed further herein, the sample preferably has a thickness of 100 micrometers or below, such as 10 micrometers or below, or 100 nm or below, or 50 nm or below, or 30 nm or below. In some embodiments described in more detail herein, the immersion medium is referred to as an immersion lens.

Apparatus comprising an immersion medium in some embodiments comprise a medium or high NA objective lens, such as an NA of 0.7 or more, 0.8 or more, or 0.9 or more.

Liquid Immersion Medium

In some embodiments of the invention, the immersion medium is a liquid immersion medium, The focusing optics comprising an objective lens directs a beam of radiation from a laser source (source not shown) towards a location on the sample stage and a liquid immersion medium is positioned between the objective lens and the sample stage. Here, a biological sample is positioned on the opposite side of the sample stage to the liquid immersion medium. Ray diagrams can show how the liquid immersion medium provides tighter focusing conditions than the conventional set up. Suitable liquids for liquid immersion media are water which has a refractive index, n, of 1.333, glycerine (n=1.4695), an oil such as paraffin oil (n=1.480), cedarwood oil (n=1.515) and synthetic oil (n=1.515), or anisole (n=1.5178), bromonaphthalene (n=1.6585) and methylene iodide (n=1.740).

Commercial oil-immersion objectives can achieve a maximum numerical aperture of around 1.49 (close to the refractive index of the immersion oil), and are able to focus a 515 nm laser beam to a FWHM focal spot diameter of around 160 nm.

When a liquid immersion medium is used, the sample needs to be positioned on the opposite side of the sample carrier to the liquid medium. Accordingly, through-sample carrier ablation techniques must be applied here. This has the additional benefit of a smaller achievable working distance for the ablation material collection hardware, and no need to bend the transport conduit between the sample chamber and the detector. This also leads to reductions in the transient time, thus increasing the achievable ablation rate in spots per second.

Liquid immersion lenses (e.g. objective-in-water or objective-in-oil lenses) are commercially available from Olympus, ThorLabs and Leica.

TIRF Radiation

A small spot size may be achieved through use of a TIRF objective. In total internal reflection fluorescence microscopy, a thin sample (e.g., less than 200 nm, 100 nm, 50 nm, or 30 nm thick) is irradiated with light that is totally internally reflected at a glass-water interface proximal to the sample, generating an evanescent wave.

Solid Immersion Medium

In some embodiments of the invention, the invention provides an apparatus wherein the immersion medium is a solid immersion medium. In one embodiment, a solid immersion is positioned between the objective lens and the sample stage.

Similarly to liquid immersion media, the refractive index n of the solid immersion lens is greater than air. Suitable materials for solid immersion lenses are glass, such as S-LAH79™ glass type, which has a refractive index of 2.0 when operating with a wavelength of ˜520 nm. Alternative suitable materials for the solid immersion medium of the present invention are diamond or fused silica. At 266 nm diamond becomes well suited for optical applications, since it has a refractive index of >2.5 in UV it offers an opportunity to focus 266 nm light to the spot size on the scale of 100 nm or even below that. Fused silica may be more attractive from a cost perspective. It would be practical both as a specimen substrate and as a solid immersion lens material. Though, the index of refraction of fused silica in UV is only ˜1.5 and the spot size will be proportionally larger due to that.

There are two standard optical schemes for solid immersion media: the hemispherical immersion lens and the Weierstrass immersion lens.

Hemispherical solid immersion lens:

The hemispherical solid immersion lens is capable of increasing the numerical aperture of an optical system by the refractive index, n, of the material of the lens.

Weierstrass solid immersion lens:

The Weierstrass solid immersion lens is a truncated sphere and has a height from the glass slide 507 of (1+1/n)r, where r is the radius of the spherical surface of the lens. The Weierstrass lens is capable of increasing the numerical aperture of an optical system by n², hence the Weierstrass lens is capable of further increasing the numerical aperture of an optical system than the hemispherical lens.

Accordingly, the present invention provides an apparatus wherein the solid immersion medium is a hemispherical solid immersion lens or a Weierstrass solid immersion lens. The stage on which the sample is mounted can be made of material of the same refractive index as the solid immersion lens and the solid immersion lens can be made thinner by an amount equal to the thickness of the substrate to maintain the focal spot location.

Combination of Immersion Lenses and Biological Samples

The present invention comprising an immersion medium positioned between the objective lens and the sample stage provide further advantages when used to analyse a biological sample prepared according to other methods of the invention described herein (page Error! Bookmark not defined.). In particular, the present invention provides further advantages when the biological sample has a thickness of 100 micrometers or below, such as 10 micrometers or below, or 100 nm or below, or 50 nm or below, or 30 nm or below.

For example, the apparatus of the present invention comprising an immersion medium between the objective lens and the sample stage can be used to analyse a biological sample of thickness of 100 nm or below, such as 50 nm or below, or 30 nm or below. Since the apparatus of the present invention provides an apparatus for imaging mass cytometry with spatial resolution of 200 nm or better (preferably 100 nm or less), the spot size of the laser is 200 nm or less (preferably 100 nm or less) and so the ablation volume is 200 nm or less (preferably 100 nm or less) in all three directions. Therefore, analysing a biological sample of thickness 200 nm or below using the present invention will ablate all the way through the sample (or preferably 100 nm or less, when the laser spot size is 100 nm or less). Thus, the present invention provides the possibility to reconstruct the image of a single layer of the thickness of a biological cell by utilising the apparatus with sequential sections of a biological cell.

Alternatively, the apparatus of the present invention comprising an immersion medium between the objective lens and the sample stage can be used to analyse a biological sample of 100 micrometers or below, such as 10 micrometers or below. Sharp focusing of the laser beam by the immersion media as discussed above creates a very short depth of focus. Hence, the present invention provides the opportunity to read a thicker specimen layer by layer and generate a 3D image.

Accordingly, the invention provides an imaging mass cytometer or imaging mass spectrometer comprising a biological sample, wherein the biological sample has a thickness of less than 100 nm, such as less than 50 nm, or less than 30 nm. The invention also provides an imaging mass cytometer or imaging mass spectrometer comprising a biological sample, wherein the biological sample has a thickness of less than 100 nm, such as less than 50 nm, or less than 30 nm, and wherein the imaging mass cytometer or imaging mass spectrometer comprises a solid immersion lens. The invention also provides an imaging mass cytometer or imaging mass spectrometer comprising a biological sample, wherein the biological sample has a thickness of less than 100 nm, such as less than 50 nm, or less than 30 nm, and wherein the imaging mass cytometer or imaging mass spectrometer comprises a solid immersion lens.

Alternative Radiation Sources

Source of Charged Particles

In certain aspects a source of charged particles is used to pass a beam of charged particles to a location on the sample.

Ion beam:

Ions can be any suitable ion for generating sputtering from the sample to be analysed. Examples of primary ion sources are: the Duoplasmatron which generates oxygen (¹⁶O⁻, ¹⁶O₂⁺, ¹⁶O₂⁻), argon (⁴⁰Ar⁺), xenon (Xe⁺), SF₅⁺, or C₆₀⁺ primary ions; a surface ionisation source which generates ¹³³Cs⁺ primary ions; and liquid metal ion guns (LMIG) which generate Ga⁺ primary ions. Other primary ions include cluster ions such as Auₙ⁺ (n=1-5), Biₙ^{q+} (n=1-7, q=1 and 12), C₆₀^{q+} probes (q=1-3) and large Ar clusters (Muramoto, Brison, & Castner, 2012).

The choice of ion source depends on the type of ion bombardment being deployed (i.e. static or dynamic) and the sample to be analysed. Static involves using a low primary ion beam current (1 nA/cm²), usually a pulsed ion beam. Because of the low current, each ion strikes a new section of the sample surface, removing only a monolayer of particles (2 nm ). Hence, static is suitable for imaging and surface analysis (Gamble & Anderton, 2016). Dynamic involves using a high primary ion beam current (10 mA/cm²), usually a continuous primary ion beam, which results in the fast removal of surface particles. As a result, is possible to use dynamic for depth profiling. Furthermore, since more material is removed from the sample surface, dynamic SIMS gives a better detection limit than static. Dynamic typically produces high image resolution (less than 100 nm ) (Vickerman & Briggs, 2013).

In certain aspects, the ion beam may have an energy at or between 10 pj, 100 pj, 500 pj, 1 nJ, 10 nJ, 50 nj, 100 nJ, 500 nJ, 1 uJ, 5 uJ, 10 uJ, 20 uJ, 50 uJ, 100 uJ, and 500 uJ. The energy of the ion beam may allow for efficient heat transfer at the sample spot.

Oxygen primary ions enhance ionisation of electropositive elements (Malherbe, Penen, Isaure, & Frank, 2016) and are used in the commercially available Cameca IMS 1280-HR, whereas caesium primary ions are used to investigate electronegative elements (Kiss, 2012) and are used in the commercially available Cameca NanoSIMS 50.

For rapid analysis of a sample a high frequency of sputtering is needed, for example more than 200 Hz (i.e. more than 200 packets of ions directed at the sample per second). Commonly, the frequency of primary ion pulse generation by the primary ion source is at least 400 Hz, such as at least 500 Hz, or at least 1 kHz. For instance, the frequency of ion pulses in some embodiments is at least 10 kHz, at least 100 kHz, at least 1 MHz, or at least 10 MHz. For instance, the frequency of ion pulses is within the range 400-100 MHz, within the range 1 kHz-100 MHz, within the range 10 kHz-100 MHz, within the range 100 kHz-100 MHz or within the range 1 MHz-100 MHz.

Accordingly, the present invention provides an apparatus wherein the source of charged particles is an ion beam.

Electron Beam

Electron beam radiation involves bombarding a gas-phase sample with a beam of electrons. An electron ionisation chamber includes a source of electrons and an electron trap. A typical source of the beam of electrons is a rhenium or tungsten wire, usually operated at 70 electron volts energy. The beam of electrons is directed towards the electron trap, and a magnetic field applied parallel to the direction of the electrons travel causes the electrons to travel in a helical path. The gas-phase sample is directed through the electron ionisation chamber and interacts with the beam of electrons to form ions.

In certain aspects, the ion beam is an electron beam. Electron beams with the energy of 1 kV to 100 kV may be particularly suitable to interrogate a specimen with a thickness at or less than 100 nm, 50 nm, or 30 nm.

A high intensity pulsed electron beam is used to cause ablation/sputtering. When the pulse of the electron current is insufficient for ablation, its effect can be used just as an ignition event as described above, followed by energy pumping by the laser pulse set at the brightness level below the level of ablation of native material but above the level of energy pumping required for ablation of an already activated material.

For rapid analysis of a sample a high frequency of sputtering is needed, for example more than 200 Hz (i.e. more than 200 packets of electrons directed at the sample per second). Commonly, the frequency of electron pulse generation by the electron source is at least 400 Hz, such as at least 500 Hz, or at least 1 kHz. For instance, the frequency of electron pulses in some embodiments is at least 10 kHz, at least 100 kHz, at least 1 MHz, or at least 10 MHz. For instance, the frequency of electron pulses is within the range 400-100 MHz, within the range 1 kHz-100 MHz, within the range 10 kHz-100 MHz, within the range 100 kHz-100 MHz or within the range 1 MHz-100 MHz.

An advantage of utilising an electron beam for the source of charged particles is that the whole instrument can be built on a platform containing an electron microscope. Accordingly, the present invention provides an apparatus further comprising an electron microscope. Accordingly, the present invention provides an apparatus wherein the source of charged particles is an electron beam wherein the electron beam is an electron source in the electron microscope.

Electron Microscope

In some embodiments of the invention, the apparatus also comprises components to perform electron microscopy.

At a general level, an electron microscope comprises an electron gun (e.g. with a tungsten filament cathode), and electrostatic/electromagnetic lenses and apertures that control the beam to direct it onto a sample in a sample chamber. The sample is held under vacuum, so that gas molecules cannot impede or diffract electrons on their way from the electron gun to the sample. In transmission electron microscopy (TEM), the electrons pass through the sample, whereupon they are deflected. The deflected electrons are then detected by a detector such as a fluorescent screen, or in some instances a high-resolution phosphor coupled to a CCD. Between the sample and the detector is an objective lens which controls the magnification of the deflected electrons on the detector.

TEM requires ultrathin sections to enable sufficient electrons to pass through the sample such that an image may be reconstructed from the deflected electrons that hit the detector. Typically, TEM samples are 100 nm or thinner, as prepared by use of an ultramicrotome. Biological tissue specimens are chemically fixed, dehydrated and embedded in a polymer resin to stabilize them sufficiently to allow the ultrathin sectioning. Sections of biological specimens, organic polymers and similar materials may require staining with heavy atom labels in order to achieve the required image contrast, as unstained biological samples rarely interact strongly with electrons in their nates state, so as to deflect them to allow electron microscopy images to be recorded.

As noted above, when thin sections are used, it is possible to perform electron microscopy on a sample also analysed by IMS or IMC. Accordingly, high resolution structural images can be obtained by electron microscopy, for example transmission electron microscopy, and then this high resolution image used to refine the resolution of image data obtained by IMS or IMC to a resolution beyond that achievable with ablation using laser radiation (due to the much shorter wavelength of electrons compared to photons). In some instances, both electron microscopy and elemental analysis by IMC or IMS are performed on the sample in a single apparatus (as IMC/IMS are destructive processes, electron microscopy is performed prior to IMC/IMS)

Thus, the invention provides an imaging mass cytometer or imaging mass spectrometer as described herein further comprising an electron microscope, such as comprising components as set out above, e.g. an electron source, such as an electron gun. As will be understood by one of skill in the art, the particular arrangement of the components will vary (e.g. direction from which electrons are directed onto the sample and the direction from which laser radiation is directed onto the sample), and routine arrangement of components can be achieved without undue burden. In some instances, the sample is not moved within the apparatus between analysis by electron microscopy and subsequent ablation. Accordingly, after completion of the electron microscopy stage of analysis, the sample chamber will be allowed to return to closer to atmospheric pressure before elemental analysis is performed.

Charmed Particle Column

The charged particle column comprises optics to direct ions to the sample. The charged particle column comprises a mass filter in order to filter out impurities in the charged particle beam; lenses and apertures as appropriate in order to control the intensity and shape of the primary ion beam; and deflection plates in order to shape the primary ion beam and optionally raster the charged particle beam across the surface of the sample (Villacob, 2016). Ion lenses and other components for constructing the charged particle column are commercially available, e.g. from Agilent. Accordingly, the charged particle column of the present invention can provide a charged particle beam scanning system adapted to scan the beam of charged particles across a plurality of locations on the sample stage

Typically, the charged particle beam used for secondary ion generation herein has a spot size (i.e. size of the charged particle beam when it hits the sample) about 1 μm or less, about 0.5 μm or less than 0.5 μm, such as about 400 nm or less, about 300 nm or less. In particular embodiments, the spot size is about 200 nm or less, about 100 nm or less than 100 nm. In order to analyse cells at a subcellular resolution the system uses a primary ion beam spot size which is no larger than these cells, and more specifically uses a primary ion beam spot size which can ablate material with a subcellular resolution. The particular spot size used can therefore be selected appropriately dependent upon the size of the cells being analysed. In biological samples, the cells will rarely all be of the same size, and so if subcellular resolution imaging is desired, the ion beam spot size should be smaller than the smallest cell, if constant spot size is maintained throughout the sputtering procedure.

Camera

In addition to identifying the most effective positioning of the sample for laser ablation, the inclusion of a camera (such as a charged coupled device image sensor based (CCD) camera or an active pixel sensor based camera), or any other light detecting means in a laser ablation sampling system enables various further analyses and techniques. A CCD is a means for detecting light and converting it into digital information that can be used to generate an image. In a CCD image sensor, there are a series of capacitors that detect light, and each capacitor represents a pixel on the determined image. These capacitors allow the conversion of incoming photons into electrical charges. The CCD is then used to read out these charges, and the recorded charges can be converted into an image. An active-pixel sensor (APS) is an image sensor consisting of an integrated circuit containing an array of pixel sensors, each pixel containing a photodetector and an active amplifier, e.g. a CMOS sensor.

A camera can be incorporated into any laser ablation sampling system discussed herein. The camera can be used to scan the sample to identify cells of particular interest or regions of particular interest (for example cells of a particular morphology), or for fluorescent probes specific for an antigen, or an intracellular or structure. In certain embodiments, the fluorescent probes are histochemical stains or antibodies that also comprise a detectable metal tag. Once such cells have been identified, then laser pulses can be directed at these particular cells to ablate material for analysis, for example in an automated (where the system both identifies and ablates the feature(s)/regions(s), such as cell(s), of interest) or semi-automated process (where the user of the system, for example a clinical pathologist, identifies the features/region(s) of interest, which the system then ablates in an automated fashion). This enables a significant increase in the speed at which analyses can be conducted, because instead of needing to ablate the entire sample to analyse particular cells, the cells of interest can be specifically ablated. This leads to efficiencies in methods of analysing biological samples in terms of the time taken to perform the ablation, but in particular in the time taken to interpret the data from the ablation, in terms of constructing images from it. Constructing images from the data is one of the more time-consuming parts of the imaging procedure, and therefore by minimising the data collected to the data from relevant parts of the sample, the overall speed of analysis is increased.

The camera may record the image from a confocal microscope. Confocal microscopy is a form of optical microscopy that offers a number of advantages, including the ability to reduce interference from background information (light) away from the focal plane. This happens by elimination of out-of-focus light or glare. Confocal microscopy can be used to assess unstained samples for the morphology of the cells, or whether a cell is a discrete cell or part of a clump of cells. Often, the sample is specifically labelled with fluorescent markers (such as by labelled antibodies or by labelled nucleic acids). These fluorescent makers can be used to stain specific cell populations (e.g. expressing certain genes and/or proteins) or specific morphological features on cells (such as the nucleus, or mitochondria) and when illuminated with an appropriate wavelength of light, these regions of the sample are specifically identifiable. Some systems described herein therefore can comprise a laser for exciting fluorophores in the labels used to label the sample. Alternatively, an LED light source can be used for exciting the fluorophores. Non-confocal (e.g. wide field) fluorescent microscopy can also be used to identify certain regions of the biological sample, but with lower resolution than confocal microscopy.

An alternative imaging technique is two-photon excitation microscopy (also referred to as non-linear or multiphoton microscopy). The technique commonly employs near-IR light to excite fluorophores. Two photons of IR light are absorbed for each excitation event. Scattering in the tissue is minimized by IR. Further, due to the multiphoton absorption, the background signal is strongly suppressed. The most commonly used fluorophores have excitation spectra in the 400-500 nm range, whereas the laser used to excite the two-photon fluorescence lies in near-IR range. If the fluorophore absorbs two infrared photons simultaneously, it will absorb enough energy to be raised into the excited state. The fluorophore will then emit a single photon with a wavelength that depends on the type of fluorophore used that can then be detected.

When a laser is used to excite fluorophores for fluorescence microscopy, sometimes this laser is the same laser that generates the laser light used to ablate material from the biological sample, but used at a power that is not sufficient to cause ablation of material from the sample. Sometimes the fluorophores are excited by the wavelength of light that the laser then ablates the sample with. In others, a different wavelength may be used, for example by generating different harmonics of the laser to obtain light of different wavelengths, or exploiting different harmonics generated in a harmonic generation system, discussed above, apart from the harmonics which are used to ablate the sample. For example, if the fourth and/or fifth harmonic of a Nd:YAG laser are used, the fundamental harmonic, or the second to third harmonics, could be used for fluorescence microscopy.

As an example technique combining fluorescence and laser ablation, it is possible to label the nuclei of cells in the biological sample with an antibody or nucleic acid conjugated to a fluorescent moiety. Accordingly, by exciting the fluorescent label and then observing and recording the positions of the fluorescence using a camera, it is possible to direct the ablating laser specifically to the nuclei, or to areas not including nuclear material. The division of the sample into nuclei and cytoplasmic regions will find particular application in field of cytochemistry. By using an image sensor (such as a CCD detector or an active pixel sensor, e.g. a CMOS sensor), it is possible to entirely automate the process of identifying features/regions of interest and then ablating them, by using a control module (such as a computer or a programmed chip) which correlates the location of the fluorescence with the x,y coordinates of the sample and then directs the ablation laser to that location. As part of this process the first image taken by the image sensor may have a low objective lens magnification (low numerical aperture), which permits a large area of the sample to be surveyed. Following this, a switch to an objective with a higher magnification can be used to home in on the particular features of interest that have been determined to fluoresce by higher magnification optical imaging. These features recorded to fluoresce may then be ablated by a laser. Using a lower numerical aperture lens first has the further advantage that the depth of field is increased, thus meaning features buried within the sample may be detected with greater sensitivity than screening with a higher numerical aperture lens from the outset.

In methods and systems in which fluorescent imaging is used, the emission path of fluorescent light from the sample to the camera may include one or more lenses and/or one or more optical filters. By including an optical filter adapted to pass a selected spectral bandwidth from one or more of the fluorescent labels, the system is adapted to handle chromatic aberrations associated with emissions from the fluorescent labels. Chromatic aberrations are the result of the failure of lenses to focus light of different wavelengths to the same focal point. Accordingly, by including an optical filter, the background in the optical system is reduced, and the resulting optical image is of higher resolution. A further way to minimise the amount of emitted light of undesired wavelengths that reaches the camera is to exploit chromatic aberration of lenses deliberately by using a series of lenses designed for the transmission and focus of light at the wavelength transmitted by the optical filter, akin to the system explained in WO 2005/121864.

A higher resolution optical image is advantageous in this coupling of optical techniques and laser ablation sampling, because the accuracy of the optical image then determines the precision with which the ablating laser can be directed to ablate the sample.

Accordingly, in some embodiments disclosed herein, the apparatus of the invention comprises a camera. Accordingly, applying this strategy in imaging a biological sample comprising a plurality of cells, the following steps can be performed: (i) labelling a plurality of different target molecules in the sample with one or more different labelling atoms and one or more fluorescent labels, to provide a labelled sample; (ii) illuminating a known location of the sample with light to excite the one or more fluorescent labels; (iii) observing and recording whether there is fluorescence at the location; (iv) if there is fluorescence, directing radiation at that location, and (vi) repeating steps (ii)-(v) for one or more further known locations on the sample. In some instances, the sample, or the sample carrier, may be modified so as to contain optically detectable (e.g., by optical or fluorescent microscopy) moieties at specific locations.

Mass Detector System

Exemplary types of mass detector system include quadrupole, time of flight (TOF), magnetic sector, high resolution, single or multicollector based mass spectrometers.

The time taken to analyse the ionised material will depend on the type of mass analyser which is used for detection of ions. For example, instruments which use Faraday cups are generally too slow for analysing rapid signals. Overall, the desired imaging speed, resolution and degree of multiplexing will dictate the type(s) of mass analyser which should be used (or, conversely, the choice of mass analyser will determine the speed, resolution and multiplexing which can be achieved).

Mass spectrometry instruments that detect ions at only one mass-to-charge ratio (m/Q, commonly referred to as m/z in MS) at a time, for example using a point ion detector, will give poor results in imaging detecting. Firstly, the time taken to switch between mass-to-charge ratios limits the speed at which multiple signals can be determined, and secondly, if ions are at low abundance then signals can be missed when the instrument is focused on other mass-to-charge ratios. Thus it is preferred to use a technique which offers substantially simultaneous detection of ions having different m/Q values.

Detector Types

Quadrupole Detector

Quadrupole mass analysers comprise four parallel rods with a detector at one end. An alternating RF potential and fixed DC offset potential is applied between one pair of rods and the other so that one pair of rods (each of the rods opposite each other) has an opposite alternative potential to the other pair of rods. The ionised sample is passed through the middle of the rods, in a direction parallel to the rods and towards the detector. The applied potentials affect the trajectory of the ions such that only ions of a certain mass-charge ratio will have a stable trajectory and so reach the detector. Ions of other mass-charge ratios will collide with the rods.

Magnetic Sector Detector

In magnetic sector mass spectrometry, the ionised sample is passed through a curved flight tube towards an ion detector. A magnetic field applied across the flight tube causes the ions to deflect from their path. The amount of deflection of each ion is based on the mass to charge ratio of each ion and so only some of the ions will collide with the detector—the other ions will be deflected away from the detector. In multicollector sector field instruments, an array of detectors is be used to detect ions of different masses. In some instruments, such as the ThermoScientific Neptune Plus, and Nu Plasma II, the magnetic sector is combined with an electrostatic sector to provide a double-focussing magnetic sector instrument that analyses ions by kinetic energy, in addition to mass to charge ratio. In particular those multidetectors having a Mattauch-Herzog geometry can be used (e.g. the SPECTRO MS, which can simultaneously record all elements from lithium to uranium in a single measurement using a semiconductor direct charge detector). These instruments can measure multiple m/Q signals substantially simultaneously. Their sensitivity can be increased by including electron multipliers in the detectors. Array sector instruments are always applicable, however, because, although they are useful for detecting increasing signals, they are less useful when signal levels are decreasing, and so they are not well suited in situations where labels are present at particularly highly variable concentrations.

Time of Flight (TOF) Detector

A time of flight mass spectrometer comprises a sample inlet, an acceleration chamber with a strong electric field applied across it, and an ion detector. A packet of ionised sample molecules is introduced through the sample inlet and into the acceleration chamber. Initially, each of the ionised sample molecules has the same kinetic energy but as the ionised sample molecules are accelerated through the acceleration chamber, they are separated by their masses, with the lighter ionised sample molecules travelling faster than heaver ions. The detector then detects all the ions as they arrive. The time taking for each particle to reach the detector depends on the mass to charge ratio of the particle.

Thus a TOF detector can quasi-simultaneously register multiple masses in a single sample. TOF techniques are not ideally suited to ICP ion sources because of their space charge characteristics, which is obviated by creating the plasma at the sample spot. Whereas TOF mass analyzers are normally unpopular for atomic analysis because of the compromises required to deal with the effects of space charge in the TOF accelerator and flight tube, tissue imaging according to the subject disclosure can be effective by detecting only the labelling atoms, and so other atoms (e.g. those having an atomic mass below 100) can be removed. This results in a less dense ion beam, enriched in the masses in (for example) the 100-250 dalton region, which can be manipulated and focused more efficiently, thereby facilitating TOF detection and taking advantage of the high spectral scan rate of TOF. Thus rapid imaging can be achieved by combining TOF detection with choosing labelling atoms that are uncommon in the sample and ideally having masses above the masses seen in an unlabelled sample e.g. by using the higher mass transition elements. Using a narrower window of label masses thus means that TOF detection to be used for efficient imaging.

By directly coupling a mass spectrometry detector system with a high-resolution sampling system it is possible to permit construction of an image of the tissue sample with high multiplexing on a practical timescale.

Ion Transport Optics

The sample ion beams may be captured from the sample via electrostatic plates positioned near to the sample, known in the art as the extraction electrode(s). The extraction electrode(s) remove(s) the elemental ions released from the locality of the sample. As used herein, ion transport optics refer to any optics handing ions produced by radiation, and may include extraction optics (e.g., optics that accelerate ions past neutralizing conditions), ion pretreatment optics (e.g., removing molecular ions and/or lighter atomic ions endogenous to the sample) and/or ion focusing optics. In certain aspects, ion transport optics only include extraction optics.

Accordingly, this difference in velocity can cause lower resolution at the detector, because not all ions are moving at the same velocity. Accordingly, by delaying the application of the voltage across the sample and extraction electrodes, those ions with lower kinetic energy with have remained closer to the sample electrode when the accelerating voltage is applied and therefore start being accelerated at a greater potential compared to the ions farther from the target electrode. With the proper delay time, the slower ions are accelerated sufficiently to catch the ions that had higher kinetic energy after laser desorption/ionization after flying some distance from the pulsed acceleration system. Ions of the same mass-to-charge ratio will then drift through the flight tube to the detector in the same time. Accordingly, in some embodiments the sample and extraction electrodes are controllable to apply a charge across the electrodes at a set time following the radiation causing ionization at the sample spot.

The sample ions may then then transferred to the detector via one or more further electrostatic lenses (known as transfer lenses in the art). The transfer lens(es) focus(es) the beam of sample ions into the detector. Commonly, further ion manipulation components are present between the electrodes and the detector, for example one or more apertures, mass filters (e.g., high pass filters with a cuttoff of less than 80 amu, less than 60 amu, or less than 40 amu) and/or sets of deflector plates. Together, the electrodes, transfer lens, and any further components, form the ion transport optics.

In addition to the detectors discussed below, as LDI can be performed so that it results in soft ionisation (e.g. ionisation without breaking of bonds in the molecules being analysed), in some instances, the detector may be a tandem MS, in which a first m/z separation is performed to select ions from the sample, before the selected ions are broken down into their fragments and undergo a second m/z separation whereupon the fragments are detected.

Methods Employing LDI

In certain aspects, direct ionization may be performed by laser desorption ionization.

The invention also provides methods for analysing biological samples using LDI. In this analysis, the cells are labelled with labels, and these labels are then detected in the ions produced following LDI of the samples. Accordingly, the invention provides a method for performing mass cytometry on a sample comprising a plurality of cells, comprising: a. labelling a plurality of different target molecules in the sample with one or more different labels, to provide a labelled sample; b. performing laser desorption/ionisation of the sample, wherein laser desorption/ionisation is performed at multiple locations to form a plurality of individual ion clouds; and c. subjecting the ion clouds individually to mass spectrometry, whereby detection of labels in the plumes permits construction of an image of the sample, optionally wherein the multiple locations are multiple known locations.

In some embodiments, the one or more labels comprise labelling atoms. In this instance, labelling works as described below herein, whereby a member of a specific binding pair (e.g. antibody binding to a protein antigen, or a nucleic acid binding to a RNA in the sample) is attached to an elemental tag comprising one or more labelling atoms (e.g. lanthanides and actinides). The elemental tag can comprise just a single type of labelling atom (e.g. one or more atoms of a single isotope of a particular element), or can comprise different multiple kinds of labelling atom (e.g. different elements/isotopes) thereby enabling large numbers of different tags to be generated as the specific combination elements/isotopes acts as the label. In some instances, the labelling atom is detected as an elemental ion. In some embodiments, the labelling atom is emitted from the sample within a molecular ion. Thus, instead of the detection in the mass channel for the labelling atom, the presence of the labelled material in the sample will be detected in the mass channel for the molecular ion (i.e. the mass channel will simply be shifted by the mass of the molecule minus the labelling atom, vis-à-vis the labelling atom alone). In some embodiments, however, the molecule that contains the labelling atom may vary between different labelling atoms. In that case the ion containing molecular residue and labelling atom will be subjected to a fragmentation method that yields a more consistent mass peak for each reagent, such as through the application of tandem MS. The goal of all these variations and modifications to the main LDI imaging mass cytometry scheme is to maximize the number of available mass channels while simultaneously reducing the overlap between mass channels.

In some embodiments, the staining reagents can be designed to promote the release and ionization of mass tagging material and individual elemental ions or molecular ions containing a single copy of the labelling atom. The staining reagent can also be designed to promote the release and ionization of mass tagging material and individual elemental ions or molecular ions containing a several copies of the labelling atom (or combinations thereof, as discussed above). As a further alternative, the mass of the staining reagent itself can be utilized to create a detection channel for mass cytometry. In this instance, no rare-earth isotopes will be used in the staining and the mass of the staining reagent will be varied by changing the chemistry of the staining reagents to create a number of mass channels. This variation can be done with carbon, oxygen, nitrogen, sulphur, phosphorus, hydrogen and similar isotopes without the need for the rare-earth isotopes.

In some embodiments, the sample is also treated with a laser radiation absorber composition. This composition acts to enhance absorption of laser light by the sample when irradiated, and so increases transfer of energy to excite the labelling atoms (and so promote production of elemental ions or molecular ions containing a labelling atom or combination thereof).

Constructing an Image

The apparatus above can provide signals for multiple atoms in packets of ionised sample material removed from the sample. Detection of an atom in a packet of sample material reveals its presence at the position of ablation, be that because the atom is naturally present in the sample or because the atom has been localised to that location by a labelling reagent. By generating a series of packets of ionised sample material from known spatial locations on the sample's surface the detector signals reveal the location of the atoms on the sample, and so the signals can be used to construct an image of the sample. By labelling multiple targets with distinguishable labels it is possible to associate the location of labelling atoms with the location of cognate targets, so the method can build complex images, reaching levels of multiplexing which far exceed those achievable using traditional techniques such as fluorescence microscopy.

In certain aspects, the image may be a 2D image. Alternatively, the image may be a 3D image, for example, when multiple pulses of radiation are focused on the same spot (X-Y coordinate). The radiation optics and/or a X-Y-Z translatable stage may be adjusted to radiate spots at different Z-planes in the same X-Y coordinate. The pulses of radiation may be applied in succession to the same spot, or scanned across the spot multiple times.

Assembly of signals into an image will use a computer and can be achieved using known techniques and software packages. For instance, the GRAPHIS package from Kylebank Software may be used, or other packages such as TERAPLOT can also be used. Imaging using MS data from techniques such as MALDI-MSI is known in the art e.g. reference i discloses the ‘MSiReader’ interface to view and analyze MS imaging files on a Matlab platform, and reference ii discloses two software instruments for rapid data exploration and visualization of both 2D and 3D MSI data sets in full spatial and spectral resolution e.g. the ‘Datacube Explorer’ program.

Images obtained using the methods disclosed herein can be further analysed e.g. in the same way that IHC results are analysed. For instance, the images can be used for delineating cell sub-populations within a sample, and can provide information useful for clinical diagnosis. Similarly, SPADE analysis can be used to extract a cellular hierarchy from the high-dimensional cytometry data which methods of the disclosure provide [iii]. In certain aspects, cell types (e.g., identified through SPADE analysis) may be colorized to allow for a plurality of cell types (at least some of which are characterized by a combination of markers) to be visualized simultaneously.

Samples

Certain aspects of the disclosure provides a method of imaging a geological or biological sample. Such biological samples can comprise a plurality of cells which can be subjected to imaging mass cytometry (IMC) in order to provide an image of these cells in the sample. In general, the invention can be used to analyse tissue samples which are now studied by immunohistochemistry (IHC) techniques, but with the use of labelling atoms which are suitable for detection by mass spectrometry (MS).

Any suitable tissue sample can be used in the methods described herein. For example, the tissue can include tissue from one or more of epithelium, muscle, nerve, skin, intestine, pancreas, kidney, brain, liver, blood (e.g. a blood smear), bone marrow, buccal swipes, cervical swipes, or any other tissue. The biological sample may be an immortalized cell line or primary cells obtained from a living subject. For diagnostic, prognostic or experimental (e.g., drug development) purposes the tissue can be from a tumor. In some embodiments, a sample may be from a known tissue, but it might be unknown whether the sample contains tumor cells. Imaging can reveal the presence of targets which indicate the presence of a tumor, thus facilitating diagnosis. Tissue from a tumor may comprise immune cells that are also characterized by the subject methods, and may provide insight into the tumor biology. The tissue sample may comprise formalin-fixed, paraffin-embedded (FFPE) tissue. The tissues can be obtained from any living multicellular organism, such as a mammal, an animal research model (e.g., of a particular disease, such as an immunodeficient rodent with a human tumor xenograft), or a human patient.

The tissue sample may be a section e.g. having a thickness within the range of 2-10 μm, such as between 4-6 μm. Techniques for preparing such sections are well known from the field of IHC e.g. using microtomes, including dehydration steps, fixation, embedding, permeabilization, sectioning etc. Thus, a tissue may be chemically fixed and then sections can be prepared in the desired plane. Cryosectioning or laser capture microdissection can also be used for preparing tissue samples. Samples may be permeabilised e.g. to permit uptake of reagents for labelling of intracellular targets (see above).

The size of a tissue sample to be analysed will be similar to current IHC methods, although the maximum size will be dictated by the laser ablation apparatus, and in particular by the size of sample which can fit into its sample chamber. A size of up to 5 mm×5 mm is typical, but smaller samples (e.g. 1 mm×1 mm) are also useful (these dimensions refer to the size of the section, not its thickness).

In addition to being useful for imaging tissue samples, the disclosure can instead be used for imaging of cellular samples such as monolayers of adherent cells or of cells which are immobilised on a solid surface (as in conventional immunocytochemistry). These embodiments are particularly useful for the analysis of adherent cells that cannot be easily solubilized for cell-suspension mass cytometry. Thus, as well as being useful for enhancing current immunohistochemical analysis, the disclosure can be used to enhance immunocytochemistry.

Solid Support

In certain embodiments, the sample may be immobilized on a solid support (e.g., such as a sample carrier, slide, electron microscopy mesh, and/or translatable sample stage), to position it for imaging mass spectrometry. The solid support may be optically transparent, for example made of glass or plastic. Where the sample carrier is optically transparent, it enables ablation of the sample material through the support. Sometimes, the sample carrier will comprise features that act as reference points for use with the apparatus and methods described herein, for instance to allow the calculation of the relative position of features/regions of interest that are to be ablated or desorbed and analysed. The reference points may be optically resolvable, or may be resolvable by mass analysis.

Ultrathin Samples

As discussed above, traditional IMC and IMS techniques use tissue samples that are several micrometres thick. However, some of the embodiments of the invention described herein, for example the apparatus for analysing a biological sample comprising an immersion medium positioned between the objective lens and the sample stage (see page 38 above), are not suitable for use with samples of such a thickness because the ablation region is typically of the order of 100 nm in all three dimensions.

Therefore, the present invention provides a method of preparing a biological sample for analysis comprising labelling the sample with labelling atoms (labelling atoms are described further herein) and sectioning the sample into thin sections, optionally wherein the sample is sectioned into sections of thickness of less than 10 micrometers or below, such as 1 micrometer or below, or 100 nm or below, or 50 nm or below, or 30 nm or below. The invention also provides a method of preparing a biological sample for analysis comprising sectioning the sample into thin sections and labelling the sample with labelling atoms (labelling atoms are described further herein), optionally wherein the sample is sectioned into sections of thickness of less than 10 micrometers or below, such as 1 micrometer or below, or 100 nm or below, or 50 nm or below, or 30 nm or below. An automated microtome, such as the ATUMtome available from RM Boeckeler, can be used to section the sample into sections of a thickness in accordance with the method of the present invention.

Samples prepared according to the method set out above can be used with any of the IMC and IMS techniques described herein. However, samples prepared according to the method set out above are particularly suited to analysis by any of the apparatus comprising an immersion medium positioned between the objective lens and the sample stage described herein.

Furthermore, samples prepared according to the method set out above are also suited to analysis by any one of the sputtering based sampling and ionising systems set out above.

Target Elements

In imaging mass spectrometry, the distribution of one or more target elements (i.e., elements or elemental isotopes) may be of interest. In certain aspects, target elements are labelling atoms (e.g., metal tags) as described herein. A labelling atom may be directly added to the sample alone or covalently bound to or within a biologically active molecule. In certain embodiments, labelling atoms may be conjugated to a member of a specific binding pair (SBP), such as an antibody (that binds to its cognate antigen), aptamer or oligonucleotide for hybridizing to a DNA or RNA target, as described in more detail below. Labelling atoms may be attached to an SBP by any method known in the art. In certain aspects, the labelling atoms are a metal element, such as a lanthanide or transition element or another metal tag as described herein. The metal element may have a mass greater than 60 amu, greater than 80 amu, greater than 100 amu, or greater than 120 amu. Mass spectrometers described herein may deplete elemental ions below the masses of the metal elements, so that abundant lighter elements do not create space-charge effects and/or overwhelm the mass detector.

Labelling of the Tissue Sample

The disclosure produces images of samples which have been labelled with labelling atoms, for example a plurality of different labelling atoms, wherein the labelling atoms are detected by an apparatus capable of sampling specific, preferably subcellular, areas of a sample (the labelling atoms therefore represent an elemental tag). The reference to a plurality of different atoms means that more than one atomic species is used to label the sample. These atomic species can be distinguished using a mass detector (e.g. they have different m/Q ratios), such that the presence of two different labelling atoms within a sample spot gives rise to two different MS signals. The atomic species can also be distinguished using an optical spectrometer (e.g. different atoms have different emission spectra), such that the presence of two different labelling atoms within a sample spot gives rise to two different emission spectral signals.

Mass Tagged Reagents

Mass-tagged reagents as used herein comprise a number of components. The first is the SBP. The second is the mass tag. The mass tag and the SBP are joined by a linker, formed at least in part of by the conjugation of the mass tag and the SBP. The linkage between the SBP and the mass tag may also comprise a spacer. The mass tag and the SBP can be conjugated together by a range of reaction chemistries. Exemplary conjugation reaction chemistries include thiol maleimide, NHS ester and amine, or click chemistry reactivities (preferably Cu(I)-free chemistries), such as strained alkyne and azide, strained alkyne and nitrone and strained alkene and tetrazine.

Mass Tags

The mass tag used in the present invention can take a number of forms. Typically, the tag comprises at least one labelling atom. A labelling atom is discussed herein below.

Accordingly, in its simplest form, the mass tag may comprise a metal-chelating moiety which is a metal-chelating group with a metal labelling atom co-ordinated in the ligand. In some instances, detecting only a single metal atom per mass tag may be sufficient. However, in other instances, it may be desirable of each mass tag to contain more than one labelling atom. This can be achieved in a number of ways, as discussed below.

A first means to generate a mass tag that can contain more than one labelling atom is the use of a polymer comprising metal-chelating ligands attached to more than one subunit of the polymer. The number of metal-chelating groups capable of binding at least one metal atom in the polymer can be between approximately 1 and 10,000, such as 5-100, 10-250, 250-5,000, 500-2,500, or 500-1,000. At least one metal atom can be bound to at least one of the metal-chelating groups. The polymer can have a degree of polymerization of between approximately 1 and 10,000, such as 5-100, 10-250, 250-5,000, 500-2,500, or 500-1,000. Accordingly, a polymer based mass tag can comprise between approximately 1 and 10,000, such as 5-100, 10-250, 250-5,000, 500-2,500, or 500-1,000 labelling atoms.

The polymer can be selected from the group consisting of linear polymers, copolymers, branched polymers, graft copolymers, block polymers, star polymers, and hyperbranched polymers. The backbone of the polymer can be derived from substituted polyacrylamide, polymethacrylate, or polymethacrylamide and can be a substituted derivative of a homopolymer or copolymer of acrylamides, methacrylamides, acrylate esters, methacrylate esters, acrylic acid or methacrylic acid. The polymer can be synthesised from the group consisting of reversible addition fragmentation polymerization (RAFT), atom transfer radical polymerization (ATRP) and anionic polymerization. The step of providing the polymer can comprise synthesis of the polymer from compounds selected from the group consisting of N-alkyl acrylamides, N,N-dialkyl acrylamides, N-aryl acrylamides, N-alkyl methacrylamides, N,N-dialkyl methacrylamides, Naryl methacrylamides, methacrylate esters, acrylate esters and functional equivalents thereof.

The polymer can be water soluble. This moiety is not limited by chemical content. However, it simplifies analysis if the skeleton has a relatively reproducible size (for example, length, number of tag atoms, reproducible dendrimer character, etc.). The requirements for stability, solubility, and non-toxicity are also taken into consideration. Thus, the preparation and characterization of a functional water soluble polymer by a synthetic strategy that places many functional groups along the backbone plus a different reactive group (the linking group), that can be used to attach the polymer to a molecule (for example, an SBP), through a linker and optionally a spacer. The size of the polymer is controllable by controlling the polymerisation reaction. Typically the size of the polymer will be chosen so as the radiation of gyration of the polymer is as small as possible, such as between 2 and 11 nanometres. The length of an IgG antibody, an exemplary SBP, is approximately 10 nanometres, and therefore an excessively large polymer tag in relation to the size of the SBP may sterically interfere with SBP binding to its target.

The metal-chelating group that is capable of binding at least one metal atom can comprise at least four acetic acid groups. For instance, the metal-chelating group can be a diethylenetriaminepentaacetate (DTPA) group or a 1,4,7,10-tetraazacyclododecane-1,4,7,10-tetraacetic acid (DOTA) group. Alternative groups include Ethylenediaminetetraacetic acid (EDTA) and ethylene glycol-bis(R-aminoethyl ether)-N,N,N′,N′-tetraacetic acid (EGTA)

The metal-chelating group can be attached to the polymer through an ester or through an amide. Examples of suitable metal-chelating polymers include the X8 and DM3 polymers available from Fluidigm Canada, Inc.

The polymer can be water soluble. Because of their hydrolytic stability, N-alkyl acrylamides, N-alkyl methacrylamides, and methacrylate esters or functional equivalents can be used. A degree of polymerization (DP) of approximately 1 to 1000 (1 to 2000 backbone atoms) encompasses most of the polymers of interest. Larger polymers are in the scope of the invention with the same functionality and are possible as would be understood by practitioners skilled in the art. Typically the degree of polymerization will be between 1 and 10,000, such as 5-100, 10-250, 250-5,000, 500-2,500, or 500-1,000. The polymers may be amenable to synthesis by a route that leads to a relatively narrow polydispersity. The polymer may be synthesized by atom transfer radical polymerization (ATRP) or reversible addition-fragmentation (RAFT) polymerization, which should lead to values of Mw (weight average molecular weight)/Mn (number average molecular weight) in the range of 1.1 to 1.2. An alternative strategy involving anionic polymerization, where polymers with Mw/Mn of approximately 1.02 to 1.05 are obtainable. Both methods permit control over end groups, through a choice of initiating or terminating agents. This allows synthesizing polymers to which the linker can be attached. A strategy of preparing polymers containing functional pendant groups in the repeat unit to which the liganded transition metal unit (for example a Ln unit) can be attached in a later step can be adopted. This embodiment has several advantages. It avoids complications that might arise from carrying out polymerizations of ligand containing monomers.

To minimize charge repulsion between pendant groups, the target ligands for (M³⁺) should confer a net charge of −1 on the chelate.

Polymers that be used in the invention include:
random copolymer poly(DMA-co-NAS): The synthesis of a 75/25 mole ratio random copolymer of N-acryloxysuccinimide (NAS) with N,N-dimethyl acrylamide (DMA) by RAFT with high conversion, excellent molar mass control in the range of 5000 to 130,000, and with Mw/Mn≈1.1 is reported in Relógio et al. (2004) (Polymer, 45, 8639-49). The active NHS ester is reacted with a metal-chelating group bearing a reactive amino group to yield the metal-chelating copolymer synthesised by RAFT polymerization.
poly(NMAS): NMAS can be polymerised by ATRP, obtaining polymers with a mean molar mass ranging from 12 to 40 KDa with Mw/Mn of approximately 1.1 (see e.g. Godwin et al., 2001; Angew. Chem.Int.Ed, 40: 594-97).
poly(MAA): polymethacrylic acid (PMAA) can be prepared by anionic polymerization of its t-butyl or trimethylsilyl (TMS) ester.
poly(DMAEMA): poly(dimethylaminoethyl methacrylate) (PDMAEMA) can be prepared by ATRP (see Wang et al, 2004, J.Am.Chem.Soc, 126, 7784-85). This is a well-known polymer that is conveniently prepared with mean Mn values ranging from 2 to 35 KDa with Mw/Mn of approximately 1.2 This polymer can also be synthesized by anionic polymerization with a narrower size distribution.
polyacrylamide, or polymethacrylamide.

The metal-chelating groups can be attached to the polymer by methods known to those skilled in the art, for example, the pendant group may be attached through an ester or through an amide. For instance, to a methylacrylate based polymer, the metal-chelating group can be attached to the polymer backbone first by reaction of the polymer with ethylenediamine in methanol, followed by subsequent reaction of DTPA anhydride under alkaline conditions in a carbonate buffer.

A second means is to generate nanoparticles which can act as mass tags. A first pathway to generating such mass tags is the use of nanoscale particles of the metal which have been coated in a polymer. Here, the metal is sequestered and shielded from the environment by the polymer, and does not react when the polymer shell can be made to react e.g. by functional groups incorporated into the polymer shell. The functional groups can be reacted with linker components (optionally incorporating a spacer) to attach click chemistry reagents, so allowing this type of mass tag to plug in to the synthetics strategies discussed above in a simple, modular fashion.

Grafting-to and grafting-from are the two principle mechanism for generating polymer brushes around a nanoparticle. In grafting to, the polymers are synthesised separately, and so synthesis is not constrained by the need to keep the nanoparticle colloidally stable. Here reversible addition-fragmentation chain transfer (RAFT) synthesis has excelled due to a large variety of monomers and easy functionalization. The chain transfer agent (CTA) can be readily used as functional group itself, a functionalized CTA can be used or the polymer chains can be post-functionalized. A chemical reaction or physisorption is used to attach the polymers to the nanoparticle. One drawback of grafting-to is the usually lower grafting density, due to the steric repulsion of the coiled polymer chains during attachment to the particle surface. All grafting-to methods suffer from the drawback that a rigorous workup is necessary to remove the excess of free ligand from the functionalized nanocomposite particle. This is typically achieved by selective precipitation and centrifugation. In the grafting-from approach molecules, like initiators for atomic transfer radical polymerization (ATRP) or CTAs for (RAFT) polymerizations, are immobilized on the particle surface. The drawbacks of this method are the development of new initiator coupling reactions. Moreover, contrary to grafting-to, the particles have to be colloidally stable under the polymerization conditions.

An additional means of generating a mass tag is via the use of doped beads. Chelated lanthanide (or other metal) ions can be employed in miniemulsion polymerization to create polymer particles with the chelated lanthanide ions embedded in the polymer. The chelating groups are chosen, as is known to those skilled in the art, in such a way that the metal chelate will have negligible solubility in water but reasonable solubility in the monomer for miniemulsion polymerization. Typical monomers that one can employ are styrene, methylstyrene, various acrylates and methacrylates, among others as is known to those skilled in the art. For mechanical robustness, the metal-tagged particles have a glass transition temperature (Tg) above room temperature. In some instances, core-shell particles are used, in which the metal-containing particles prepared by miniemulsion polymerization are used as seed particles for a seeded emulsion polymerization to control the nature of the surface functionality. Surface functionality can be introduced through the choice of appropriate monomers for this second-stage polymerization. Additionally, acrylate (and possible methacrylate) polymers are advantageous over polystyrene particles because the ester groups can bind to or stabilize the unsatisfied ligand sites on the lanthanide complexes. An exemplary method for making such doped beads is: (a) combining at least one labelling atom-containing complex in a solvent mixture comprising at least one organic monomer (such as styrene and/or methyl methacrylate in one embodiment) in which the at least one labelling atom-containing complex is soluble and at least one different solvent in which said organic monomer and said at least one labelling atom-containing complex are less soluble, (b) emulsifying the mixture of step (a) for a period of time sufficient to provide a uniform emulsion; (c) initiating polymerization and continuing reaction until a substantial portion of monomer is converted to polymer; and (d) incubating the product of step (c) for a period of time sufficient to obtain a latex suspension of polymeric particles with the at least one labelling atom-containing complex incorporated in or on the particles therein, wherein said at least one labelling atom-containing complex is selected such that upon interrogation of the polymeric mass tag, a distinct mass signal is obtained from said at least one labelling atom. By the use of two or more complexes comprising different labelling atoms, doped beads can be made comprising two or more different labelling atoms. Furthermore, controlling the ration of the complexes comprising different labelling atoms, allows the production of doped beads with different ratios of the labelling atoms. By use of multiple labelling atoms, and in different radios, the number of distinctively identifiable mass tags is increased. In core-shell beads, this may be achieved by incorporating a first labelling atom-containing complex into the core, and a second labelling atom-containing complex into the shell.

A yet further means is the generation of a polymer that include the labelling atom in the backbone of the polymer rather than as a co-ordinated metal ligand. For instance, Carerra and Seferos (Macromolecules 2015, 48, 297-308) disclose the inclusion of tellurium into the backbone of a polymer. Other polymers incorporating atoms capable as functioning as labelling atoms tin-, antimony- and bismuth-incorporating polymers. Such molecules are discussed inter alia in Priegert et al., 2016 (Chem. Soc. Rev., 45, 922-953).

Thus the mass tag can comprise at least two components: the labelling atoms, and a polymer, which either chelates, contains or is doped with the labelling atom. In addition, the mass tag comprises an attachment group (when not-conjugated to the SBP), which forms part of the chemical linkage between the mass tag and the SBP following reaction of the two components, in a click chemistry reaction in line with the discussion above.

A polydopamine coating can be used as a further way to attach SBPs to e.g. doped beads or nanoparticles. Given the range of functionalities in polydopamine, SBPs can be conjugated to the mass tag formed from a PDA coated bead or particle by reaction of e.g. amine or sulhydryl groups on the SBP, such as an antibody. Alternatively, the functionalities on the PDA can be reacted with reagents such as bifunctional linkers which introduce further functionalities in turn for reaction with the SBP. In some instances, the linkers can contain spacers, as discussed below. These spacers increase the distance between the mass tag and the SBP, minimising steric hindrance of the SBP. Thus the invention comprises a mass-tagged SBP, comprising an SBP and a mass tag comprising polydopamine, wherein the polydopamine comprises at least part of the link between the SBP and the mass tag. Nanoparticles and beads, in particular polydopamine coated nanoparticles and beads, may be useful for signal enhancement to detect low abundance targets, as they can have thousands of metal atoms and may have multiple copies of the same affinity reagent. The affinity reagent could be a secondary antibody, which could further boost signal.

Labelling Atom

Labelling atoms that can be used with the disclosure include any species that are detectable by MS or OES and that are substantially absent from the unlabelled tissue sample. Thus, for instance, ¹²C atoms would be unsuitable as labelling atoms because they are naturally abundant, whereas ¹¹C could in theory be used for MS because it is an artificial isotope which does not occur naturally. Often the labelling atom is a metal. In preferred embodiments, however, the labelling atoms are transition metals, such as the rare earth metals (the 15 lanthanides, plus scandium and yttrium). These 17 elements (which can be distinguished by OES and MS) provide many different isotopes which can be easily distinguished (by MS). A wide variety of these elements are available in the form of enriched isotopes e.g. samarium has 6 stable isotopes, and neodymium has 7 stable isotopes, all of which are available in enriched form. The 15 lanthanide elements provide at least 37 isotopes that have non-redundantly unique masses. Examples of elements that are suitable for use as labelling atoms include Lanthanum (La), Cerium (Ce), Praseodymium (Pr), Neodymium (Nd), Promethium (Pm), Samarium (Sm), Europium (Eu), Gadolinium, (Gd), Terbium (Tb), Dysprosium (Dy), Holmium (Ho), Erbium (Er), Thulium (Tm), Ytterbium (Yb), Lutetium (Lu), Scandium (Sc), and Yttrium (Y). In addition to rare earth metals, other metal atoms are suitable for detection e.g. gold (Au), platinum (Pt), iridium (Ir), rhodium (Rh), bismuth (Bi), etc. The use of radioactive isotopes is not preferred as they are less convenient to handle and are unstable e.g. Pm is not a preferred labelling atom among the lanthanides.

In order to facilitate time-of-flight (TOF) analysis (as discussed herein) it is helpful to use labelling atoms with an atomic mass within the range 80-250 e.g. within the range 80-210, or within the range 100-200. This range includes all of the lanthanides, but excludes Sc and Y. The range of 100-200 permits a theoretical 101-plex analysis by using different labelling atoms, while taking advantage of the high spectral scan rate of TOF MS. As mentioned above, by choosing labelling atoms whose masses lie in a window above those seen in an unlabelled sample (e.g. within the range of 100-200), TOF detection can be used to provide rapid imaging at biologically significant levels.

Various numbers of labelling atoms can be attached to a single SBP member dependent upon the mass tag used (and so the number of labelling atoms per mass tag) and the number of mass tags that are attached to each SBP). Greater sensitivity can be achieved when more labelling atoms are attached to any SBP member. For example, greater than 10, 20, 30, 40, 50, 60, 70, 80, 90 or 100 labelling atoms can be attached to a SBP member, such as up to 10,000, for instance as 5-100, 10-250, 250-5,000, 500-2,500, or 500-1,000 labelling atoms. As noted above, monodisperse polymers containing multiple monomer units may be used, each containing a chelator such as diethylenetriaminepentaacetic acid (DTPA) or DOTA. DTPA, for example, binds 3+lanthanide ions with a dissociation constant of around 10⁻⁶ M. These polymers can terminate in a thiol which can be used for attaching to a SBP via reaction of that with a maleimide to attach a click chemistry reactivity in line with those discussed above. Other functional groups can also be used for conjugation of these polymers e.g. amine-reactive groups such as N-hydroxy succinimide esters, or groups reactive against carboxyls or against an antibody's glycosylation. Any number of polymers may bind to each SBP. Specific examples of polymers that may be used include straight-chain (“X8”) polymers or third-generation dendritic (“DN3”) polymers, both available as MaxPar™ reagents. Use of metal nanoparticles can also be used to increase the number of atoms in a label, as also discussed above.

In some embodiments, all labelling atoms in a mass tag are of the same atomic mass. Alternatively, a mass tag can comprise labelling atoms of differing atomic mass. Accordingly, in some instances, a labelled sample may be labelled with a series of mass-tagged SBPs each of which comprises just a single type of labelling atom (wherein each SBP binds its cognate target and so each kind of mass tag is localised on the sample to a specific e.g. antigen). Alternatively, in some instance, a labelled sample may be labelled with a series of mass-tagged SBPs each of which comprises a mixture of labelling atoms. In some instances, the mass-tagged SBPs used to label the sample may comprise a mix of those with single labelling atom mass tags and mixes of labelling atoms in their mass tags.

Spacer

As noted above, in some instances, the SBP is conjugated to a mass tag through a linker which comprises a spacer. There may be a spacer between the SBP and the click chemistry reagent (e.g. between the SBP and the strained cycloalkyne (or azide); strained cycloalkene (or tetrazine); etc.). There may be a spacer between the between the mass tag and the click chemistry reagent (e.g. between the mass tag and the azide (or strained cycloalkyne); tetrazine (or strained cycloalkene); etc.). In some instances there may be a spacer both between the SNP and the click chemistry reagent, and the click chemistry reagent and the mass tag.

The spacer might be a polyethylene glycol (PEG) spacer, a poly(N-vinylpyrolide) (PVP) spacer, a polyglycerol (PG) spacer, poly(N-(2-hydroxylpropyl)methacrylamide) spacer, or a polyoxazoline (POZ, such as polymethyloxazoline, polyethyloxazoline or polypropyloxazoline) or a C5-C20 non-cyclic alkyl spacer. For example, the spacer may be a PEG spacer with 3 or more, 4 or more, 5 or more, 6 or more, 7 or more, 8 or more, 9 or more, 10 or more, 11 or more, 12 or more, 15 or more of 20 or more EG (ethylene glycol) units. The PEG linker may have from 3 to 12 EG units, from 4 to 10, or may have 4, 5, 6, 7, 8, 9, or 10 EG units. The linker may include cystamine or derivatives thereof, may include one or more disulfide groups, or may be any other suitable linker known to one of skill in the art.

Spacers may be beneficial to minimize the steric effect of the mass tag on the SBP to which is conjugated. Hydrophilic spacers, such as PEG based spacers, may also act to improve the solubility of the mass-tagged SBP and act to prevent aggregation.

SBPs

Mass cytometry, including imaging mass cytometry is based on the principle of specific binding between members of specific binding pairs. The mass tag is linked to a specific binding pair member, and this localises the mass tag to the target/analyte which is the other member of the pair. Specific binding does not require binding to just one molecular species to the exclusion of others, however. Rather it defines that the binding is not-nonspecific, i.e. not a random interaction. An example of an SBP that binds to multiple targets would therefore be an antibody which recognises an epitope that is common between a number of different proteins. Here, binding would be specific, and mediated by the CDRs of the antibody, but multiple different proteins would be detected by the antibody. The common epitopes may be naturally occurring, or the common epitope could be an artificial tag, such as a FLAG tag. Similarly, for nucleic acids, the a nucleic acid of defined sequence may not bind exclusively to a fully complementary sequence, but varying tolerances of mismatch can be introduced under the use of hybridisation conditions of a differing stringencies, as would be appreciated by one of skill in the art. Nonetheless, this hybridisation is not non-specific, because it is mediated by homology between the SBP nucleic acid and the target analyte. Similarly, ligands can bind specifically to multiple receptors, a facile example being TNFα which binds to both TNFR1 and TNFR2.

The SBP may comprise any of the following: a nucleic acid duplex; an antibody/antigen complex; a receptor/ligand pair; or an aptamer/target pair. Thus a labelling atom can be attached to a nucleic acid probe which is then contacted with a tissue sample so that the probe can hybridise to complementary nucleic acid(s) therein e.g. to form a DNA/DNA duplex, a DNA/RNA duplex, or a RNA/RNA duplex. Similarly, a labelling atom can be attached to an antibody which is then contacted with a tissue sample so that it can bind to its antigen. A labelling atom can be attached to a ligand which is then contacted with a tissue sample so that it can bind to its receptor. A labelling atom can be attached to an aptamer ligand which is then contacted with a tissue sample so that it can bind to its target. Thus, labelled SBP members can be used to detect a variety of targets in a sample, including DNA sequences, RNA sequences, proteins, sugars, lipids, or metabolites.

The mass-tagged SBP therefore can be a protein or peptide, or a polynucleotide or oligonucleotide.

Examples of protein SBPs include an antibody or antigen binding fragment thereof, a monoclonal antibody, a polyclonal antibody, a bispecific antibody, a multispecific antibody, an antibody fusion protein, scFv, antibody mimetic, avidin, streptavidin, neutravidin, biotin, or a combination thereof, wherein optionally the antibody mimetic comprises a nanobody, affibody, affilin, affimer, affitin, alphabody, anticalin, avimer, DARPin, Fynomer, kunitz domain peptide, monobody, or any combination thereof, a receptor, such as a receptor-Fc fusion, a ligand, such as a ligand-Fc fusion, a lectin, for example an agglutinin such as wheat germ agglutinin.

The peptide may be a linear peptide, or a cyclical peptide, such as a bicyclic peptide. One example of a peptide that can be used is Phalloidin.

A polynucleotide or oligonucleotide generally refers to a single- or double-stranded polymer of nucleotides containing deoxyribonucleotides or ribonucleotides that are linked by 3′-5′ phosphodiester bonds, as well as polynucleotide analogs. A nucleic acid molecule includes, but is not limited to, DNA, RNA, and cDNA. A polynucleotide analog may possess a backbone other than a standard phosphodiester linkage found in natural polynucleotides and, optionally, a modified sugar moiety or moieties other than ribose or deoxyribose. Polynucleotide analogs contain bases capable of hydrogen bonding by Watson-Crick base pairing to standard polynucleotide bases, where the analog backbone presents the bases in a manner to permit such hydrogen bonding in a sequence-specific fashion between the oligonucleotide analog molecule and bases in a standard polynucleotide. Examples of polynucleotide analogs include, but are not limited to xeno nucleic acid (XNA), bridged nucleic acid (BNA), glycol nucleic acid (GNA), peptide nucleic acids (PNAs), yPNAs, morpholino polynucleotides, locked nucleic acids (LNAs), threose nucleic acid (TNA), 2′-0-Methyl polynucleotides, 2′-0-alkyl ribosyl substituted polynucleotides, phosphorothioate polynucleotides, and boronophosphate polynucleotides. A polynucleotide analog may possess purine or pyrimidine analogs, including for example, 7-deaza purine analogs, 8-halopurine analogs, 5-halopyrimidine analogs, or universal base analogs that can pair with any base, including hypoxanthine, nitroazoles, isocarbostyril analogues, azole carboxamides, and aromatic triazole analogues, or base analogs with additional functionality, such as a biotin moiety for affinity binding.

Antibody SBP Members

In a typical embodiment, the labelled SBP member is an antibody. Labelling of the antibody can be achieved through conjugation of one or more labelling atom binding molecules to the antibody, by attachment of a mass tag using e.g. NHS-amine chemistry, sulfhydryl-maleimide chemistry, or the click chemistry (such as strained alkyne and azide, strained alkyne and nitrone, strained alkene and tetrazine etc.). Antibodies which recognise cellular proteins that are useful for imaging are already widely available for IHC usage, and by using labelling atoms instead of current labelling techniques (e.g. fluorescence) these known antibodies can be readily adapted for use in methods disclosure herein, but with the benefit of increasing multiplexing capability. Antibodies can recognise targets on the cell surface or targets within a cell. Antibodies can recognise a variety of targets e.g. they can specifically recognise individual proteins, or can recognise multiple related proteins which share common epitopes, or can recognise specific post-translational modifications on proteins (e.g. to distinguish between tyrosine and phosphor-tyrosine on a protein of interest, to distinguish between lysine and acetyl-lysine, to detect ubiquitination, etc.). After binding to its target, labelling atom(s) conjugated to an antibody can be detected to reveal the location of that target in a sample.

The labelled SBP member will usually interact directly with a target SBP member in the sample. In some embodiments, however, it is possible for the labelled SBP member to interact with a target SBP member indirectly e.g. a primary antibody may bind to the target SBP member, and a labelled secondary antibody can then bind to the primary antibody, in the manner of a sandwich assay. Usually, however, the method relies on direct interactions, as this can be achieved more easily and permits higher multiplexing. In both cases, however, a sample is contacted with a SBP member which can bind to a target SBP member in the sample, and at a later stage label attached to the target SBP member is detected.

Nucleic Acid SBPs, and Labelling Methodology Modifications

RNA is another biological molecule which the methods and apparatus disclosed herein are capable of detecting in a specific, sensitive and if desired quantitative manner. In the same manner as described above for the analysis of proteins, RNAs can be detected by the use of a SBP member labelled with an elemental tag that specifically binds to the RNA (e.g. an poly nucleotide or oligonucleotide of complementary sequence as discussed above, including a locked nucleic acid (LNA) molecule of complementary sequence, a peptide nucleic acid (PNA) molecule of complementary sequence, a plasmid DNA of complementary sequence, an amplified DNA of complementary sequence, a fragment of RNA of complementary sequence and a fragment of genomic DNA of complementary sequence). RNAs include not only the mature mRNA, but also the RNA processing intermediates and nascent pre-mRNA transcripts.

In certain embodiments, both RNA and protein are detected using methods of the claimed invention.

To detect RNA, cells in biological samples as discussed herein may be prepared for analysis of RNA and protein content using the methods and apparatus described herein. In certain aspects, cells are fixed and permeabilized prior to the hybridization step. Cells may be provided as fixed and/or pemeabilized. Cells may be fixed by a crosslinking fixative, such as formaldehyde, glutaraldehyde. Alternatively or in addition, cells may be fixed using a precipitating fixative, such as ethanol, methanol or acetone. Cells may be permeabilized by a detergent, such as polyethylene glycol (e.g., Triton X-100), Polyoxyethylene (20) sorbitan monolaurate (Tween-20), Saponin (a group of amphipathic glycosides), or chemicals such as methanol or acetone. In certain cases, fixation and permeabilization may be performed with the same reagent or set of reagents. Fixation and permeabilization techniques are discussed by Jamur et al. in “Permeabilization of Cell Membranes” (Methods Mol. Biol., 2010).

Detection of target nucleic acids in the cell, or “in-situ hybridization” (ISH), has previously been performed using fluorophore-tagged oligonucleotide probes. As discussed herein, mass-tagged oligonucleotides, coupled with ionization and mass spectrometry, can be used to detect target nucleic acids in the cell. Methods of in-situ hybridization are known in the art (see Zenobi et al. “Single-Cell Metabolomics: Analytical and Biological Perspectives,” Science vol. 342, no. 6163, 2013). Hybridization protocols are also described in US Pat. No. 5,225,326 and US Pub. No. 2010/0092972 and 2013/0164750, which are incorporated herein by reference.

Prior to hybridization, cells immobilized on a solid support may be fixed and permeabilized as discussed earlier. Permeabilization may allow a cell to retain target nucleic acids while permitting target hybridization nucleotides, amplification oligonucleotides, and/or mass-tagged oligonucleotides to enter the cell. The cell may be washed after any hybridization step, for example, after hybridization of target hybridization oligonucleotides to nucleic acid targets, after hybridization of amplification oligonucleotides, and/or after hybridization of mass-tagged oligonucleotides.

Cells can be in suspension for all or most of the steps of the method, for ease of handling. However, the methods are also applicable to cells in solid tissue samples (e.g., tissue sections) and/or cells immobilized on a solid support (e.g., a slide or other surface). Thus, sometimes, cells can be in suspension in the sample and during the hybridization steps. Other times, the cells are immobilized on a solid support during hybridization.

Target nucleic acids include any nucleic acid of interest and of sufficient abundance in the cell to be detected by the subject methods. Target nucleic acids may be RNAs, of which a plurality of copies exist within the cell. For example, 10 or more, 20 or more, 50 or more, 100 or more, 200 or more, 500 or more, or 1000 or more copies of the target RNA may be present in the cell. A target RNA may be a messenger NA (mRNA), ribosomal RNA (rRNA), transfer RNA (tRNA), small nuclear RNA (snRNA), small interfering RNA (siRNA), long noncoding RNA (IncRNA), or any other type of RNA known in the art. The target RNA may be 20 nucleotides or longer, 30 nucleotides or longer, 40 nucleotides or longer, 50 nucleotides or longer, 100 nucleotides or longer, 200 nucleotides or longer, 500 nucleotides or longer, 1000 nucleotides or longer, between 20 and 1000 nucleotides, between 20 and 500 nucleotides in length, between 40 and 200 nucleotides in length, and so forth.

In certain embodiments, a mass-tagged oligonucleotide may be hybridized directly to the target nucleic acid sequence. However, hybridization of additional oligonucleotides may allow for improved specificity and/or signal amplification.

In certain embodiments, two or more target hybridization oligonucleotides may be hybridized to proximal regions on the target nucleic acid, and may together provide a site for hybridization of an additional oligonucleotides in the hybridization scheme.

In certain embodiments, the mass-tagged oligonucleotide may be hybridized directly to the two or more target hybridization oligonucleotides. In other embodiments, one or more amplification oligonucleotides may be added, simultaneously or in succession, so as to hybridize the two or more target hybridization oligonucleotides and provide multiple hybridization sites to which the mass-tagged oligonucleotide can bind. The one or more amplification oligonucleotides, with or without the mass-tagged oligonucleotide, may be provided as a multimer capable of hybridizing to the two or more target hybridization oligonucleotides.

While the use of two or more target hybridization oligonucleotides improves specificity, the use of amplification oligonucleotides increases signal. Two target hybridization oligonucleotides are hybridized to a target RNA in the cell. Together, the two target hybridization oligonucleotides provide a hybridization site to which an amplification oligonucleotide can bind. Hybridization and/or subsequent washing of the amplification oligonucleotide may be performed at a temperature that allows hybridization to two proximal target hybridization oligonucleotides, but is above the melting temperature of the hybridization of the amplification oligonucleotide to just one target hybridization oligonucleotide. The first amplification oligonucleotide provides multiple hybridization sites, to which second amplification oligonucleotides can be bound, forming a branched pattern. Mass-tagged oligonucleotides may bind to multiple hybridization sites provided by the second amplification nucleotides. Together, these amplification oligonucleotides (with or without mass-tagged oligonucleotides) are referred to herein as a “multimer”. Thus the term “amplification oligonucleotide” includes oligonucleotides that provides multiple copies of the same binding site to which further oligonucleotides can anneal. By increasing the number of binding sites for other oligonucleotides, the final number of labels that can be found to a target is increased. Thus, multiple labelled oligonucleotides are hybridized, indirectly, to a single target RNA. This is enables the detection of low copy number RNAs, by increasing the number of detectable atoms of the element used per RNA.

One particular method for performing this amplification comprises using the RNAscope® method from Advanced cell diagnostics, as discussed in more detail below. A further alternative is the use of a method that adapts the QuantiGene® FlowRNA method (Affymetrix eBioscience). The assay is based on oligonucleotide pair probe design with branched DNA (bDNA) signal amplification. There are more than 4,000 probes in the catalog or custom sets can be requested at no additional charge. In line with the previous paragraph, the method works by hybridization of target hybridization oligonucleotides to the target, followed by the formation of a branched structure comprising first amplification oligonucleotides (termed preamplification oligonucleotides in the QuantiGene® method) to form a stem to which multiple second amplification oligonucleotides can anneal (termed simply amplification oligonucleotides in the QuantiGene® method). Multiple mass-tagged oligonucleotides can then bind.

Another means of amplification of the RNA signal relies on the rolling circle means of amplification (RCA). There are various means why which this amplification system can be introduced into the amplification process. In a first instance, a first nucleic acid is used as the hybridisation nucleic acid wherein the first nucleic acid is circular. The first nucleic acid can be single stranded or may be double-stranded. It comprises as sequence complementary to the target RNA. Following hybridisation of the first nucleic acid to the target RNA, a primer complementary to the first nucleic acid is hybridised to the first nucleic acid, and used for primer extension using a polymerase and nucleic acids, typically exogenously added to the sample. In some instances, however, when the first nucleic acid is added to sample, it may already have the primer for extension hybridised to it. As a result of the first nucleic acid being circular, once the primer extension has completed a full round of replication, the polymerase can displace the primer and extension continues (i.e. without 5′→3′ exonuclase activity), producing linked further and further chained copies of the complement of the first nucleic acid, thereby amplifying that nucleic acid sequence. Oligonucleotides comprising an elemental tag (RNA or DNA, or LNA or PNA and the like) as discussed above) may therefore be hybridised to the chained copies of the complement of the first nucleic acid. The degree of amplification of the RNA signal can therefore be controlled by the length of time allotted for the step of amplification of the circular nucleic acid.

In another application of RCA, rather than the first, e.g., oligonucleotide that hybridises to the target RNA being circular, it may be linear, and comprise a first portion with a sequence complementary to its target and a second portion which is user-chosen. A circular RCA template with sequence homologous to this second portion may then be hybridised to this the first oligonucleotide, and RCA amplification carried out as above. The use of a first, e.g., oligonucleotide having a target specific portion and user-chosen portion is that the user-chosen portion can be selected so as to be common between a variety of different probes. This is reagent-efficient because the same subsequent amplification reagents can be used in a series of reactions detecting different targets. However, as understood by the skilled person, when employing this strategy, for individual detection of specific RNAs in a multiplexed reaction, each first nucleic acid hybridising to the target RNA will need to have a unique second sequence and in turn each circular nucleic acid should contain unique sequence that can be hybridised by the labelled oligonucleotide. In this manner, signal from each target RNA can be specifically amplified and detected.

Other configurations to bring about RCA analysis will be known to the skilled person. In some instances, to prevent the first, e.g., oligonucleotide dissociating from the target during the following amplification and hybridisation steps, the first, e.g., oligonucleotide may be fixed following hybridisation (such as by formaldehyde).

Further, hybridisation chain reaction (HCR) may be used to amplify the RNA signal (see, e.g., Choi et al., 2010, Nat. Biotech, 28:1208-1210). Choi explains that an HCR amplifier consists of two nucleic acid hairpin species that do not polymerise in the absence of an initiator. Each HCR hairpin consists of an input domain with an exposed single-stranded toehold and an output domain with a single-stranded toehold hidden in the folded hairpin. Hybridization of the initiator to the input domain of one of the two hairpins opens the hairpin to expose its output domain. Hybridization of this (previously hidden) output domain to the input domain of the second hairpin opens that hairpin to expose an output domain identical in sequence to the initiator. Regeneration of the initiator sequence provides the basis for a chain reaction of alternating first and second hairpin polymerization steps leading to formation of a nicked double-stranded ‘polymer’. Either or both of the first and second hairpins can be labelled with an elemental tag in the application of the methods and apparatus disclosed herein. As the amplification procedure relies on output domains of specific sequence, various discrete amplification reactions using separate sets of hairpins can be performed independently in the same process. Thus this amplification also permits amplification in multiplex analyses of numerous RNA species. As Choi notes, HCR is an isothermal triggered self-assembly process. Hence, hairpins penetrate the sample before undergoing triggered self-assembly in situ, suggesting the potential for deep sample penetration and high signal-to-background ratios

Hybridization may include contacting cells with one or more oligonucleotides, such as target hybridization oligonucleotides, amplification oligonucleotides, and/or mass-tagged oligonucleotides, and providing conditions under which hybridization can occur. Hybridization may be performed in a buffered solution, such as saline sodium-citrate (SCC) buffer, phosphate-buffered saline (PBS), saline-sodium phosphate-EDTA (SSPE) buffer, TNT buffer (having Tris-HCI, sodium chloride and Tween 20), or any other suitable buffer. Hybridization may be performed at a temperature around or below the melting temperature of the hybridization of the one or more oligonucleotides.

Specificity may be improved by performing one or more washes following hybridization, so as to remove unbound oligonucleotide. Increased stringency of the wash may improve specificity, but decrease overall signal. The stringency of a wash may be increased by increasing or decreasing the concentration of the wash buffer, increasing temperature, and/or increasing the duration of the wash. RNAse inhibitor may be used in any or all hybridization incubations and subsequent washes.

A first set of hybridization probes, including one or more target hybridizing oligonucleotides, amplification oligonucleotides and/or mass-tagged oligonucleotides, may be used to label a first target nucleic acid. Additional sets of hybridization probes may be used to label additional target nucleic acids. Each set of hybridization probes may be specific for a different target nucleic acid. The additional sets of hybridization probes may be designed, hybridized and washed so as to reduce or prevent hybridization between oligonucleotides of different sets. In addition, the mass-tagged oligonucleotide of each set may provide a unique signal. As such, multiple sets of oligonucleotides may be used to detect 2, 3, 5, 10, 15, 20 or more distinct nucleic acid targets.

Sometimes, the different nucleic acids detected are splice variants of a single gene. The mass-tagged oligonucleotide can be designed to hybridize (directly or indirectly through other oligonucleotides as explained below) within the sequence of the exon, to detect all transcripts containing that exon, or may be designed to bridge the splice junctions to detect specific variants (for example, if a gene had three exons, and two splice variants—exons 1-2-3 and exons 1-3—then the two could be distinguished: variant 1-2-3 could be detected specifically by hybridizing to exon 2, and variant 1-3 could be detected specifically by hybridizing across the exon 1-3 junction.

Histochemical Stains

The histochemical stain reagents having one or more intrinsic metal atoms may be combined with other reagents and methods of use as described herein. For example, histochemical stains may be colocalized (e.g., at cellular or subcellular resolution) with metal containing drugs, metal-labelled antibodies, and/or accumulated heavy metals. In certain aspects, one or more histochemical stains may be used at lower concentrations (e.g., less than half, a quarter, a tenth, etc.) from what is used for other methods of imaging (e.g., fluorescence microscopy, light microscopy, or electron microscopy).

To visualize and identify structures, a broad spectrum of histological stains and indicators are available and well characterized. The metal-containing stains have a potential to influence the acceptance of the imaging mass cytometry by pathologists. Certain metal containing stains are well known to reveal cellular components, and are suitable for use in the subject invention. Additionally, well defined stains can be used in digital image analysis providing contrast for feature recognition algorithms. These features are strategically important for the development of imaging mass cytometry.

Often, morphological structure of a tissue section can be contrasted using affinity products such as antibodies. They are expensive and require additional labelling procedure using metal-containing tags, as compared to using histochemical stains. This approach was used in pioneering works on imaging mass cytometry using antibodies labelled with available lanthanide isotopes thus depleting mass (e.g. metal) tags for functional antibodies to answer a biological question.

The subject invention expands the catalog of available isotopes including such elements as Ag, Au, Ru, W, Mo, Hf, Zr (including compounds such as Ruthenium Red used to identify mucinous stroma, Trichrome stain for identification of collagen fibers, osmium tetroxide as cell counterstain). Silver staining is used in karyotyping. Silver nitrate stains the nucleolar organization region (NOR)-associated protein, producing a dark region wherein the silver is deposited and denoting the activity of rRNA genes within the NOR. Adaptation to IMC may require that the protocols (e.g., oxidation with potassium permanganate and a silver concentration of 1% during) be modified for use lower concentrations of silver solution, e.g., less than 0.5%, 0.01%, or 0.05% silver solution.

Autometallographic amplification techniques have evolved into an important tool in histochemistry. A number of endogenous and toxic heavy metals form sulfide or selenide nanocrystals that can be autocatalytically amplified by reaction with Ag ions. The larger Ag nanocluster can then be readily visualized by IMC. At present, robust protocols for the silver amplified detection of Zn—S/Se nanocrystals have been established as well as detection of selenium through formation of silver-selenium nanocrystals. In addition, commercially available quantum dots (detection of Cd) are also autocatalytically active and may be used as histochemical labels.

Aspects of the subject invention may include histochemical stains and their use in imaging by elemental mass spectrometry. Any histochemical stain resolvable by elemental mass spectrometry may be used in the subject invention. In certain aspects, the histochemical stain includes one or more atoms of mass greater than a cut-off of the elemental mass spectrometer used to image the sample, such as greater than 60 amu, 80 amu, 100 amu, or 120 amu. For example, the histochemical stain may include a metal tag (e.g., metal atom) as described herein. The metal atom may be chelated to the histochemical stain, or covalently bound within the chemical structure of the histochemical stain. In certain aspects, the histochemical stain may be an organic molecule. Histochemical stains may be polar, hydrophobic (e.g., lipophilic), ionic or may comprise groups with different properties. In certain aspects, a histochemical stain may comprise more than one chemical.

Histochemical stains include small molecules of less than 2000, 1500, 1000, 800, 600, 400, or 200 amu. Histochemical stains may bind to the sample through covalent or non-covalent (e.g., ionic or hydrophobic) interactions. Histochemical stains may provide contrast to resolve the morphology of the biological sample, for example, to help identify individual cells, intracellular structures, and/or extracellular structures. Intracellular structures that may be resolved by histochemical stains include cell membrane, cytoplasm, nucleus, Golgi body, ER, mitochondria, and other cellular organelles. Histochemical stains may have an affinity for a type of biological molecule, such as nucleic acids, proteins, lipids, phospholipids or carbohydrates. In certain aspects, a histochemical stain may bind a molecule other than DNA. Suitable histochemical stains also include stains that bind extracellular structures (e.g., structures of the extracellular matrix), including stroma (e.g., mucosal stroma), basement membrane, interstitial stroma, proteins such as collage or elastin, proteoglycans, non-proteoglycan polysaccharides, extracellular vesicles, fibronectin, laminin, and so forth.

In certain aspects, histochemical stains and/or metabolic probes may indicate a state of a cell or tissue. For example, histochemical stains may include vital stains such as cisplatin, eosin, and propidium iodide. Other histochemical stains may stain for hypoxia, e.g., may only bind or deposit under hypoxic conditions. Probes such as Iododeoxyuridine (IdU) or a derivative thereof, may stain for cell proliferation. In certain aspects, the histochemical stain may not indicate the state of the cell or tissue. Probes that detect cell state (e.g., viability, hypoxia and/or cell proliferation) but are administered in-vivo (e.g., to a living animal or cell culture) be used in any of the subject methods but do not qualify as histochemical stains.

Histochemical stains may have an affinity for a type of biological molecule, such as nucleic acids (e.g., DNA and/or RNA), proteins, lipids, phospholipids, carbohydrates (e.g., sugars such as mono-saccharides or di-saccharides or polyols; oligosaccharides; and/or polysaccharides such as starch or glycogen), glycoproteins, and/or glycolipids. In certain aspects the histochemical stain may be a counterstain.

The following are examples of specific histochemical stains and their use in the subject methods:

Ruthenium Red stain as a metal-containing stain for mucinous stroma detection may be used as follows: Immunostained tissue (e.g., de-paraffinized FFPE or cryosection) may be treated with 0.0001-0.5%, 0.001-0.05%, less than 0.1%, less than 0.05%, or around 0.0025% Ruthenium Red (e.g., for at least 5 minutes, at least 10 minutes, at least 30 minutes, or around 30 min at 4-42° C., or around room temperature). The biological sample may be rinsed, for example with water or a buffered solution. Tissue may then be dried before imaging by elemental mass spectrometry.

Phosphotungstic Acid (e.g., as a Trichrome stain) may be used as a metal-containing stain for collagen fibers. Tissue sections on slides (de-paraffinized FFPE or cryosection) may be fixed in Bouin's fluid (e.g., for at least 5 minutes, at least 10 minutes, at least 30 minutes, or around 30 minutes at 4-42° C. or around room temperature). The sections may then be treated with 0.0001%-0.01%, 0.0005%-0.005%, or around 0.001% Phosphotangstic Acid for (e.g., for at least 5 minutes, at least 10 minutes, at least 30 minutes, or around 15 minutes at 4-42° C. or around room temperature). Sample may then be rinsed with water and/or buffered solution, and optionally dried, prior to imaging by elemental mass spectrometry. Triichrome stain may be used at a dilution (e.g., 5 fold, 10 fold, 20 fold, 50 fold or great dilution) compared to concentrations used for imaging by light (e.g., fluorescence) microscopy.

In some embodiments, the histochemical stain is an organic molecule. In some embodiments, the second metal is covalently bound. In some embodiments, the second metal is chelated. In some embodiments, the histochemical stain specifically binds cell membrane. In some embodiments, the histochemical stain is osmium tetroxide. In some embodiments, the histochemical stain is lipophilic. In some embodiments, the histochemical stain specifically binds an extracellular structure. In some embodiments, the histochemical stain specifically binds extracellular collagen. In some embodiments, the histochemical stain is a trichrome stain comprising phosphotungstic/phosphomolybdic acid. In some embodiments, trichrome stain is used after contacting the sample with the antibody, such as at a lower concentration than would be used for optical imaging, for instance wherein the concentration is a 50 fold dilution of trichrome stain or greater.

Metal-Containing Drugs

Metals in medicine is a new and exciting field in pharmacology. Little is known about the cellular structures that are involved in transiently storing metal ions prior to their incorporation into metalloproteins, nucleic acid metal complexes or metal-containing drugs or the fate of metal ions upon protein or drug degradation. An important first step towards unravelling the regulatory mechanisms involved in trace metal transport, storage, and distribution represents the identification and quantitation of the metals, ideally in context of their native physiological environment in tissues, cells, or even at the level of individual organelles and subcellular compartments. Histological studies are typically carried out on thin sections of tissue or with cultured cells.

A number of metal-containing drugs are being used for treatment of various diseases, however not enough is known about their mechanism of action or biodistribution: cisplatin, ruthenium imidazole, metallocene-based anti-cancer agents with Mo, tungstenocenes with W, B-diketonate complexes with Hf or Zr, auranofin with Au, polyoxomolybdate drugs. Many metal complexes are used as MRI contrast agents (Gd(III) chelates). Characterization of the uptake and biodistribution of metal-based anti-cancer drugs is of critical importance for understanding and minimizing the underlying toxicity.

The atomic masses of certain metals present in drugs fall into the range of mass cytometry. Specifically, cisplatin and others with Pt complexes (iproplatin, lobplatin) are extensively used as a chemotherapeutic drug for treating a wide range of cancers. The nephrotoxicity and myelotoxicity of platinum-based anti-cancer drugs is well known. With the methods and reagents described herein, their subcellular localization within tissue sections, and colocalization with mass- (e.g. metal-) tagged antibodies and/or histochemical stains can now be examined. Chemotherepeutic drugs may be toxic to certain cells, such as proliferating cells, through direct DNA damage, inhibition of DNA damage repair pathways, radioactivity, and so forth. In certain aspects, chemotherapeutic drugs may be targeted to tumor through an antibody intermediate.

In certain aspects, the metal containing drug is a chemotherapeutic drug. Subject methods may include administering the metal containing drug to a living animal, such as an animal research model or human patient as previously described, prior to obtaining the biological sample. The biological sample may be, for example, a biopsy of cancerous tissue or primary cells. Alternatively, the metal containing drug may be added directly to the biological sample, which may be an immortalized cell line or primary cells. When the animal is a human patient, the subject methods may include adjusting a treatment regimen that includes the metal containing drug, based on detecting the distribution of the metal containing drug.

The method step of detecting the metal containing drug may include subcellular imaging of the metal containing drug by elemental mass spectrometry, and may include detecting the retention of the metal containing drug in an intracellular structure (such as membrane, cytoplasm, nucleus, Golgi body, ER, mitochondria, and other cellular organelles) and/or extracellular structure (such as including stroma, mucosal stroma, basement membrane, interstitial stroma, proteins such as collage or elastin, proteoglycans, non-proteoglycan polysaccharides, extracellular vesicles, fibronectin, laminin, and so forth).

A histochemical stain and/or mass- (e.g. metal-) tagged SBP that resolves (e.g., binds to) one or more of the above structures may be colocalized with the metal containing drug to detected retention of the drug at specific intracellular or extracellular structures. For example, a chemotherapeutic drug such as cisplatin may be colocalized with a structure such as collagen. Alternatively or in addition, the localization of the drug may be related to presence of a marker of cell viability, cell proliferation, hypoxia, DNA damage response, or immune response.

In some embodiments, the metal containing drug comprises a non-endogenous metal, such as wherein the non-endogenous metal is platinum, palladium, cerium, cadmium, silver or gold. In certain aspects, the metal containing drug is one of cisplatin, ruthenium imidazole, metallocene-based anti-cancer agents with Mo, tungstenocenes with W, B-diketonate complexes with Hf or Zr, auranofin with Au, polyoxomolybdate drugs, N-myristoyltransferase-1 inhibitor (Tris(dibenzylideneacetone) dipalladium) with Pd, or a derivative thereof. For example the drug may comprise Pt, and may be, for example, cisplatin, carboplatin, oxaliplatin, iproplatin, lobaplatin or a derivative thereof. The metal containing drug may include a non-endogenous metal, such as platinum (Pt), ruthenium (Ru), molybdenum (Mo), tungsten (W), hafnium (Hf), zirconium (Zr), gold (Au), gadolinium (Gd), palladium (Pd) or an isotope thereof. Gold compounds (Auranofin, for example) and gold nanoparticle bioconjugates for photothermal therapy against cancer can be identified in tissue sections.

Multiplexed Analysis

One feature of the disclosure is its ability to detect multiple (e.g. 10 or more, and even up to 100 or more) different target SBP members in a sample e.g. to detect multiple different proteins and/or multiple different nucleic acid sequences. To permit differential detection of these target SBP members their respective SBP members should carry different labelling atoms such that their signals can be distinguished. For instance, where ten different proteins are being detected, ten different antibodies (each specific for a different target protein) can be used, each of which carries a unique label, such that signals from the different antibodies can be distinguished. In some embodiments, it is desirable to use multiple different antibodies against a single target e.g. which recognise different epitopes on the same protein. Thus, a method may use more antibodies than targets due to redundancy of this type. In general, however, the disclosure will use a plurality of different labelling atoms to detect a plurality of different targets.

If more than one labelled antibody is used with the disclosure, it is preferable that the antibodies should have similar affinities for their respective antigens, as this helps to ensure that the relationship between the quantity of labelling atoms detected and the abundance of the target antigen in the tissue sample will be more consistent across different SBPs (particularly at high scanning frequencies). Similarly, it is preferable if the labelling of the various antibodies has the same efficiency, so that the antibodies each carry a comparable quantity of the labelling atom.

In some instances, the SBP may carry a fluorescent label as well as an elemental tag. Fluorescence of the sample may then be used to determine regions of the sample, e.g. a tissue section, comprising material of interest which can then be sampled for detection of labelling atoms. E.g. a fluorescent label may be conjugated to an antibody which binds to an antigen abundant on cancer cells, and any fluorescent cell may then be targeted to determine expression of other cellular proteins that are about by SBPs conjugated to labelling atoms.

If a target SBP member is located intracellularly, it will typically be necessary to permeabilize cell membranes before or during contacting of the sample with the labels. For example, when the target is a DNA sequence but the labelled SBP member cannot penetrate the membranes of live cells, the cells of the tissue sample can be fixed and permeabilised. The labelled SBP member can then enter the cell and form a SBP with the target SBP member. In this respect, known protocols for use with IHC and FISH can be utilised.

A method may be used to detect at least one intracellular target and at least one cell surface target. In some embodiments, however, the disclosure can be used to detect a plurality of cell surface targets while ignoring intracellular targets. Overall, the choice of targets will be determined by the information which is desired from the method, as the disclosure will provide an image of the locations of the chosen targets in the sample.

As described further herein, specific binding partners (i.e., affinity reagents) comprising labelling atoms may be used to stain (contact) a biological sample. Suitable specific binging partners include antibodies (including antibody fragments). Labelling atoms may be distinguishable by mass spectrometry (i.e., may have different masses). Labelling atoms may be referred to herein as metal tags when they include one or more metal atoms. Metal tags may include a polymer with a carbon backbone and a plurality of pendant groups that each bind a metal atom. Alternatively, or in addition, metal tags may include a metal nanoparticle. Antibodies may be tagged with a metal tag by a covalent or non-covalent interaction.

Antibody stains may be used to image proteins at cellular or subcellular resolution. Aspects of the invention include contacting the sample with one or more antibodies that specifically bind a protein expressed by cells of the biological sample, wherein the antibody is tagged with a first metal tag. For example, the sample may be contacted with 5 or more, 10 or more, 15 or more, 20 or more, 30 or more, 40 or more, 50 or more antibodies, each with a distinguishable metal tag. The sample may further be contacted with one or more histochemical stains before, during (e.g., for ease of workflow), or after (e.g., to avoid altering antigen targets of antibodies) staining the sample with antibodies. The sample may further comprise one or more metal containing drugs and/or accumulated heavy metals as described herein.

Metal tagged antibodies for use in the subject inventions may specifically bind a metabolic probe that does not comprise a metal (e.g., EF5). Other metal tagged antibodies may specifically bind a target (e.g., of epithelial tissue, stromal tissue, nucleus, etc.) of traditional stains used in fluorescence and light microscopy. Such antibodies include anti-cadherin, anti-collagen, anti-keratin, anti-EFS, anti-Histone H3 antibodies, and a number of other antibodies known in the art.

Single Cell Analysis

Methods of the disclosure include laser ablation of multiple cells in a sample, and thus sampled spots from multiple cells are analysed and their contents are mapped to specific locations in the sample to provide an image. In certain aspects, the image may be a 2D or 3D image. In most cases a user of the method will need to localise the signals to specific cells within the sample, rather than to the sample as a whole. To achieve this, the boundaries of cells (e.g. the plasma membrane, or in some cases the cell wall) in the sample can be demarcated.

Demarcation of cellular boundaries can be achieved in various ways. For instance, a sample can be studied using conventional techniques which can demarcate cellular boundaries, such as microscopy as discussed above. When performing these methods, therefore, an analysis system comprising a camera as discussed above is particularly useful. An image of this sample can then be prepared using a method of the disclosure, and this image can be superimposed on the earlier results, thereby permitting the detected signals to be localised to specific cells. Indeed, as discussed above, in some cases the laser ablation may be directed only to a subset of cells in the sample as determined to be of interest by the use of microscopy based techniques.

To avoid the need to use multiple techniques, however, it is possible to demarcate cellular boundaries as part of the imaging method of the disclosure. Such boundary demarcation strategies are familiar from IHC and immunocytochemistry, and these approaches can be adapted by using labels which can be detected. For instance, the method can involve labelling of target molecule(s) which are known to be located at cellular boundaries, and signal from these labels can then be used for boundary demarcation. Suitable target molecules include abundant or universal markers of cell boundaries, such as members of adhesion complexes (e.g. p-catenin or E-cadherin). Some embodiments can label more than one membrane protein in order to enhance demarcation.

In addition to demarcating cell boundaries by including suitable labels, it is also possible to demarcate specific organelles in this way. For instance, antigens such as histones (e.g. H3) can be used to identify the nucleus, and it is also possible to label mitochondrial-specific antigens, cytoskeleton-specific antigens, Golgi-specific antigens, ribosome-specific antigens, etc., thereby permitting cellular ultrastructure to be analysed by methods of the disclosure.

Signals which demarcate the boundary of a cell (or an organelle) can be assessed by eye, or can be analysed by computer using image processing. Such techniques are known in the art for other imaging techniques e.g. reference iv describes a segmentation scheme that uses spatial filtering to determine cell boundaries from fluorescence images, reference v discloses an algorithm which determines boundaries from brightfield microscopy images, reference vi discloses the CelISeT method to extract cell geometry from confocal microscope images, and reference vii discloses the CellSegm MATLAB toolbox for fluorescence microscope images. A method which is useful with the disclosure uses watershed transformation and Gaussian blurring. These image processing techniques can be used on their own, or they can be used and then checked by eye.

Once cellular boundaries have been demarcated it is possible to allocate signal from specific target molecules to individual cells. It can also be possible to quantify the amount of a target analyte(s) in an individual cell e.g. by calibrating the methods against quantitative standards.

Element Standard

In certain aspects, a sample carrier may include an element standard. Methods of the subject disclosure may include applying an element standard to a sample carrier. Alternatively, or in addition, methods of the present disclosure may include performing calibration based on the element standard and/or normalizing data obtained from the sample based on the element standard, as discussed further herein. Sample carriers and methods including an element standard may further include additional aspects or steps described elsewhere in the present disclosure.

An element standard may include particles (e.g., polymer beads) comprising known quantities of a plurality of isotopes. In certain aspects, the particles may have different sizes, each comprising quantities of a plurality of isotopes. The particles may be applied to the support holding a sample. In certain aspects the sample may include a cell smear. Element standard particles may be applied to the support (e.g., alongside the cell smear).

When the element standard comprises distinct particles as described herein, the subject systems and methods may allow for scanning a laser across the surface of the particle to provide a continuous signal. All of a particle may be acquired in this way, providing an integrated signal from a particle that has a known quantity of a plurality of isotopes. The signal acquired from a particle can be integrated over time and used for normalization or calibration as described herein.

Depending on the system and application, instrument sensitivity drift can be caused by a number of factors including ion optics drift, surface charging, detector drift (e.g., aging), temperature and gas flows drifts affecting diffusion, and electronics behaviour. Such instrument sensitivity can be accommodated by normalizing or calibrating using an element standard as described herein.

The element standard may include particles, film and/or a polymer that comprise one or more elements or isotopes. The element standard may include a consistent abundance of the elements or isotopes across the element standard. Alternatively, the element standard may include separate regions, each with a different amount of the one or more elements or isotopes (e.g., providing a standard curve). Different regions of the element standard may comprise a different combination of elements or isotopes.

As described herein, elemental standard particles (i.e., reference particles) of known elemental or isotopic composition may be added to the sample (or the sample support or sample carrier) for use as a reference during detection of target elemental ions in the sample. In certain embodiments, reference particles comprise metal elements or isotopes, such as transition metals or lanthanides. For example, reference particles may comprise elements or isotopes of mass greater than 60 amu, greater than 80 amu, greater than 100 amu, or greater than 120 amu. The quantity of the one or more elements or isotopes may be known. For example, the standard deviation of the number of atoms in reference particles of the same elemental or isotopic composition may be 50%, 40%, 30%, 20% or 10% of the average number of atoms.

In certain embodiments, the reference particles may be optically resolvable (e.g., may include one or more fluorophores).

In certain embodiments, reference particles may include elements or elemental isotopes with masses above 100 amu (e.g., elements in the lanthanide or transition element series). Alternatively, or in addition, reference particles may include a plurality of elements or elemental isotopes. For example, the reference particles may include elements or elemental isotopes that are identical to elements or elemental isotope of all, some or none of the labelling atoms in the sample. Alternatively, reference particles may include elements or elemental isotopes of masses above and below the masses of at least one of the labelling atoms. The reference particles may have a known quantity of one or more elements or isotopes. The reference particles may include reference particles with different elements or isotopes, or a different combination of elements or isotopes, than the target elements.

Element standard particles (i.e., reference particles) may have a similar diameter range as particles described generally herein, such as diameter at or between 1 nm and 1 um, between 10 nm and 500 nm, between 20 nm and 200 nm, between 50 nm and 100 nm, less than 1 um, less than 800 nm, less than 600 nm, less than 400 nm, less than 200 nm, less than 100 nm, less than 50 nm, less than 20 nm, less than 10 nm, or less than 1 nm. In certain aspects, the element standard particles may be nanoparticles. Elemental standard particles may have a similar composition as particles described generally herein, e.g., may have a metallic nanocrystal core and/or polymer surface.

Aspects of the invention include methods, samples and reference particles for normalization during a sample run by imaging mass spectrometry. Normalization may be performed by detection of individual reference particles. The reference particle may be used as a standard in imaging mass spectrometry, to correct for instrument sensitivity drift during the imaging of a sample, for example, according to any of the aspects of embodiments described below.

In certain aspects, a method of imaging mass spectrometry of a sample includes providing a sample on a solid support, where the sample includes one or more target elements, and where reference particles are distributed on or within the sample such that a plurality of the reference particles are individually resolvable. Ionizing and atomizing locations on the sample may be performed to produce target elemental ions and reference particle elemental ions. The target elemental ions and elemental ions from individual reference particles may be detected (e.g., at different locations on the sample). Target elemental ions may be normalized elemental ions of one or more individual reference particles detected in proximity to the detected target elemental ions. Alternatively or in addition, target elemental ions detected at a first and second location may be normalized to elemental ions detected from different individual reference particles. An image of the normalized target elemental ions may then be generated by any means known in the art or described herein.

Aspects of the invention include a biological sample on a solid support including a plurality of specific binding partners attached (e.g., covalently or non-covalently) to labelling atoms (e.g., to elemental tags that include labelling atoms). The biological sample may further include reference particles distributed on or within the biological sample on the solid support, such that a plurality of the reference particles are individually resolvable.

Aspects of the invention include preparing such a biological sample by providing a sample on a solid support, wherein the sample is a biological sample on a solid support, labelling the biological sample with specific binding partners attached to labelling atoms, and distributing reference particles on or within the biological sample, such that a plurality of the reference particles are individually resolvable. In certain aspects the sample is a biological sample may include one or more target elements, such as labelling atoms as described herein.

Aspects of the invention include the use of a reference particle, or a composition of reference particles, as a standard in imaging mass spectrometry to correct for instrument sensitivity drift during the imaging of a sample. In certain aspects the sample is a biological sample may include one or more target elements, such as labelling atoms as described herein.

The methods and uses described above may include additional elements, as described below.

The element standard may be deposited on or in a sample or a portion thereof. Alternatively, or in addition, the element standard may be at a position on the sample carrier distinct from a sample, or distinct from where a sample is to be placed.

In another example, elemental standard particles detected within temporal proximity of a portion of the sample, such as within 6 hours, 3 hours, 1 hour, 30 minutes, 10 minutes, 1 minute, 30 second, 10 seconds, 1 second, 500 us, 100 us, 50 us or 10 us, or within a certain number of laser or ion beam pulses (such as within 1000 pulses, 500 pulses, 100 pulses, or 50 pulses) from the detection of target elemental ions may be used to for normalization or calibration.

Target elements, such as labelling atoms, can be normalized within a sample run based on elemental ions detected from individual reference particles. For example, the subject methods may include switching between detecting elemental ions from individual reference particles and detecting only target elemental ions.

Target elemental ions may be detected as an intensity value, such as the area under an ion peak or the number of ion events (pulses) within the same mass channel. In certain embodiments, detected target elemental ions may be normalized to elemental ions detected from individual reference particles. In certain embodiments, target elemental ions in different locations are normalized to different reference particles during the same sample run.

Normalization may include quantification of target elemental ions. In embodiments where the reference particle has a known quantity of one or more elements or isotopes (e.g., with a certain degree of certainty, as described above), the signal detected from elemental ions from the reference particle can be used to quantify target elemental ions.

Normalization to reference particles during a sample run may compensate for instrument sensitivity drift, in which the same number of target elements at different locations may be detected differently. Depending on the system and application, instrument sensitivity drift can be caused by a number of factors including ion optics drift, surface charging, detector drift (e.g., aging), temperature and gas flows drifts affecting diffusion, and electronics behaviour.

Aspects of the invention include an element film, or multiple element films, that may be applied to or present on a support, such as a sample carrier, as an element standard. The element film may be an adhesive element film and or a polymer film. For example, the element film may be a thin layer polymer film (e.g., encoded with a combination of elements or isotopes such as Y, In, Ce, Eu, Lu) on a polyester sticker. In certain embodiments, the element film may comprise a polymer (e.g., plastic) layer that can be mounted on a support. The support may be a sample slide, as described herein. In other embodiments, the element film may be pre-printed on a sample slide. As discussed herein, the sample slide may have one or more regions for binding cells and/or free analyte in a sample.

In certain aspects, the polymer film may be a polyester plastic film. The polymer may be a long chain polymer that, when mixed with a metal solution and volatile solvent, may create a film entrapping the metal after the solvent is evaporated. For example, the polymer film may be a poly(methyl methacrylate) polymer, and the solvent may be toluene. The polymer may be spin coated to allow for even distribution.

The element film may comprise at least 1, 2, 3, 4, 5, 10, or 20 different elements. The element film may comprise at least 1, 2, 3, 4, 5, 10, 20, 30, 40, or 50 different elemental isotopes. The elements or elemental isotopes may include metals, such as lanthanides and/or transition elements. Some or all of the elemental isotopes may have masses of 60 amu or higher, 70 amu or higher, 80 amu or higher, 90 amu or higher, or 100 amu or higher. In certain embodiments, the element film may comprise elements, elemental isotopes, or elemental isotope masses identical to one or more labelling atoms. For example, the element film may comprise mass tags identical to those used to tag sample on the same support. The element film may comprise elemental atoms bound to a polymer (either covalently or by chelation), or may comprise elemental atoms (either free, in clusters, or chelated) bound directly to the film. The element film may comprise an even coating of the elements or elemental isotopes across its surface, although individual isotopes may be present at the same or different amounts. Alternatively, different amounts of the same isotope may be patterned with a known distribution across the surface of the film. The element film may be at least 0.01, 0.1, 1, 10, or 100 square millimeters.

In certain aspects, the element film may be applied to a sample slide after tagging with mass tags (and potentially after washing of unbound mass tags). This may reduce cross contamination of sample from the element film. For example, use of the element film may result in less than 50%, 25%, 10%, or 5% increase in background during sample acquisition. The background may be the signal intensity of one or more (e.g., the majority of) the masses of isotopes present in the element film.

In certain aspects, the average number (or mean intensities) of each elemental isotope (or the majority of elemental isotopes) across the element film may have a coefficient of variation (CV) of less than 20%, less than 15%, less than 10%, or less than 5% or 2%. For example, the CV may be less than 6%. The CV may be measured across at least 2, 5, 10, 20, or 40 regions of interest, where each region is at least 100, 500, 1,000, 5,000, or 10,000 square micrometers. Similarly, the CV of the average number (or mean intensities) of each elemental isotope (or the majority of elemental isotopes) between element films may be less than 20%, 15%, 10%, 5%, or 2%.

The element film may be used for tuning, signal normalization and/or quantitation of labeling atoms (e.g., within a sample run and/or between sample runs). For example, the element film may be used throughout a long sample run (e.g., of more then 1, 2, 4, 12, 24, or 48 hours).

In certain aspects, the adhesive element film may be used to tune the apparatus before sample acquisition, between acquiring sample from different regions (or at different times) on a single solid support, or both. During tuning, the adhesive element film may be subjected to laser ablation, and the resulting ablation plume (e.g., transient) may be transferred to a mass detector as described herein. The spatial resolution, transients cross talk, and/or signal intensity (e.g., number of ion counts over one or more pushes, such as across all pushes in a given transient) may then be read out. One or more parameters may be adjusted based on the readout. Such parameters may include gas flow (e.g., sheath, carrier, and/or makeup gas flow), voltage (e.g., voltage applied to an amplifier or ion detector), and/or optical parameters (e.g., ablation frequency, ablation energy, ablation distance, etc.). For example, the voltage applied to an ion detector may be adjusted such that the signal intensity returns to an expected value (e.g., pre-set value or value obtained from an earlier signal intensity obtained from the same, or similar, adhesive element film).

In certain aspects, the adhesive element film may be used to normalize signal intensity from labeling atoms detected between samples on different solids supports, from labeling atoms detected between regions (or at different times) from a sample on a single solid support, or both. Normalization is performed after sample acquisition, and allows for comparison of signal intensities obtained from different samples, regions, times or operating conditions. Signal intensities (e.g., ion count) acquired from a given elemental isotope (e.g., associated with a mass tag) of a sample or region thereof may be normalized to the signal intensity of the same (or similar) elemental isotope(s) acquired from element film in close spatial or temporal proximity. For example, element film within spatial proximity, such as within 100 um, 50 um, 25 um, 10 um or 5 um of the detected target elemental ions may be used for normalization. In another example, element film detected within temporal proximity such as within 1 minute, 30 second, 10 seconds, 1 second, 500 us, 100 us, 50 us or 10 us, or within a certain number of laser or ion beam pulses (such as within 1000 pulses, 500 pulses, 100 pulses, or 50 pulses) from the detection of target elemental ions may be used to for normalization.

Normalization may include quantification of target elemental ions (e.g., ionized elemental isotopes). In embodiments where the element film has a known quantity of one or more elements or isotopes (e.g., with a certain degree of certainty, as described above), the signal detected from elemental ions from the element film can be used to quantify target elemental ions.

Normalization to element film during a sample run may compensate for instrument sensitivity drift, in which the same number of target elements at different locations may be detected differently. Depending on the system and application, instrument sensitivity drift can be caused by a number of factors including ion optics drift, surface charging, detector drift (e.g., aging), temperature and gas flows drifts affecting diffusion, and electronics behavior (e.g., plasma power, ion optics voltages, etc). Alternatively or in addition to normalization, parameters affecting the above instrument sensitivity drift factors may be adjusted based on the signal acquired from the element film.

As described below, an elemental (e.g., elemental isotope) standard may be used to generate a standard curve to quantify the amount of mass tags (e.g., number of labeling atoms) or the number of an analyte bound by a given mass tag. Multiple element films (or multiple regions of a single element film) with different known amounts of an element or elemental isotope may be used to generate such a standard curve.

In certain embodiments, the elemental film may be a metal-containing standard on an adhesive tape. This tape can be applied to a stained tissue slide when long image acquisition. These long acquisitions can benefit from periodic sampling to acquire data for active surveillance of instrument performance. This further enables standardization and/or normalization for longitudinal studies.

In certain aspects, an array of tissue sections may be prepared (e.g., by array tomography) and ordered on a single slide alongside an element standard, allowing for IMC signal normalization across a long sample run (across multiple sections on the same slide).

Reference Particles

As described herein, reference particles of known elemental or isotopic composition may be added to the sample (or the sample carrier) for use as a reference during detection of target elemental ions in the sample. In certain embodiments, reference particles comprise metal elements or isotopes, such as transition metals or lanthanides. For example, reference particles may comprise elements or isotopes of mass greater than 60 amu, greater than 80 amu, greater than 100 amu, or greater than 120 amu.

Target elements, such as labelling atoms, can be normalized within a sample run based on elemental ions detected from individual reference particles. For example, the subject methods may include switching between detecting elemental ions from individual reference particles and detecting only target elemental ions.

Pre-Analysis Sample Expansion Using Hydrogels

Conventional light microscopy is limited to approximately half the wavelength of the source of illumination, with a minimum possible resolution of about 200 nm. Expansion microscopy is a method of sample preparation (in particular for biological samples) that uses polymer networks to physically expand the sample and so increase the resolution of optical visualisation of a sample to around 20 nm (WO2015127183). The expansion procedures can be used to prepare samples for imaging mass spectrometry and imaging mass cytometry. By this process, a 1 μm ablation spot diameter would provide a resolution of 1 μm on an unexpanded sample, but with this 1 pm ablation spot represents ˜100 nm resolution following expansion.

Expansion microscopy of biological samples generally comprises the steps of: fixation, preparation for anchoring, gelation, mechanical homogenization, and expansion.

Sample Preparation for High Resolution Imaging

Aspects of the application may include a sample, preparation of a sample, and or analysis of a sample as described herein. Also contemplated are kits comprising any combination of reagents used for sample preparation and/or analysis. For example, kits may include resin embedding reagents and/or array tomography equipment, in addition to mass tagged SBPs.

In certain aspects, a tissue sample may be embedded with a polymer resin (e.g., a “hard” polymer resin). Compared to FFPE (formalin fixed paraffin embedded) samples and other soft embedding sample preparations, embedding in a hard polymer resin allows for thinner sectioning, which has a number of benefits described herein.

The polymer resin may be an epoxy resin. However, epoxy resins may be less suitable for labelling with SBPs, as target epitopes may be damaged. Epoxy forms covalent bonds with biological materials such as proteins, which reduce exposure of epitopes. That said, epoxy preserves of structural details of the sample, that are stable to EM imaging. Ultrathin sectioning may allow for exposure of epitopes for binding by mass tagged SBPs. Epoxy may be cured at high temperatures (e.g., above 50 degrees Celsius), and may be deplasticized with reagents such as sodium ethoxide, which may damage SBP targets. In certain aspects, an epoxy resin may be a Spurr resin or an Araldite resin (a modified epoxy).

The polymer resin may be an acrylic resin, or a derivative thereof. Acrylic resins are less common than epoxy resins, but offer a number of advantages for IMC. In acrylic resin embedding, free radicals react with double bonds of the acrylic monomer, and a new radical, which is one monomer larger, is produced. Monomers will continue to be added in this way and the polymer grows larger until its growth is terminated. The free radicals may have little or no affinity for proteins and nucleic acids, and therefore biomolecules of interest may not incorporated into the polymer network, allowing SBPs to bind to their targets.

An acrylic resin may be a polyhydroxy-aromatic acrylic resin, such as LR White or LR Gold, which has low viscosity and is well suited for immunostaining. However, LR White is resistant to de-plasticization by an organic solvent, and thermal curing at high temperature may be required, either or both of which may reduce SBP binding to targets. Further, low SBP (e.g., antibody) penetration may result in need for ultrathin (e.g., less than 200 nm thick) sections.

An acrylic resin may be a lowicryl (low viscosity at low temperature) resin. Such resins may have highly cross-linked acrylate and methacrylate based media, low viscosity at low temperature and may have a low freezing point (e.g., less than minus 60 degrees Celsius, such as minus 80 degrees Celsius).

An acrylic resin may be a Methyl methacrylate (MMA) resin, such as Butyl-methylmethacrylate (BMMA). BMMA is versatile polymer with variable hardness, such that it may be used for a variety of imaging modalities. BMMA may be cured at low temperatures under UV light. It is soluble in ethanol and acetone, allowing for gentle deplaticization that leaves more SBP targets (e.g., epitopes) intact. BMMA embedded resin may be sectioned at ultrathin and/or thick sections. For example, an ultrathin section may be at or less than 250 nm, 200 nm, 150 nm, 100 nm, or 50 nm in thickness. A thick section may be at or more than 300 nm, 400 nm, 500 nm, 1 um, or 2 um in thickness. In certain aspects, the BMMA section may be less than 100 nm, 150 nm, 200 nm, 300 nm, 400 nm, 500 nm, 1 um, or 2 um in thickness.

BMMA resin embedding may be compatible with histological stains such as H&E (hematoxylin and eosin) stains, immunostains (e.g., with SBPs such as antibodies), in situ hybridization, non-linear microscopy such as second Harmonic generation (SHG) microscopy, fluorescent microscopy such as confocal microscopy, IMS such as Direct ionisation (described herein) or MALDI, IMC by direct ionisation or another means described herein, and/or electron microscopy such as SEM and TEM. Certain SBPs such as antibodies penetrates the semi-thin BMMA sections and may be stripped from them, allowing for iterative microscopy (such as iterative fluorescence microscopy). As such, BMMA embedding may be combined with one or more of the above imaging modalities. BMMA is harder than paraffin, and may provide cleaner thick sections for tomography. In certain aspects, a thick BMMA section may be immunostained (e.g., after deplasticization), and coregistered with an imaging modality of a thinner BMMA section. BMMA sections (e.g., after deplastization) may be compatible with mass tagged SBPs.

In certain aspects, BMMA serial-sections may be cured by exposure to UV, de-plasticized using acetone, re-hydrated by immersion in 50-95% ethanol, washed in buffer, exposed to antigen retrieval (e.g., by heating and/or acidification), and/or immuostained (e.g., with mass and/or fluorescent tagged SBPs).

As described herein, embedding may be with an acrylic polymer resin comprises LR White, a lowicryl, or a methyl methacrylate. In certain aspects, the resin, such as a lowicryl or MMA resin, may be cured (photopolymerized) by UV light, which may leave more SBP targets (e.g., epitopes) intact compared to high temperature curing. In certain aspects, the tissue may be was fixed in paraformaldehyde prior to embedding. Methods may include deplasticizing one or more of the tissue sections prior to labeling with the plurality of mass tagged SBPs.

Serial Sections and Resampling

In certain aspects, serial sections of tissue may be analysed by imaging mass cytometry. Serial sections may be identically stained or stained for different markers. For example, a first serial section may be stained for protein markers (or predominantly protein markers) while a second serial section may be stained for RNA markers (or predominantly RNA markers). This is especially useful when the sample preparation for one set of markers (such as antigen retrieval for protein markers) may damage or impair the ability to detect another set of markers (such as RNA markers).

A plurality of serial sections may be stained with different sets of SBPs that comprise the same or overlapping mass tags, thus increasing the number of SBPs detected in a sample (e.g., to more than the number of distinct mass tags used). Alternatively, serial sections may be stained with the same or overlapping set of SBPs that comprise the same or overlapping mass tags, thus allowing for detection of identical targets across sections. Markers present on features shared across serial sections may be integrated or otherwise combined for analysis. For example, the same marker (e.g., bound by the same SBP) detected in a feature, such as a cell, across subsequent sections may be added together to determine expression in that feature. This may provide higher sensitivity, and may be particularly useful for detecting and/or determining the abundance of low expressing markers. Features such as cells may be larger than a single section, or may be split across sections. Various methods allow for thin sections to be cut on the micron scale. Dehydration of the section during sample prep combined with the depth of laser ablation can allow for the majority of a sections thickness to be ablated. In cases where the section is significantly thicker than the depth of laser ablation, resampling at a location can allow for more material from a feature to be analysed. Lasers with a short intense pulse, such as fs lasers, may more cleanly sample from a sample (e.g., with little heat dissipation beyond the site of ablation), better enabling resampling. As described above, resampling and/or analysis of multiple serial sections may allow for higher sensitivity. In addition, resampling and/or analysis of multiple serial sections may allow reconstruction of a 3D mass cytometry image.

In certain aspects, identification of features may be done during an optical interrogation, and the laser may be scanned along optically identified features of interest. Alternatively, features may be identified from a pixel-by-pixel mass cytometry image, such as an array of pixels on the scale of a micron (e.g., 0.5 to 2 microns in diameter). Pixels relating to a feature may be identified at the analysis stage, and the signal from markers in that feature may be integrated. Laser scanning along a feature, grouping of pixels (obtained by translation of a stage and/or laser scanning) into a feature, resampling at a location, and/or integration of features across serial sections, may in any combination improve sensitivity of markers associated with a feature. When laser scanning is applied, it may allow for significant time saving, which becomes even more valuable when analysing serial sections.

IMC provides inherent advantage over immunohistochemistry imaging or immune fluorescent microscopy in that the signals from metal label have little or no overlap, enabling imaging for 40 or more proteins (and/or other markers) simultaneously, from one tissue section. In some cases, IMC may have lower sensitivity than other methods. In some cases, a fast (e.g., fs) laser may allow for resampling and “drilling” into a thicker tissue section.

Interrogating features such as cells by IMC may result in low detection power of low abundance markers that may be distributed evenly (e.g., throughout the cytoplasm), and their abundance in a fraction of a cell may be lower than in a whole cell. Moreover, some markers can be under-represented in a particular fraction of a cell, as some markers can be present in particular cellular compartments. For example, nucleus of a cell (detectable, for example, by iridium nucleic acid intercalator), can be fully present, fully absent, or present in its fraction, in a particular tissue section. As a result, it can be either fully detectable with good signal to noise ratio, partially detectable, or not detectable/absent at all. Similarly, protein markers can be detectable, partially detectable or not detectable at all, depending on their presence in cell compartments/section. Even for markers above a detection threshold, a higher sensitivity may improve or allow qualitative or quantitative assessment of the abundance of the marker.

As described herein, a method or system may measure of major markers present at high abundance in cells, measurement being performed in sequential tissue sections. Then major marker signals may be used for identifying objects/segmenting cell-like objects representing particular cells in each cross-section, or developing typical phenotypes of cells present in each tissue section. Then, markers signature or cell phenotype may be linked to XY coordinates of each identified object. Then the object of similar major marker signature/phenotype with close XY coordinates are linked to each other as pieces of the same cell sectioned during microtoming. Once the objects in the sequential sections are identified as representing the same cell, signals for all markers are integrated (e.g., summed) between sequential tissue sections, effectively producing a “volume integral” of marker signals. This improves signal and signal to noise ratio, as the sum of the marker signals can potentially scale with the number of summed sections, while background signal would be proportional to a square root of the number of summed sections.

More-over, in cases when a particular cell compartment (or marker in a compartment) is not present in one tissue section, it can be present in a previous or next section of the same tissue block. Thus, detection of some markers can be improved many-fold, or even enabled. Multiple methods of recognition of major marker signatures as belonging to the same cell are available, including known in the field method of image segmentation (for example, watershed method). While the above example is provided for cells, this approach could be used for any feature described herein. Features at similar XY coordinates having similar characteristics such as shape and/or marker expression, and/or having a similar surrounding set of features, can be recognized as belonging to the same cell feature (e.g., cell) after such segmentation.

Sectioning by Array Tomography

In certain aspects, serial sections of embedded tissue samples may be arrayed (e.g., on a single slide), in a process called array tomography. Such sections may be compatible with an array of imaging modalities described herein, including forms of fluorescence microscopy, electron microscopy, and/or imaging mass cytometry. In certain aspects, individual sections may be imaged by non-destructive means such as fluorescence and/or electron microscopy, before imaging by IMC.

Hard resins, such as the BMMA sample resin described herein, may be embedded upstream of Array Tomography for 3D IMC, e.g., in which serial sections are imaged by IMC and computationally stacked. Array tomography may provide ultrathin sections for Super Resolution IMC with a spot size (pixel size) less than 500 nm, less than 400 nm, less than 300 nm, or less than 200 nm.

Computational stitching of the resulting two-dimensional image tiles allows for volumetric analysis (e.g., across features or regions of interest). Multiple imaging modalities may be coregistered. Sections may be labelled with a plurality of distinguably tagged SBPs. Sections may be ultrathin, allowing for high resolution imaging. Ultrathin sections that also allow for depth invariance due to homogenous SBP penetration. This benefit may improve quantitation. In certain aspects, IMC may be performed on thick sections and higher resolution imaging may be performed on thinner sections from the same tissue (e.g., same embedded tissue block). Sections analysed by IMC may have residual resin (e.g., post deplasticization).

As embedding and sectioning is time and skill intensive, may include use of toxic reagents, and expensive equipment (such as diamond knife sectioning tools), such approaches may not be used for IMC analysis unless the above benefits are recognized.

Additional Imaging Modalities

In certain aspects, a sample prepared as described herein may be analysed by direct ionization imaging mass cytometry, or by another form of imaging mass cytometry described below. In addition, the sample (e.g., the same section(s) or separate sections of a sample) may be analysed by non-IMC imaging modalities described below.

One method may include a method of coregistering images, including obtaining a first image from a first tissue section of a tissue sample by an imaging modality other than imaging mass cytometry, obtaining a second image of a second tissue section of the tissue sample by imaging mass cytometry, and coregistering the first and second images. In certain aspects, the first image, or both the first and second images, may be provided by a third party. Imaging mass cytometry may be performed by LA-ICP-MS or by direct ionization, optionally with a femtosecond laser and/or laser scanning system.

Aspects of the invention include a method of coregistering images, including obtaining a first image from a first tissue section of a tissue sample by an imaging modality other than imaging mass cytometry, obtaining a second image of a second tissue section of the tissue sample by imaging mass cytometry, and coregistering the first and second images. In certain aspects, the first image, or both the first and second images, may be provided by a third party.

In some cases, an imaging mass cytometer may be equipped to image in additional modalities, including but not limited to light microscopy, such as brightfield and/or , fluorescence microscopy, and/or non-linear microscopy. For example, the imaging mass cytometer may stack optics for laser ablation and light microscopy. A histochemical stain may be imaged by light microscopy to identify a region of interest (ROI) for analysis by imaging mass cytometry. Alternatively or in addition, light microscopy may be used to coregister an image obtained by imaging mass cytometry from a first tissue section with an image obtained from a second tissue section (e.g., serial section) by another modality (e.g., by another system) as described herein. When a high speed (e.g., femtosecond) laser is used, non-linear microscopy may be performed at one or more harmonics, thereby imaging structural aspects of the sample. When an antibody is tagged with both labelling atom(s) and fluorophore label, analysis of the distribution of the fluorophore label may be non-destructive to the sample, and may be followed by IMC analysis of the labeling atom(s). In certain aspects, the fluorophore label may be a fluorescent barcode cleaved (e.g., photocleaved) from a region of interest and analysed after aspiration.

One or more tissue sections may be analysed by imaging mass cytometry and one or more additional imaging modalities, and co-registered based on fiducials (such as a coordinate system) present on slide(s) holding the tissue section(s). Alternatively or in addition, co-registration can be performed by aligning features (e.g., structures or patterns) present on two sections from the same tissue. The features may be identified by the same or different imaging modalities. Even when identified by the same imaging modality, the features or their x,y coordinates may be used to coregister different imaging modalities.

In certain aspects, an additional imaging modality is MALDI mass spectrometry imaging. The sample preparation of a tissue section for MALDI imaging may be incompatible with preparation for imaging mass cytometry. As such, MALDI imaging of a first section may be co-registered with imaging mass cytometry of a second section (e.g, serial section) from the same tissue. Laser desorption ionization in MALDI imaging provides a molecular ions that are detected by mass spectrometry. A MALDI image of a sample may identify distribution of an analyte (e.g, a drug, such as a cancer drug, potential cancer drug, or metabolite thereof) in a tissue section or subregion thereof comprising a tumor and/or healthy tissue. When the analyte is a drug, it may be administered to a subject (e.g., human patient or animal model) from which a tissue sample is collected for analysis as described herein. An otherwise identical analyte may be isotopically labelled, such as with a non naturally abundant isotope (e.g., of H, C, or N) and applied to the tissue along with the matrix to identify and expected peak in the mass spectrum relating to the original analyte. Alternatively or in addition to imaging distribution of an analyte, the MALDI image may provide a distribution of endogenous biomolecules (or molecular ions thereof). MALDI imaging may be coregistered with an IMC image through a shared or similar histochemical stain (such as cresyl violet, Ponceau S, bromophenol blue, Ruthenium Red, Trichrome stain, osmium tetroxide, and so forth). In certain aspects, labelling atoms of a sample analysed by MALDI imaging may survive the procedure, allowing for analysis of IMC. However, MALDI sample prep may complicate sample prep for IMC imaging, in which case the MALDI and IMC images may be obtained from different tissue sections.

Co-registration of a MALDI image with a mass cytometry image may provide additional insight into the portion of the tissue retaining the drug and/or the effect of the drug on the tissue. For example, metal containing histochemical stains, viability reagents and/or cell state indicators may identify whether or not a drug is targeted to at least one of connective tissue (e.g, stroma, extracellular matrix or macromolecules such as collagen or glycoproteins, fibrous proteins such as actin, keratin, tubulin), cells or a subregion of a cell (e.g., cell membrane, cytoplasm and/or nucleus), proliferating cells, live or dead cells, hypoxic cells or regions, necrotic regions, tumor cells or regions having a tumor signature (e.g., combination of surface markers and/or cell state markers characteristic of a tumor), and/or healthy tissue. In some cases, the effect of a drug can be inferred by the combination of the drug distribution (e.g., identified by MALDI imaging) and state of the tissue at or around the drug (e.g., identified by imaging mass cytometry). For example, the number, position, cell activity surface markers, intracellular signalling markers, cell type markers of tumor cells or tumor infiltrating immune cells may be used to identify the effect of the drug and/or identify additional drug targets (such as a receptor up or down regulated in a tumor cell or tumor infiltrating immune cell in response to the drug). Tumor infiltrating immune cells may include one or more of dendritic cells, lymphocytes (such as B cells, T cells and/or NK cells), or subsets of immune cells such as CD4+, CD8+, and/or CD4+CD25+ T cells. In some cases, imaging mass cytometry may identify a plurality of immune cell types in a tumor microenvironment, and may further identify cell state (e.g., intracellular signalling and/or expression of receptors involved in activation or suppression of an immune response). An area of drug distribution imaged by MALDI may identify a ROI for imaging mass cytometry analysis and/or be co-registered with a mass cytometry image. In certain aspects, coregistering a IMC image with a non-IMC image provides distribution of a plurality (e.g. at least 5 10, 20, or 30) different targets (e.g., or their associated labelling atoms) at cellular or subcellular resolution. The IMC image may be obtained through LA-ICP-MS, and optionally through use of a femtosecond laser and/or laser scanning system as described herein.

Coregistration may include mapping (e.g., aligning) two images (obtained by different imaging modalities) to one another (e.g., to a shared coordinate system). Two coregistered images (or aspects of each image) may be superimposed or combined to present higher level features such as coexpresison of two targets detected by two different imaging modalities. In certain aspects, coregistration may only be at a region of interest.

IMC may be coregistered with one or more non-IMC imaging modalities, such as one or more of fluorescence microscopy such as iterative fluorescence microscopy, high resolution microscopy such as confocal microscopy or direct stochastic optical reconstruction microscopy (dSTORM), non-linear microscopy such as second harmonic generation microscopy, brightfield microscopy such as of an H&E stain, IMS imaging such as MALDI imaging, and electron microscopy such as SEM or TEM. Alternatively or in addition, analysis may be by elemental imaging, such as by X-ray fluorescence, particle induced x-ray emission, x-ray photoelectron spectroscopy, and Auger electron spectroscopy which probes the inner electronic structure of atoms.

An imaging mass cytometry system integrating nonlinear microscopy may provide one or more of two-photon fluorescence, second harmonic generation (SHG), three-photon fluorescence (3PF), third harmonic generation (THG), and or coherent anti-Stokes Raman scattering (CARS). In certain aspects, the sample may be prepared for imaging by one or more forms of nonlinear microscopy, such as by a contrast agent or by a fluorophore tagged SBP. The sample may further be prepared with mass tagged SBPs.

In second harmonic generation (SHG), the signal is generated most strongly in collagen-containing tissues, where the signal has been shown to give rich information on the type of collagen in the laser focal spot as well as its 3-dimensional orientation. Such information cannot be obtained through other microscopy techniques. In third harmonic generation, the signal is uniquely generated in samples in the presence of interfaces between dissimilar materials. For example, this signal is generated at cell membranes, meaning it can be used to improve the accuracy of cell segmentation. In two-photon excitation fluorescence, the signal behaves very similarly to ‘normal’ fluorescence, except that the signal-to-noise ratio of the resulting images is generally much better due to no signal being generated outside of the laser focus. In Stimulated Raman Scattering or Coherent anti-Stokes Raman Scattering (SRS, CARS), signals are generated by concentrations of specific chemicals (inherent or introduced) with optically active vibrational bonds that resonate at particular frequencies. As an example, recent research has shown 30-plex SRS imaging of a series of engineered chemicals. Another strong application of this signal is in the detection of high lipid concentrations, such as in the cell wall or lipid droplets inside cells.

A plurality of different nonlinear microscopy signals could be detected, such as three signals detected by the three integrating detectors. These signals could include, for example, second harmonic generation, third harmonic generation, and/or two-photon excitation fluorescence. If Stimulated Raman Scattering (SRS) or CARS are to be added to the setup, the laser source will need modification as well, since two coherent, synchronized laser beams with a well-defined wavelength difference between them are used to generate the SRS or CARS signal. As such, an imaging mass cytometry system integrating SRS or CARS may include a laser source providing two coherent laser beams at a defined difference in wavelength. Specifically, the laser source may generate a secondary pulse, coherent and copropagating with the primary pulse, and with a specific wavelength shift compared to the primary pulse. In CARS, the laser source can be tuned to the chemical transition frequency of a particular target (e.g., class of molecules). An imaging mass cytometer integrating CARS microscopy include a notch filter.

As described herein, one or more non-IMC imaging modalities may be coregistered with IMC imaging. As such, systems within the scope of the subject application may include devices for IMC or IMS (such as for direct ionisation) in addition to devices for other non-IMC (or non-IMS) imaging modalities.

Alternative IMC Imaging Modalities

In certain aspects, the sample may be imaged by an IMC modality other than direct ionisation (e.g., as an alternative or in addition to direct ionisation). One or more IMC imaging modalities may be applied to an arrayed tissue sections in addition to one or more non-IMC imaging modalities.

When laser radiation is used (e.g., for direct ionization or for sampling by laser ablation), a component which can rapidly direct laser radiation to different locations on the sample can be used as a positioner in the laser scanning system. The various types of positioner discussed below are commercially available, and can be selected by the skilled person as appropriate for the particular application for which an apparatus is to be used, as each has inherent strengths and limitations. In some embodiments of the invention, as set out below, multiple of the positioners discussed below can be combined in a single laser scanning system. Positioners can be grouped generally into those that rely on moving components to introduce relative movements into the laser beam (examples of which include galvanometer mirror, piezoelectric mirror, MEMS mirror, polygon scanner etc.) and those that do not (examples of which include such acousto-optic devices and electro-optic devices). The types of positioners listed in the previous sentence act to controllably deflect the beam of laser radiation to various angles, which results in a translation of the ablation spot. The laser scanning system may comprise a single positioner, or may comprise a positioner and a second positioner. The description of “positioner” and “second positioner” where two positioners are present in the laser scanning system does not define an order in which a pulse of laser radiation hits the positioners on its path from the laser source to the sample.

As described herein, the laser may be a fs laser. For example, a fs laser in the near-IR range may be operated at the 2nd harmonic to provide laser radiation in the green range, or at the 3rd harmonic to provide laser radiation in the UV range. A lower wavelength such as a green or UV may allow for higher resolution (e.g., smaller spot size). When the laser radiation travels across a sample support to impinge on the sample, the sample support needs to be transparent to the laser radiation. Glass and silica are transparent to green wavelength, which silica but not glass are transparent to UV. To enable high resolution while allowing for use of a glass slide, an IR fs laser may be operated at the 2nd harmonic (e.g., around 50% conversion efficiency) to provide green laser radiation. Of note commercially available objectives often have the best correction in the green range. The resolution achieved by a green or UV fs laser may be at a spot size at or less than 500 nm, 400 nm, 300 nm, 200 nm, 150 nm, or 100 nm.

When a laser is used to ablate sample material (as oppose to sampling and ionization), fluidics may allow transport of the ablated sample to an ionisation system.

Laser ablation may be performed in a manner as set out previously, for example in Giesen et al, 2014 and WO2014169394, in light of the modifications related herein (e.g. it is not mandatory to use an ICP to ionize the sample material, nor to use a TOF MS detector). For example, methods and systems for ionization at or near the sample surface, as described herein, may use ion optics to transfer labelling atoms to a mass spectrometry detector (e.g., a TOF detector or magnetic sector detector) directly from the sample, without the need of gas fluidics to deliver sample to an ICP. In some cases, methods and systems may use non-laser forms of radiation (e.g., an electron beam, or ion beam) instead of, or in addition to, a laser.

In embodiments where laser ablation is performed without sustained ionization of the ablated sample, the ablation plume may be transferred to an ICP-MS as described below.

Transfer Conduit

The transfer conduit forms a link between the laser ablation sampling system and the ionisation system, and allows the transportation of plumes of sample material, generated by the laser ablation of the sample, from the laser ablation sampling system to the ionisation system. Part (or all) of the transfer conduit may be formed, for example, by drilling through a suitable material to produce a lumen (e.g., a lumen with a circular, rectangular or other cross-section) for transit of the plume. The transfer conduit sometimes has an inner diameter in the range 0.2 mm to 3 mm. Sometimes, the internal diameter of the transfer conduit can be varied along its length. For example, the transfer conduit may be tapered at an end. A transfer conduit sometimes has a length in the range of 1 centimeter to 100 centimeters. Sometimes the length is no more than 10 centimeters (e.g., 1-10 centimeters), no more than 5 centimeters (e.g., 1-5 centimeters), or no more than 3 cm (e.g., 0.1-3 centimeters). Sometimes the transfer conduit lumen is straight along the entire distance, or nearly the entire distance, from the ablation system to the ionisation system. Other times the transfer conduit lumen is not straight for the entire distance and changes orientation. For example, the transfer conduit may make a gradual 90 degree turn. This configuration allows for the plume generated by ablation of a sample in the laser ablation sampling system to move in a vertical plane initially while the axis at the transfer conduit inlet will be pointing straight up, and move horizontally as it approaches the ionisation system (e.g. an ICP torch which is commonly oriented horizontally to take advantage of convectional cooling). The transfer conduit can be straight for a distance of least 0.1 centimeters, at least 0.5 centimeters or at least 1 centimeter from the inlet aperture though which the plume enters or is formed. In general terms, typically, the transfer conduit is adapted to minimize the time it takes to transfer material from the laser ablation sampling system to the ionisation system.

In some instances, the laser ablation sampling system inlet that receives material from the laser ablation sampling system is an aperture in the wall of a conduit along which a second “transfer” gas is flowed (as disclosed, for example in WO2014146724 and WO2014147260) from a separate transfer flow inlet. In this instance, the transfer gas forms a significant proportion, and in many instances the majority of the gas flow to the ionisation system. The sample chamber of the laser ablation sampling system contains a gas inlet. Flowing gas into the chamber through this inlet creates a flow of gas out of the chamber though the inlet of the transfer conduit. This flow of gas captures plumes of ablated material, and entrains it as it into the transfer conduit (typically the laser ablation sampling system inlet of the transfer conduit is in the shape of a cone, termed herein the sample cone) and out of the sample chamber into the conduit passing above the chamber. This conduit also has gas flowing into it from the separate transfer flow inlet (left hand side of the figure, indicated by the transfer flow arrow). The component comprising the transfer flow inlet, laser ablation sampling system inlet and which begins the transfer conduit which carries the ablated sample material towards the ionisation system can also termed a flow cell (as it is in WO2014146724 and WO2014147260).

Ionisation System

In order to generate elemental ions, it is necessary to use a hard ionisation technique that is capable of vaporising, atomising and ionising the atomised sample.

Inductively Coupled Plasma Torch

Commonly, an inductively coupled plasma is used to ionise the material to be analysed before it is passed to the mass detector for analysis. It is a plasma source in which the energy is supplied by electric currents produced by electromagnetic induction. The inductively coupled plasma is sustained in a torch that consists of three concentric tubes, the innermost tube being known as the injector.

The induction coil that provides the electromagnetic energy that maintains the plasma is located around the output end of the torch. The alternating electromagnetic field reverses polarity many millions of times per second. Argon gas is supplied between the two outermost concentric tubes. Free electrons are introduced through an electrical discharge and are then accelerated in the alternating electromagnetic field whereupon they collide with the argon atoms and ionise them. At steady state, the plasma consists of mostly of argon atoms with a small fraction of free electrons and argon ions.

The ICP can be retained in the torch because the flow of gas between the two outermost tubes keeps the plasma away from the walls of the torch. A second flow of argon introduced between the injector (the central tube) and the intermediate tube keeps the plasma clear of the injector. A third flow of gas is introduced into the injector in the centre of the torch. Samples to be analysed are introduced through the injector into the plasma.

The ICP can comprise an injector with an internal diameter of less than 2 mm and more than 250 μm for introducing material from the sample into the plasma. The diameter of the injector refers to the internal diameter of the injector at the end proximal to the plasma. Extending away from the plasma, the injector may be of a different diameter, for example a wider diameter, wherein the difference in diameter is achieved through a stepped increase in diameter or because the injector is tapered along its length. For instance, the internal diameter of the injector can be between 1.75 mm and 250 pm, such as between 1.5 mm and 300 μm in diameter, between 1.25 mm and 300 μm in diameter, between 1 mm and 300 μm in diameter, between 900 μm and 300 μm in diameter, between 900 μm and 400 μm in diameter, for example around 850 μm in diameter. The use of an injector with an internal diameter less than 2 mm provides significant advantages over injectors with a larger diameter. One advantage of this feature is that the transience of the signal detected in the mass detector when a plume of sample material is introduced into the plasma is reduced with a narrower injector (the plume of sample material being the cloud of particular and vaporous material removed from the sample by the laser ablation sampling system). Accordingly, the time taken to analyse a plume of sample material from its introduction into the ICP for ionisation until the detection of the resulting ions in the mass detector is reduced. This decrease in time taken to analyse a plume of sample material enables more plumes of sample material to be detected in any given time period. Also, an injector with a smaller internal diameter results in the more accurate introduction of sample material into the centre of the induction coupled plasma, where more efficient ionisation occurs (in contrast to a larger diameter injector which could introduce sample material more towards the fringe of the plasma, where ionisation is not as efficient).

ICP torches (Agilent, Varian, Nu Instruments, Spectro, Leeman Labs, PerkinElmer, Thermo Fisher etc.) and injectors (for example from Elemental Scientific and Meinhard) are available.

Other ionisation techniques include electron ionisation involves bombarding a gas-phase sample with a beam of electrons. An electron ionisation chamber includes a source of electrons and an electron trap. A typical source of the beam of electrons is a rhenium or tungsten wire, usually operated at 70 electron volts energy. Electron beam sources for electron ionisation are available from Markes International. The beam of electrons is directed towards the electron trap, and a magnetic field applied parallel to the direction of the electrons travel causes the electrons to travel in a helical path. The gas-phase sample is directed through the electron ionisation chamber and interacts with the beam of electrons to form ions. Electron ionisation is considered a hard method of ionisation since the process typically causes the sample molecules to fragment. Examples of commercially available electron ionisation systems include the Advanced Markus Electron Ionisation Chamber.

In certain aspects, sampling and ionisation may be performed in the same step by electron beam radiation, such as by secondary ion mass spectrometry (SIMS) of mass tagged SBPs.

Ion optics and mass detectors described herein (e.g., for direct ionisation applications) may be used for the laser ablation based methods and systems described above.

In certain aspects, imaging of sections may include IMC, such as super resolution IMC (e.g., at a resolution better than 500 nm ). IMC imaging modalities may include one or more of direct ionisation, LA-ICP-MS, or secondary ion mass spectrometry (SIMS) analysis of mass tagged SBPs. IMC may include laser ablation and optional ionization by ICP. IMC may comprise direct ionization as described herein, such as laser radiation, electron beam radiation, or ion beam radiation to form a plasma at or near the sample surface. In certain aspects, the speed of IMC (e.g., through direct ionization and/or scanning) may allow for imaging of more than 1 cm², 5 cm², 10 cm², 20 cm², or 100 cm² surface area in less than an hour at super resolution described herein, allowing for efficient volumetric analysis when applied to an array of serial tissue sections.

Experimental

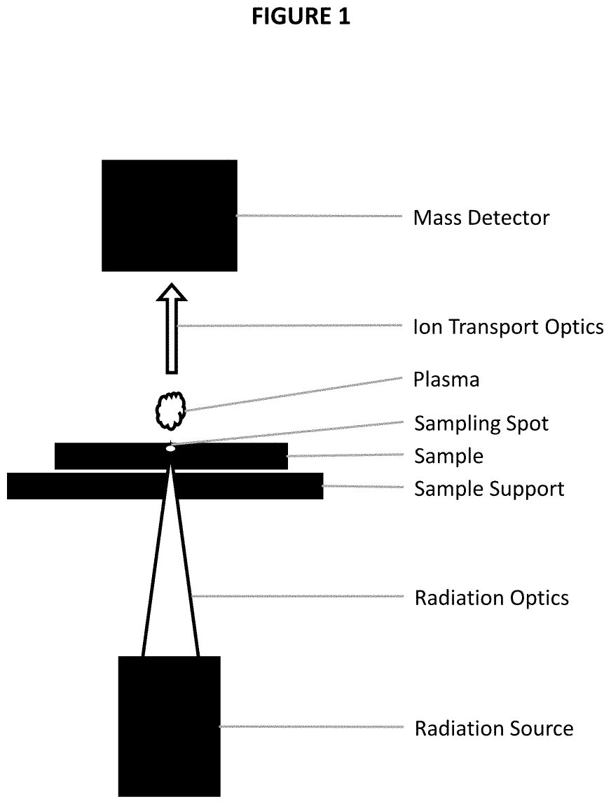

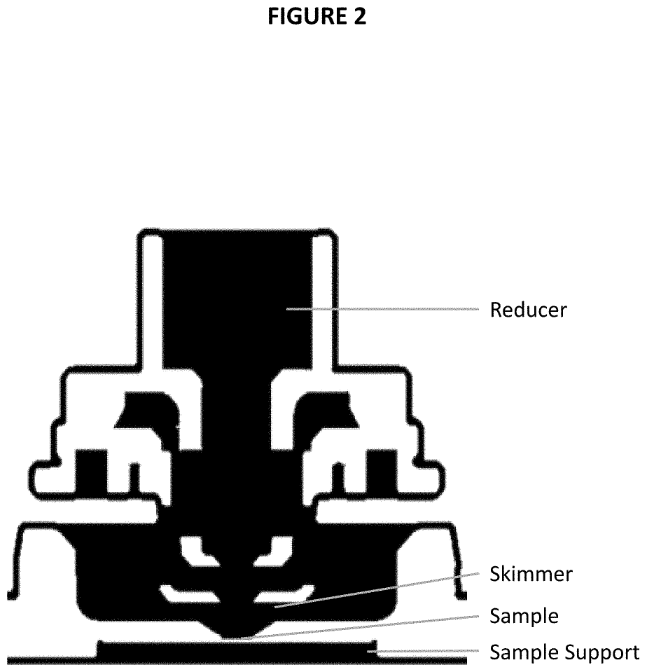

Sampling was performed using a system similar to that shown in FIG. 1, which comprised direct radiation of the sample without a downstream ionization source (such as an ICP). Specifically, a fs laser operated by a galvomirror positioner (galvo driver) and focused by a 1.4 NA immersion objective was used to sample from a PMMA tuning film comprising heavy metal (Eu151/153 and Iu175/176 isotopes). Ion transport was performed under vacuum using the system shown in FIG. 2, comprising a modified skimmer operated at around −30 V and a reducer operated at around −350 V. The sample itself was not grounded.

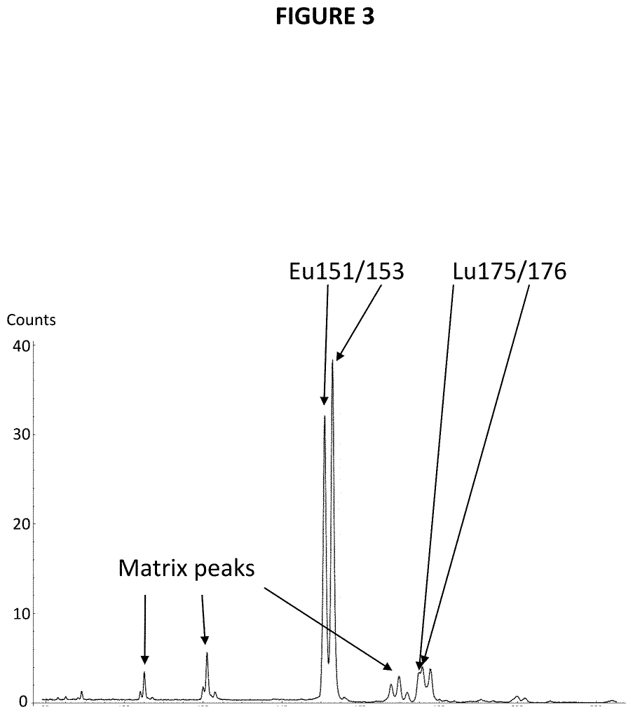

Ions were detected by TOF over around 3 TOF pushes per laser pulse. As shown in FIG. 3, the heavy metal isotopes were detected over the organic molecular fragments from the PMMA matrix.

Biological tissue, specifically an FFPE tonsil section stained with iridium and lanthanide mass tags, was imaged at 0.25 um pixel size and 10 kHz effective shot rate using the system described above. Tissue morphology was imaged by detection of molecular fragments, but Iridium nuclear stain was not detected over molecular fragments. This may be due to quenching by more easily ionized endogenous elements such as Na, low temperature at the site of ablation, and/or neutralization due to ion density post ablation. Parameters discussed herein and below are expected to improve ionization efficiency.

Additional Discussion of Parameter Modifications and Pretreatment

As such, stable ionization of heavy metals, such as lanthanides of mass tags, may be achieve by or more of a smaller sample spot and/or higher laser pulse energy. Thin sections, reduced spot size, and/or pretreatment to remove organic material may further limit the amount of organic material that may quench ionization (e.g., ionization of metal atoms of the mass tags).

For example, a spot size at or less than one of 0.2 um, 0.15 um, 0.1 um, 0.05 um or 0.03 um may be enabled by a lower wavelength laser source (e.g., operating at a high harmonic) providing laser radiation at a wavelength at or less than 200 nm, 100 nm, 50 nm, 30 nm, or 20 nm and optionally a high NA lens at or greater than an NA of 1.5 or 1.8. At small spot sizes (e.g., small scale ablation), autofocusing may be coupled to a piezo Z control of the sample support. Dampening of vibrations may also improve ablation of small spot sizes. In certain aspects, the focal point of radiation may be controlled with an average precision of less than 50 nm, 20 nm, or 10 nm in any direction (e.g., X,Y or X,Y,Z).

The sample itself may be suitable for the subject system and methods. A sample may be an inorganic sample (e.g., geological sample) or an organic sample, such as a biological tissue such as a tissue section. The sample may have mass tags, such as mass tags comprising distinct heavy metal isotopes. For example, an organic sample (e.g., biological molecules and/or a matrix comprising carbon) may comprise heavy metal (e.g., metals or isotopes thereof of greater than 80 amu) such as heavy metals of one or more mass tags. Optionally, an ultrathin tissue (e.g., cut from a resin embedded tissue block) at or less than one of 100 nm, 50 nm, 30 nm, 20 nm, or 10 nm may reduce (or allow for optics that reduce) the size (e.g., diameter, area and/or volume) of the sample spot. In an alternative embodiment, organic material from the sample may be removed prior to sampling (such as through oxidation reaction) and metal containing mass tags may be left on the sample support as a film. The oxidation may take place in a combustion oven (e.g. in GC-IRMS), as described in Z. Muccio and G. P. Jackson, Isotope ratio mass spectrometry, Analyst 134 (2009) 213-222, or it may involve a wet chemical oxidation process (e.g. in LC-IRMS), as described in C. Osburn and G. St-Jean, Limnology and Oceanography: Methods 5 (2007) 296-308. “Dry” oxidation e.g. by UV-ozone, is also routinely used for removal of contaminations on surfaces of semiconductors, glass, etc.

The laser may be operated to provide at or more than one of 1 , 2, 5, 10, 50, 100, or 200 nJ/pulse, such as greater than 1 microjoule per pulse or greater than 100 microjoules per pulse. Ionization rate may be further improved by electron seeding enabled avalanche ionization. For example, the fluence of the laser pulse may be greater than one of 5 nJ/um², 10 nJ/um², 20 nJ/um², 50 nJ/um², 100 nJ/um², 200 nJ/um², or 500 nJ/um² (such as between 50 nJ/um² and 1000 nj/um²). The laser energy may be based on the choice of laser and/or the operation of an attenuator, and fluence may be further based on beam size (e.g., determined by beam expanding and/or focusing optics). As such, the radiation optics may include a pulse picker, attenuator, beam expander and/or focusing optics (such as a high NA lens).

Ion processing and transport may improve detection of heavy metals, such as lanthanides of mass tags. For example, molecular ions may be removed by additional ion optics such as an electrostatic analyzer (ESA) and/or ions outside the mass range may be filtered by quadrupole (such as a RF quadrupole operated as a high-pass filter with a cutoff between 40 and 100 amu).

However, a quadrupole may increase the phase space are of the beam, and a quadrupole and/or ion lenses may increase the path length. A shorter path length to may allow for acquisition of ions from a sample spot in a single TOF push. A shorter path length (e.g., at or less than 20 cm, at or less than 10 cm, at or less than 5 cm, or at or less than 3 cm) to detector, e.g., to the pusher of a TOF detector, may optionally be combined with a TOF blanker that reduces detector exposure to low mass ions (e.g., majority of ions less than 50 amu). In certain aspects, a magnetic sector detector may be used to improve sensitivity.

Ion extraction optics may be positioned proximal to the sample surface to immediately spread ions produced by direct radiation of the sample, thereby reducing neutralization. Ions may be extracted while still in a plasma and accelerated to reduce neutralization due to cooling at high ion density. One or more ion extraction optics, such as a skimmer, may be positioned at or less than 2 mm, at or less than 1 mm, at or less than 0.5 mm, at or less than 0.2 mm, at or less than 0.1 mm, at or less than 50 um, at or less than 20 um, or at or less than 10 um from the sample surface such as the sample spot. One or more ion extraction optics may be operated on the order of tens, hundreds, or thousands of Volts. For example, a skimmer may be operated between -10 and -100 V and/or a reducer may be operated between -100 and -1000 V. Extraction optics may have a skimmer and/or reducer component. In certain aspects, extraction optics may not provide differential pumping.

In certain aspects, the sample holder, and optionally sample support, may be at ground potential. In certain aspects, the sample itself may not be grounded.

In certain aspects, the system or methods herein may provide a non-zero electric field in the ionization region (e.g., at a spot of radiation at the sample surface). For example, the sample support may comprise a conductive substrate (e.g., layer), such as a metal layer (e.g., gold layer) that may retain energy from radiation at the sample spot (e.g., may define an electric field supplied from laser radiation, similar to as is done for in some SIMS applications for ion radiation) and/or better allow mounting of a tissue section. The conductive substrate may be transparent to the radiation (e.g., when opposite side radiation is applied), for example may be UV transparent. The conductive substrate may be an electrode, such as a ring counter electrode and/or UV transparent glass electrode. In certain aspects, a DC voltage may be applied to the conductive substrate, such as on the scale of 1 to 1000 V, 1 to 100 V, 10 to 1000 V, more than 1 V, more than 10 V, or more than 100 V. As such, ion extraction optics may include the sample support, or a component thereof. Such optics may be most successful in promoting ionization efficiency when combined with a small spot size as described herein.

In certain aspects, only one push on a TOF detector may be used to detect ions from a given sample spot (e.g., produced from a single pulse of radiation). Alternatively, a plurality of pushes on a TOF detector may be used to detect ions from a given sample spot, such as at or between 2 and 100, 2 and 20, 2 and 10, or 2 and 5 pushes. For example, less than 20, less than 10, or less than 5 pushes may be performed for a given sample spot.
[i] Robichaud et al. (2013) J Am Soc Mass Spectrom 24(5):718-21.
[ii] Klinkert et al. (2014) Int J Mass Spectrom http://dx.doi.org/10.1016/j.ijms.2013.12.012
[iii] Qiu et al. (2011) Nat. Biotechnol. 29:886-91.
[iv] Arce et al. (2013) Scientific Reports 3, article 2266.
[v] Ali et al. (2011) Mach Vis Appl 23:607-21.
[vi] Pound et al. (2012) The Plant Cell 24:1353-61.
[vii] Hodneland et al. (2013) Source Code for Biology and Medicine 8:16.

1. A method of analyzing a sample comprising:
d) directing radiation at a spot on a sample to form a plasma comprising elemental ions,
e) delivering the elemental ions to a mass detector;
f) detecting the elemental ions at the mass detector.

2. The method of claim 1, further comprising an initial step of providing a sample on a solid support.

3. The method of claim 1, wherein the sample is a geological or semiconductor sample.

4. The method of claim 1, wherein sample is a biological sample.

5. The method of claim 4, wherein the sample is a tissue section, such as an EM section.

6. The method of claim 5, wherein the tissue section is 100 nm thick or less.

7. The method of claim 4, wherein the sample is stained with specific binding partners (SBPs) comprising distinct metal tags.

8. The method of claim 7, wherein the SBPs are antibodies.

9. The method of claim 7, further comprises metal containing histochemical stains and/or metal tagged oligonucleotides.

10. The method of claim 2, wherein the solid support comprises an X-Y stage.

11. The method of claim 2, wherein the solid support comprises a slide.

12. The method of claim 1, wherein the radiation is scanned across the sample.

13. The method of claim 12, wherein the radiation is laser radiation scanned across the sample by a positioner.

14. The method of claim 13, wherein the positioner is a galvanometer mirror, piezoelectric mirror, MEMS mirror, polygon scanner, acousto-optic device or an electro-optic device.

15. The method of claim 1, wherein the radiation is directed from a different angle than the direction of the mass detector in the relation to the sample.

16. The method of claim 15, wherein the radiation is directed from the opposite side of the sample from the side of delivery to the mass detector.

17. The method of claim 1, wherein the radiation is a laser.

18. The method of claim 17, wherein the laser has a pulse duration between 10 fs and 10 ps.

19. The method of claim 17, wherein the laser has a pulse duration less than 10 ps.

20. The method of claim 17, wherein the laser is a high harmonic generation laser.

21. The method of claim 17, wherein the laser is focused by an immersion lens.

22. The method of claim 21, wherein the laser is focused by a liquid or solid immersion lens.

23. The method of claim 17, wherein the laser is from a femtosecond laser or picosecond laser.

24. The method of claim 17, wherein the laser has a wavelength of less than 500 nm.

25. The method of claim 17, wherein the laser is a UV laser or EUV laser.

26. The method of claim 17 or 18, wherein the laser has a pulse energy between 10 pj and 10 uJ.

27. The method of claim 17, wherein the laser has a pulse energy of less than 1 nj.

28. The method of claim 27, wherein the laser has a pulse energy of less than 100 pj.

29. The method of claim 1, wherein the radiation is a beam of charged particles.

30. The method of claim 29, wherein the charged particle beam is an electron beam.

31. The method of claim 30, wherein the electron beam comprises electrons with an energy of between 100 eV, and 10 keV.

32. The method of claim 30 or 31, wherein the number of electrons used to create the plasma is at or between 1000 and 50000 electrons

33. The method of claim 1, wherein the radiation is a pulse of radiation of a duration less than the time of plasma formation

34. The method of claim 1, wherein sample spots are analyzed at a frequency between 1 kHz and 10 MHz.

35. The method of claim 1, 18 or 26, wherein the spot size is 300 nm or less.

36. The method of claim 35, wherein the spot size is 100 nm or less.

37. The method of claim 36, wherein the spot size is 50 nm or less.

38. The method of claim 37, wherein the spot size is 30 nm or less.

39. The method of claim 1, wherein the ions are delivered in a vacuum from the point of plasma formation.

40. The method of claim 1, wherein the plasma is not formed in the presence of an injected noble gas, such as Argon or Xenon.

41. The method of claim 1, wherein the plasma is a thermal plasma, having an internal temperature between 3000 and 30000 K.

42. The method of claim 41, wherein the internal temperature is between 5000 and 10000 K.

43. The method of claim 41, wherein the thermal plasma internal temperature is within 3000 to 30000 K past neutralization.

44. The method of claim 1, wherein the plasma is a non-thermal plasma.

45. The method of claim 1, wherein the plasma has a diameter less than 1 um when it passes the point of neutralization.

46. The method of claim 1, wherein the elemental ions from plasma are directly delivered to the mass detector by ion transport optics.

47. The method of claim 1, wherein delivering does not comprise a mass filter.

48. The method of claim 46, wherein the ion transport optics comprises a high pass filter with a cutoff below 80 amu.

49. The method of claim 1, wherein the delivery time of elemental ions from the plasma to the detector is less than 200 us.

50. The method of claim 1, wherein at least 10% of metals released from the sample spot by the radiation are atomized and ionized and delivered to the detector.

51. The method of claim 1, wherein the ionization efficiency of lanthanides is in the plasma is at least 20% and the ionization efficiency of carbon in the plasma is below 5%.

52. The method of claim 1, wherein the plasma has an ionization efficiency of at least 5% post neutralization.

53. The method of claim 1, wherein the detector is a magnetic sector detector.

54. The method of claim 1, wherein the detector is a TOF detector.

55. The method of claim 54, wherein ions from a single spot are not separately pushed to the TOF detector.

56. The method of claim 1, wherein detection of the elemental ions comprises analysis of metal tags or targets associated with the metal tags.

57. The method of claim 1, further comprising forming an image of the sample based on the elemental/isotopic composition of multiple spots.

58. The method of claim 4, further comprising detecting single copies of metal-tagged antibodies.

59. The method of claim 58, wherein at least some of the metal-tags comprise a barcode of isotopes.

60. The method of claim 59, wherein the sample comprises more than 100 different metal tagged antibodies

61. The method of claim 1, wherein the portion of the sample removed at the spot by radiation is less than 1 atto gram.

62. The method of claim 1, further comprising 3D imaging by radiating the sample at the same X, Y coordinate multiple times.

63. A system for analyzing a sample comprising:
a) a solid support;
b) a radiation source and optics for directing radiation at a spot on a sample to form a plasma that atomizes and ionizes the sample at that spot to produce elemental ions;
c) a mass detector for detecting the elemental composition of elemental ions delivered from the plasma.

64. The system of claim 63, further comprising a sample mounted on the sample support.

65. The system of claim 64, wherein the sample is a geological or semiconductor sample.

66. The system of claim 64, wherein sample is a biological sample.

67. The system of claim 66, wherein the sample is a tissue section, such as an EM section.

68. The system of claim 67, wherein the tissue section is 100 nm thick or less.

69. The system of claim 66, wherein the sample is stained with specific binding partners (SBPs) comprising distinct metal tags.

70. The system of claim 69, wherein the SBPs are antibodies.

71. The system of claim 70, further comprises metal containing histochemical stains and/or metal tagged oligonucleotides.

72. The system of claim 63, wherein the solid support comprises an X-Y stage.

73. The system of claim 63, wherein the solid support comprises a slide.

74. The system of claim 63, wherein the radiation source is a laser scanned across the sample by a positioner.

75. The system of claim 74, wherein the positioner is a galvanometer mirror, piezoelectric mirror, or MEMS mirror, polygon scanner, acousto-optic device or an electro-optic device.

76. The system of claim 63, wherein the radiation source is positioned to direct radiation from a different angle than the direction of the mass detector in the relation to the sample.

77. The system of claim 76, wherein the radiation source is positioned to direct radiation from the opposite side of the sample from the side of delivery to the MS detector.

78. The system of claim 63, wherein the radiation source is a laser.

79. The system of claim 78, wherein the laser has a pulse duration between 10 fs and 10 ps.

80. The system of claim 78, wherein the laser has a pulse duration less than 10 ps.

81. The system of claim 78, wherein the laser is a high harmonic generation laser.

82. The system of claim 78, wherein the laser is focused by an immersion lens.

83. The system of claim 78, wherein the laser is focused by a solid or liquid immersion lens.

84. The system of claim 78, wherein the laser is from a femtosecond laser or picosecond laser.

85. The system of claim 78, wherein the laser has a wavelength of less than 500 nm.

86. The system of claim 78, wherein the laser is a UV laser or EUV laser.

87. The system of claim 78 or 79, wherein the laser has a pulse energy between 10 pj and 10 uJ.

88. The system of claim 78, wherein the laser has a pulse energy of less than 1 nj.

89. The system of claim 88, wherein the laser has a pulse energy of less than 100 pj.

90. The system of claim 63, wherein the radiation is a beam of charged particles.

91. The system of claim 90, wherein the beam of charged particles is an electron beam.

92. The system of claim 91, wherein the electron beam can direct electrons with an energy of between 100 eV, and 100 keV to the sample spot.

93. The system of claim 30 or 31, wherein the radiation source can direct a number of electrons to the sample spot at or between 1000 and 50000 electrons.

94. The system of claim 63, wherein the radiation source is configured to provide a pulse of radiation of a duration less than the time of plasma formation.

95. The system of claim 63, wherein sample spots are analyzed at a frequency between 1 kHz and 10 MHz.

96. The system of claim 63, 78, or 88, wherein the system comprises radiation optics providing a spot size of 500 nm or less.

97. The system of claim 96, wherein the spot size is 200 nm or less.

98. The system of claim 97, wherein the spot size is 100 nm or less.

99. The system of claim 98, wherein the spot size is 50 nm or less.

100. The system of claim 63, wherein the system is configured to maintain a vacuum at the point of plasma formation.

101. The system of claim 63, wherein system is configured to form a plasma without the presence of an injected noble gas, such as Argon or Xenon.

102. The system of claim 63, wherein the system is configured to form a plasma is a thermal plasma, having an internal temperature between 3000 and 30000K.

103. The system of claim 102, wherein the internal temperature is between 5000 and 10000K.

104. The system of claim 102, wherein the thermal plasma internal temperature is between 3000 and 30000K past neutralization.

105. The system of claim 63, wherein the plasma is a non-thermal plasma.

106. The system of claim 63, wherein the plasma has a diameter less than 1 um when it passes the point of neutralization.

107. The system of claim 63, wherein the elemental ions from plasma are directly delivered to the mass detector by ion transport optics.

108. The system of claim 63, wherein delivering does not comprise a mass filter.

109. The system of claim 46, wherein the ion transport optics comprises a high pass filter with a cutoff below 80 amu.

110. The system of claim 63, wherein the delivery time of elemental ions from the plasma to the detector is less than 200 us.

111. The system of claim 63, wherein at least 10% of metals released from the sample spot by the radiation are atomized and ionized and delivered to the detector.

112. The system of claim 63, wherein the ionization efficiency of lanthanides is in the plasma is at least 20% and the ionization efficiency of carbon in the plasma is below 5%.

113. The system of claim 63, wherein the plasma has an ionization efficiency of at least 5% post neutralization.

114. The system of claim 63, wherein the detector is a magnetic sector detector.

115. The system of claim 63, wherein the detector is a TOF detector.

116. The system of claim 115, wherein ions from a single spot are not separately pushed to the TOF detector.

117. The system of claim 63, wherein detection of the elemental ions comprises analysis of metal tags or targets associated with the metal tags.

118. The system of claim 63, wherein the system is configured to form an image of the sample based on the elemental/isotopic composition of multiple spots.
